(19) United States
(12) Patent Application Publication
(10) Pub. No.: US 2018/0349472 A1
(43) Pub. Date: Dec. 6, 2018

(54) METHODS AND SYSTEMS FOR PROVIDING QUERY SUGGESTIONS

(71) Applicant: Apple Inc., Cupertino, CA (US)

(72) Inventors: Karl Christian KOHLSCHUETTER, Monte Sereno, CA (US); Juan DAI, Cupertino, CA (US); William C. MACCARTNEY, San Jose, CA (US)

(21) Appl. No.: 15/690,821

(22) Filed: Aug. 30, 2017

Related U.S. Application Data
(60) Provisional application No. 62/514,660, filed on Jun. 2, 2017.

(51) Int. Cl. G06F 17/30

(52) U.S. Cl. CPC G06F 17/30643; G06F 17/30011; G06F 17/30675; G06F 17/30622; G06F 17/30705

(57) ABSTRACT

Systems and processes for operating an intelligent automated assistant to provide query suggestions are provided. In accordance with one or more examples, a method includes, at an electronic device with one or more processors and memory: while displaying an input document comprising unstructured natural language information, receiving a user input initiating a search. The method also include in response to receiving the user input, initiating a query based on the input document. The query accesses a repository of candidate query suggestions related to one or more topics present in the unstructured natural language information. The method further includes receiving, from the repository, one or more query suggestions; and providing the one or more query suggestions to the user.

### CROSS-REFERENCE TO RELATED APPLICATIONS

This application claims priority to U.S. Provisional Patent Application Ser. No. 62/514,660, filed on Jun. 2, 2017, entitled “METHODS AND SYSTEMS FOR PROVIDING QUERY SUGGESTIONS,” which is hereby incorporated by reference in its entirety for all purposes.

### FIELD

This relates generally to intelligent automated assistants and, more specifically, to providing query suggestions to a user on an electronic device.

### BACKGROUND

Intelligent automated assistants (or digital assistants) can provide a beneficial interface between human users and electronic devices. Such assistants can allow users to interact with devices or systems using natural language in spoken and/or text forms. For example, a user can provide a speech input containing a user request to a digital assistant operating on an electronic device. The digital assistant can interpret the user's intent from the speech input and operationalize the user's intent into tasks. The tasks can then be performed by executing one or more services of the electronic device, and a relevant output responsive to the user request can be returned to the user.

Intelligent automated assistant can provide query suggestions to a user. Query suggestions can include suggestions for a user to initiate a query for information that the user may be interested in. For example, based on an article the user reads, an intelligent automated assistant can perform a search and determine multiple suggestions of articles or websites that the user may be interested in. In view of the multiple suggestions, the user may select one suggestion to initiate a query for information. The determination of multiple query suggestions may require searching a large collection of topically-diverse documents. As a result, the process may be slow, inefficient, and inaccurate.

### SUMMARY

Systems and processes for providing a plurality of query suggestions are provided.

In accordance with one or more examples, a method includes, at an electronic device with one or more processors and memory: while displaying an input document comprising unstructured natural language information, receiving a user input initiating a search. The method also include in response to receiving the user input, initiating a query based on the input document. The query accesses a repository of candidate query suggestions related to one or more topics present in the unstructured natural language information. The method further includes receiving, from the repository, one or more query suggestions; and providing the one or more query suggestions to the user.

Example non-transitory computer-readable media are disclosed herein. An example non-transitory computer-readable storage medium stores one or more programs. The one or more programs comprise instructions, which when executed by one or more processors of an electronic device, cause the electronic device to, while displaying an input document comprising unstructured natural language information, receive a user input initiating a search. The one or more programs further include instructions that cause the electronic device to, in response to receiving the user input, initiate a query based on the input document. The query accesses a repository of candidate query suggestions related to one or more topics present in the unstructured natural language information. The one or more programs further includes instructions that cause the electronic device to receive, from the repository, one or more query suggestions; and provide the one or more query suggestions to the user.

Example electronic devices are disclosed herein. An example electronic device comprises one or more processors; a memory; and one or more programs, where the one or more programs are stored in the memory and configured to be executed by the one or more processors, the one or more programs including instructions for, while displaying an input document comprising unstructured natural language information, receiving a user input initiating a search. The one or more programs also include instructions for, in response to receiving the user input, initiating a query based on the input document. The query accesses a repository of candidate query suggestions related to one or more topics present in the unstructured natural language information. The one or more programs further include receiving, from the repository, one or more query suggestions; and providing the one or more query suggestions to the user.

An example electronic device comprises while displaying an input document comprising unstructured natural language information, means for receiving a user input initiating a search. The electronic device also includes, in response to receiving the user input, means for initiating a query based on the input document. The query accesses a repository of candidate query suggestions related to one or more topics present in the unstructured natural language information. The electronic device further includes means for receiving, from the repository, one or more query suggestions; and means for providing the one or more query suggestions to the user.

Providing query suggestions to the user requires searching of an index structure. An index structure that is smaller in size can improve the speed of searching. Various techniques described in this application reduce the size of the index structure for enabling the searching to be performed in a fast and efficient manner. For example, searching can be performed and the query suggestions can be provided to the user in about 50-150 milliseconds. Thus, the user should not detect any delay between initiating a search and receiving the query suggestions (e.g., articles that the user may be interested in). In some examples, the customized index structure can be accommodated in a mobile device for performing a search in absence of a network connection, which can further improve the searching speed. Moreover, the techniques for reducing the size of the index structure described in this application do not reduce or compromise the accuracy of determining the query suggestions. For example, the techniques employed in this application can effectively determine whether terms in the index structure likely represent documents that may be interested to the user, and therefore confidently remove terms according to the determination.

Furthermore, various techniques for providing query suggestions described in this application enhance the operability of the device and makes the user-device interface more efficient (e.g., by performing post processing of search result to refine and narrow the search result to provide the top 2-3 query suggestions to the user, rather than a large quantity of query suggestions) which, additionally, reduces power usage and improves battery life of the device by enabling the user to use the device more quickly and efficiently.

### BRIEF DESCRIPTION OF THE DRAWINGS

FIG. 1 is a block diagram illustrating a system and environment for implementing a digital assistant, according to various examples.

FIG. 2A is a block diagram illustrating a portable multifunction device implementing the client-side portion of a digital assistant, according to various examples.

FIG. 2B is a block diagram illustrating exemplary components for event handling, according to various examples.

FIG. 3 illustrates a portable multifunction device implementing the client-side portion of a digital assistant, according to various examples.

FIG. 4 is a block diagram of an exemplary multifunction device with a display and a touch-sensitive surface, according to various examples.

FIG. 5A illustrates an exemplary user interface for a menu of applications on a portable multifunction device, according to various examples.

FIG. 5B illustrates an exemplary user interface for a multifunction device with a touch-sensitive surface that is separate from the display, according to various examples.

FIG. 6A illustrates a personal electronic device, according to various examples.

FIG. 6B is a block diagram illustrating a personal electronic device, according to various examples.

FIG. 7A is a block diagram illustrating a digital assistant system or a server portion thereof, according to various examples.

FIG. 7B illustrates the functions of the digital assistant shown in FIG. 7A, according to various examples.

FIG. 7C illustrates a portion of an ontology, according to various examples.

FIG. 8 illustrates a block diagram of an intelligent automated assistant for providing query suggestions, according to various examples.

FIG. 9 illustrates a user interface for displaying a document on a user device, according to various examples.

FIG. 10A illustrates a user interface for receiving a user input initiating a search, according to various examples.

FIG. 10B illustrates a user interface for displaying query suggestions in response to a search, according to various examples.

FIG. 10C illustrates a user interface for receiving another user input initiating a search, according to various example.

FIG. 11 illustrates a block diagram of a query generator, according to various examples.

FIG. 12A illustrates a block diagram of a query suggestion generator, according to various examples.

FIG. 12B illustrates an index structure, according to various examples.

FIG. 12C illustrates a positional index associated with a text corpus, according to various examples.

FIG. 13A illustrates a user interface for receiving a user selection of a query suggestion, according to various examples.

FIG. 13B illustrates a user interface for providing a document to the user in response to the user selection of a query suggestion, according to various examples.

FIGS. 14A-14F illustrates a process for providing query suggestions, according to various examples.

### DETAILED DESCRIPTION

In the following description of examples, reference is made to the accompanying drawings in which are shown by way of illustration specific examples that can be practiced. It is to be understood that other examples can be used and structural changes can be made without departing from the scope of the various examples.

Various techniques for improving the efficiency of providing query suggestions are described. The techniques include generating an index structure to enable a similarity search, and reducing, sometimes significantly, the size of the index structure to enable a faster and more accurate similarity search. The techniques also include performing post-processing of the similarity search results such that the top few query suggestions are provided to the user. The post-processing of the similarity results further refines and narrows among the candidate query suggestions to provide an improved user interaction interface.

Although the following description uses terms “first,” “second,” etc. to describe various elements, these elements should not be limited by the terms. These terms are only used to distinguish one element from another. For example, a first input could be termed a second input, and, similarly, a second input could be termed a first input, without departing from the scope of the various described examples. The first input and the second input are both inputs and, in some cases, are separate and different inputs.

The terminology used in the description of the various described examples herein is for the purpose of describing particular examples only and is not intended to be limiting. As used in the description of the various described examples and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

### 1. System and Environment

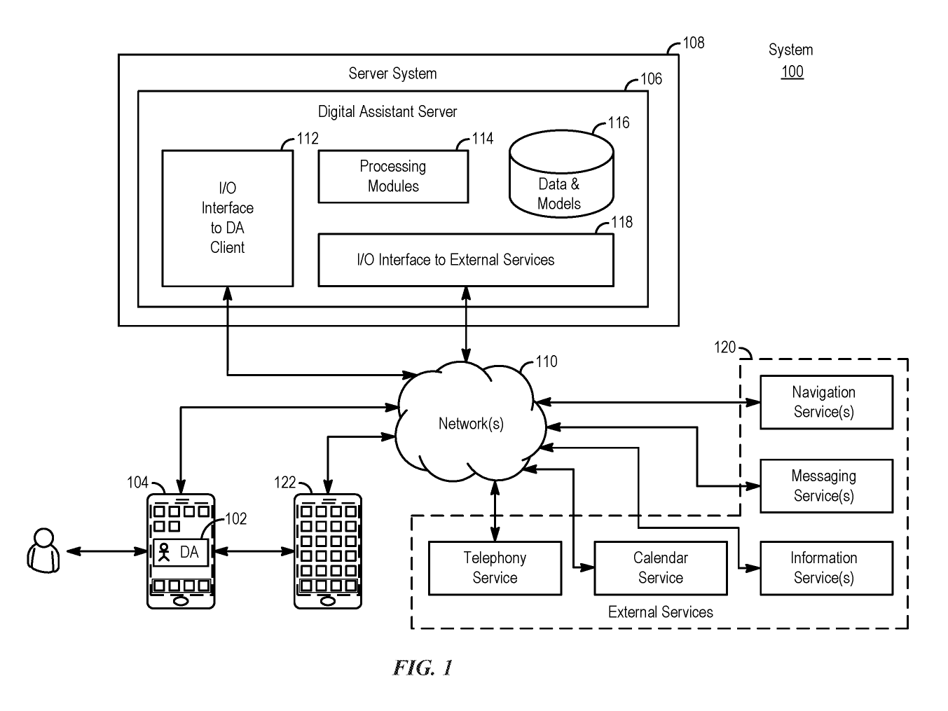

FIG. 1 illustrates a block diagram of system 100 according to various examples. In some examples, system 100 implements a digital assistant. The terms “digital assistant,” “virtual assistant,” “intelligent automated assistant,” or “automatic digital assistant” refer to any information processing system that interprets natural language input in spoken and/or textual form to infer user intent, and performs actions based on the inferred user intent. For example, to act on an inferred user intent, the system performs one or more of the following: identifying a task flow with steps and parameters designed to accomplish the inferred user intent, inputting specific requirements from the inferred user intent into the task flow; executing the task flow by invoking programs, methods, services, APIs, or the like; and generating output responses to the user in an audible (e.g., speech) and/or visual form.

Specifically, a digital assistant is capable of accepting a user request at least partially in the form of a natural language command, request, statement, narrative, and/or inquiry. Typically, the user request seeks either an informational answer or performance of a task by the digital assistant. A satisfactory response to the user request includes a provision of the requested informational answer, a performance of the requested task, or a combination of the two. For example, a user asks the digital assistant a question, such as “Where am I right now?” Based on the user's current location, the digital assistant answers, “You are in Central Park near the west gate.” The user also requests the performance of a task, for example, “Please invite my friends to my girlfriend's birthday party next week.” In response, the digital assistant can acknowledge the request by saying “Yes, right away,” and then send a suitable calendar invite on behalf of the user to each of the user's friends listed in the user's electronic address book. During performance of a requested task, the digital assistant sometimes interacts with the user in a continuous dialogue involving multiple exchanges of information over an extended period of time. There are numerous other ways of interacting with a digital assistant to request information or performance of various tasks. In addition to providing verbal responses and taking programmed actions, the digital assistant also provides responses in other visual or audio forms, e.g., as text, alerts, music, videos, animations, etc.

As shown in FIG. 1, in some examples, a digital assistant is implemented according to a client-server model. The digital assistant includes client-side portion 102 (hereafter “DA client 102”) executed on user device 104 and server-side portion 106 (hereafter “DA server 106”) executed on server system 108. DA client 102 communicates with DA server 106 through one or more networks 110. DA client 102 provides client-side functionalities such as user-facing input and output processing and communication with DA server 106. DA server 106 provides server-side functionalities for any number of DA clients 102 each residing on a respective user device 104.

In some examples, DA server 106 includes client-facing I/O interface 112, one or more processing modules 114, data and models 116, and I/O interface to external services 118. The client-facing I/O interface 112 facilitates the client-facing input and output processing for DA server 106. One or more processing modules 114 utilize data and models 116 to process speech input and determine the user's intent based on natural language input. Further, one or more processing modules 114 perform task execution based on inferred user intent. In some examples, DA server 106 communicates with external services 120 through network(s) 110 for task completion or information acquisition. I/O interface to external services 118 facilitates such communications.

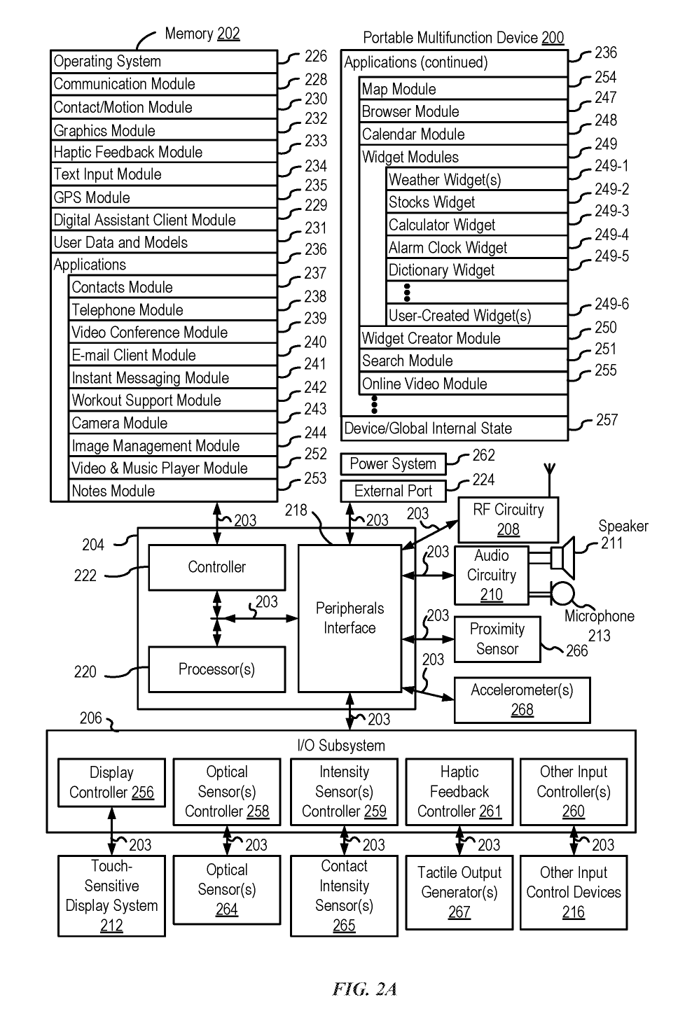

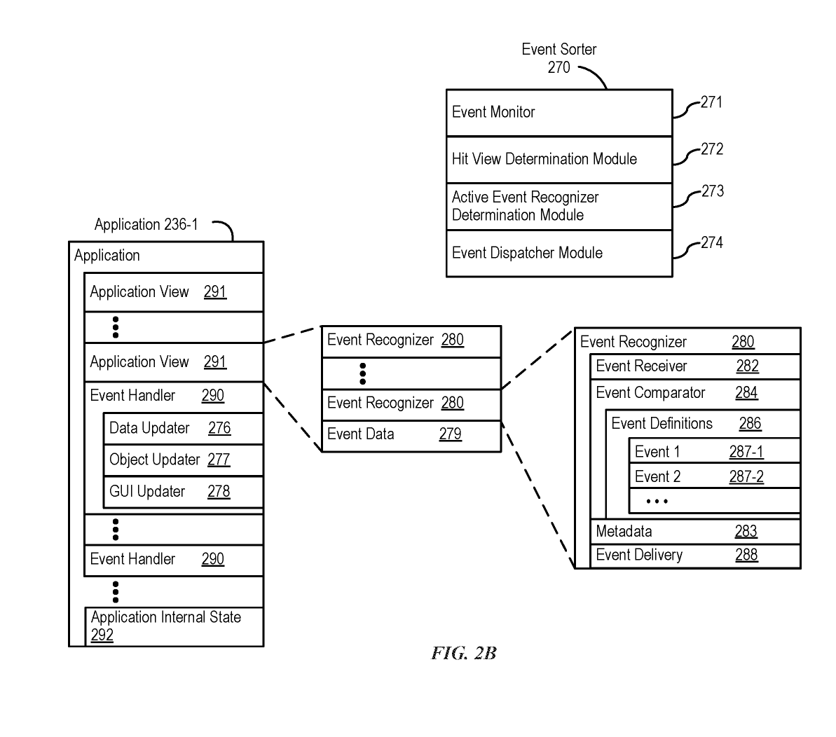

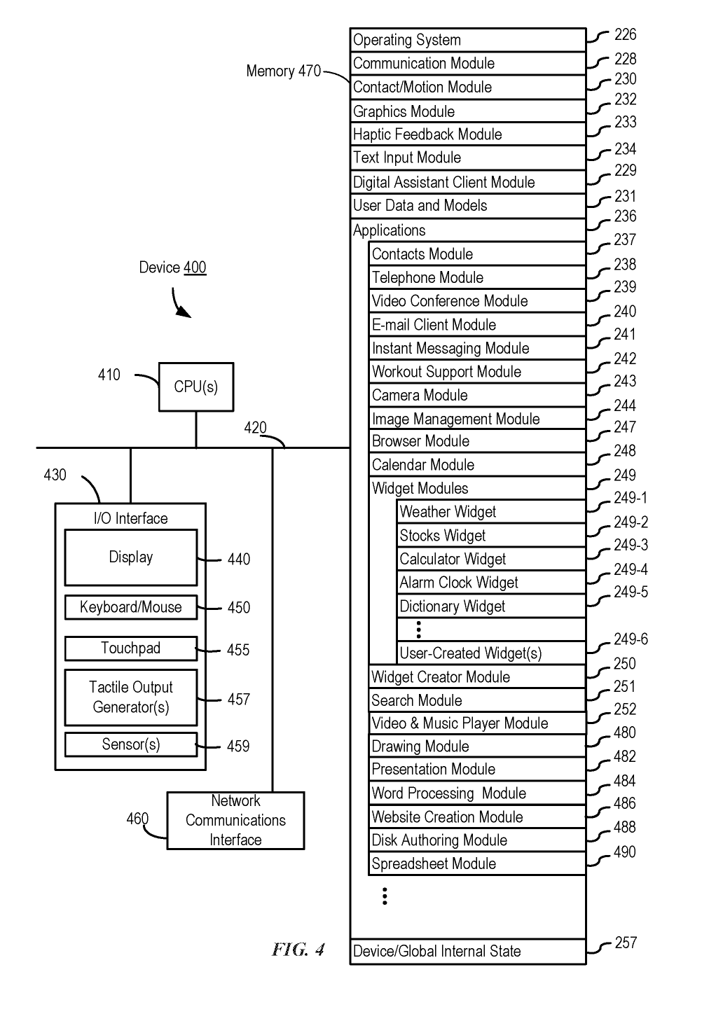

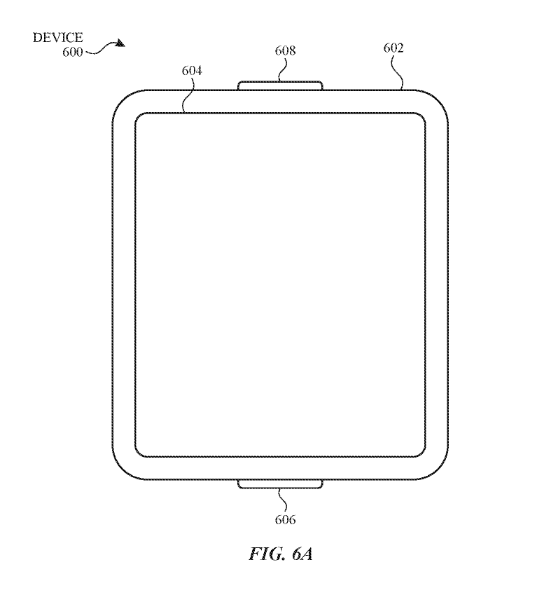

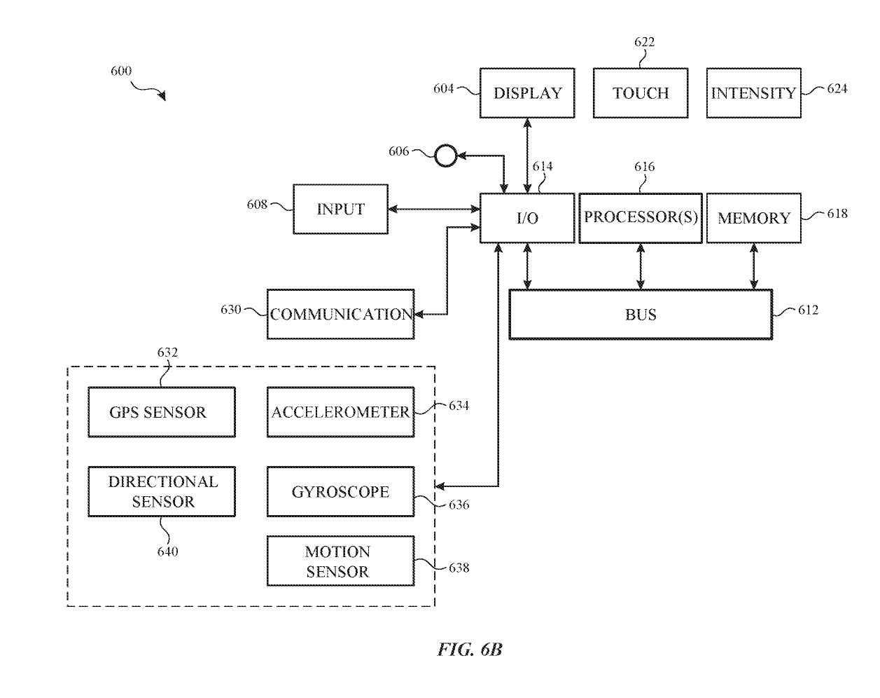

User device 104 can be any suitable electronic device. In some examples, user device is a portable multifunctional device (e.g., device 200, described below with reference to FIG. 2A), a multifunctional device (e.g., device 400, described below with reference to FIG. 4), or a personal electronic device (e.g., device 600, described below with reference to FIG. 6A-B.) A portable multifunctional device is, for example, a mobile telephone that also contains other functions, such as PDA and/or music player functions. Specific examples of portable multifunction devices include the iPhone®, iPod Touch®, and iPad® devices from Apple Inc. of Cupertino, Calif. Other examples of portable multifunction devices include, without limitation, laptop or tablet computers. Further, in some examples, user device 104 is a non-portable multifunctional device. In particular, user device 104 is a desktop computer, a game console, a television, or a television set-top box. In some examples, user device 104 includes a touch-sensitive surface (e.g., touch screen displays and/or touchpads). Further, user device 104 optionally includes one or more other physical user-interface devices, such as a physical keyboard, a mouse, and/or a joystick. Various examples of electronic devices, such as multifunctional devices, are described below in greater detail.

Examples of communication network(s) 110 include local area networks (LAN) and wide area networks (WAN), e.g., the Internet. Communication network(s) 110 is implemented using any known network protocol, including various wired or wireless protocols, such as, for example, Ethernet, Universal Serial Bus (USB), FIREWIRE, Global System for Mobile Communications (GSM), Enhanced Data GSM Environment (EDGE), code division multiple access (CDMA), time division multiple access (TDMA), Bluetooth, Wi-Fi, voice over Internet Protocol (VoW), Wi-MAX, or any other suitable communication protocol.

Server system 108 is implemented on one or more standalone data processing apparatus or a distributed network of computers. In some examples, server system 108 also employs various virtual devices and/or services of third-party service providers (e.g., third-party cloud service providers) to provide the underlying computing resources and/or infrastructure resources of server system 108.

In some examples, user device 104 communicates with DA server 106 via second user device 122. Second user device 122 is similar or identical to user device 104. For example, second user device 122 is similar to devices 200, 400, or 600 described below with reference to FIGS. 2A, 4, and 6A-B. User device 104 is configured to communicatively couple to second user device 122 via a direct communication connection, such as Bluetooth, NFC, BTLE, or the like, or via a wired or wireless network, such as a local Wi-Fi network. In some examples, second user device 122 is configured to act as a proxy between user device 104 and DA server 106. For example, DA client 102 of user device 104 is configured to transmit information (e.g., a user request received at user device 104) to DA server 106 via second user device 122. DA server 106 processes the information and return relevant data (e.g., data content responsive to the user request) to user device 104 via second user device 122.

In some examples, user device 104 is configured to communicate abbreviated requests for data to second user device 122 to reduce the amount of information transmitted from user device 104. Second user device 122 is configured to determine supplemental information to add to the abbreviated request to generate a complete request to transmit to DA server 106. This system architecture can advantageously allow user device 104 having limited communication capabilities and/or limited battery power (e.g., a watch or a similar compact electronic device) to access services provided by DA server 106 by using second user device 122, having greater communication capabilities and/or battery power (e.g., a mobile phone, laptop computer, tablet computer, or the like), as a proxy to DA server 106. While only two user devices 104 and 122 are shown in FIG. 1, it should be appreciated that system 100, in some examples, includes any number and type of user devices configured in this proxy configuration to communicate with DA server system 106.

Although the digital assistant shown in FIG. 1 includes both a client-side portion (e.g., DA client 102) and a server-side portion (e.g., DA server 106), in some examples, the functions of a digital assistant are implemented as a standalone application installed on a user device. In addition, the divisions of functionalities between the client and server portions of the digital assistant can vary in different implementations. For instance, in some examples, the DA client is a thin-client that provides only user-facing input and output processing functions, and delegates all other functionalities of the digital assistant to a backend server.

### 2. Electronic Devices

Attention is now directed toward embodiments of electronic devices for implementing the client-side portion of a digital assistant. FIG. 2A is a block diagram illustrating portable multifunction device 200 with touch-sensitive display system 212 in accordance with some embodiments. Touch-sensitive display 212 is sometimes called a “touch screen” for convenience and is sometimes known as or called a “touch-sensitive display system.” Device 200 includes memory 202 (which optionally includes one or more computer-readable storage mediums), memory controller 222, one or more processing units (CPUs) 220, peripherals interface 218, RF circuitry 208, audio circuitry 210, speaker 211, microphone 213, input/output (I/O) subsystem 206, other input control devices 216, and external port 224. Device 200 optionally includes one or more optical sensors 264. Device 200 optionally includes one or more contact intensity sensors 265 for detecting intensity of contacts on device 200 (e.g., a touch-sensitive surface such as touch-sensitive display system 212 of device 200). Device 200 optionally includes one or more tactile output generators 267 for generating tactile outputs on device 200 (e.g., generating tactile outputs on a touch-sensitive surface such as touch-sensitive display system 212 of device 200 or touchpad 455 of device 400). These components optionally communicate over one or more communication buses or signal lines 203.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 200 is only one example of a portable multifunction device, and that device 200 optionally has more or fewer components than shown, optionally combines two or more components, or optionally has a different configuration or arrangement of the components. The various components shown in FIG. 2A are implemented in hardware, software, or a combination of both hardware and software, including one or more signal processing and/or application-specific integrated circuits.

Memory 202 includes one or more computer-readable storage mediums. The computer-readable storage mediums are, for example, tangible and non-transitory. Memory 202 includes high-speed random access memory and also includes non-volatile memory, such as one or more magnetic disk storage devices, flash memory devices, or other non-volatile solid-state memory devices. Memory controller 222 controls access to memory 202 by other components of device 200.

In some examples, a non-transitory computer-readable storage medium of memory 202 is used to store instructions (e.g., for performing aspects of processes described below) for use by or in connection with an instruction execution system, apparatus, or device, such as a computer-based system, processor-containing system, or other system that can fetch the instructions from the instruction execution system, apparatus, or device and execute the instructions. In other examples, the instructions (e.g., for performing aspects of the processes described below) are stored on a non-transitory computer-readable storage medium (not shown) of the server system 108 or are divided between the non-transitory computer-readable storage medium of memory 202 and the non-transitory computer-readable storage medium of server system 108.

Peripherals interface 218 is used to couple input and output peripherals of the device to CPU 220 and memory 202. The one or more processors 220 run or execute various software programs and/or sets of instructions stored in memory 202 to perform various functions for device 200 and to process data. In some embodiments, peripherals interface 218, CPU 220, and memory controller 222 are implemented on a single chip, such as chip 204. In some other embodiments, they are implemented on separate chips.

RF (radio frequency) circuitry 208 receives and sends RF signals, also called electromagnetic signals. RF circuitry 208 converts electrical signals to/from electromagnetic signals and communicates with communications networks and other communications devices via the electromagnetic signals. RF circuitry 208 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 208 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 208 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSDPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoW), Wi-MAX, a protocol for e mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

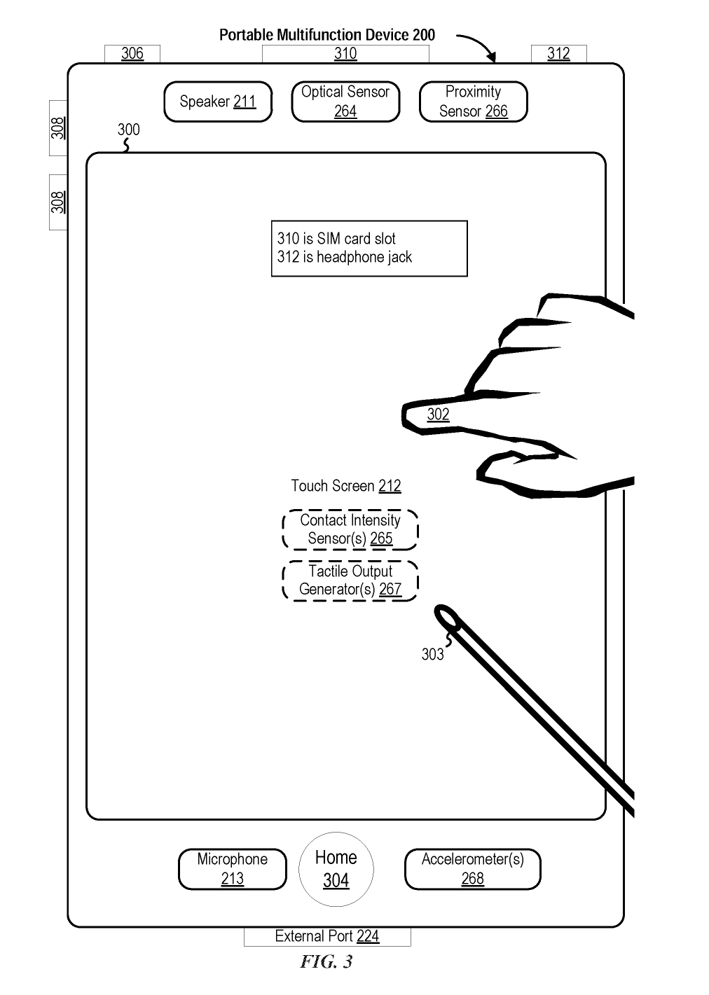

Audio circuitry 210, speaker 211, and microphone 213 provide an audio interface between a user and device 200. Audio circuitry 210 receives audio data from peripherals interface 218, converts the audio data to an electrical signal, and transmits the electrical signal to speaker 211. Speaker 211 converts the electrical signal to human-audible sound waves. Audio circuitry 210 also receives electrical signals converted by microphone 213 from sound waves. Audio circuitry 210 converts the electrical signal to audio data and transmits the audio data to peripherals interface 218 for processing. Audio data are retrieved from and/or transmitted to memory 202 and/or RF circuitry 208 by peripherals interface 218. In some embodiments, audio circuitry 210 also includes a headset jack (e.g., 312, FIG. 3). The headset jack provides an interface between audio circuitry 210 and removable audio input/output peripherals, such as output-only headphones or a headset with both output (e.g., a headphone for one or both ears) and input (e.g., a microphone).

I/O subsystem 206 couples input/output peripherals on device 200, such as touch screen 212 and other input control devices 216, to peripherals interface 218. I/O subsystem 206 optionally includes display controller 256, optical sensor controller 258, intensity sensor controller 259, haptic feedback controller 261, and one or more input controllers 260 for other input or control devices. The one or more input controllers 260 receive/send electrical signals from/to other input control devices 216. The other input control devices 216 optionally include physical buttons (e.g., push buttons, rocker buttons, etc.), dials, slider switches, joysticks, click wheels, and so forth. In some alternate embodiments, input controller(s) 260 are, optionally, coupled to any (or none) of the following: a keyboard, an infrared port, a USB port, and a pointer device such as a mouse. The one or more buttons (e.g., 308, FIG. 3) optionally include an up/down button for volume control of speaker 211 and/or microphone 213. The one or more buttons optionally include a push button (e.g., 306, FIG. 3).

A quick press of the push button disengages a lock of touch screen 212 or begin a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 306) turns power to device 200 on or off. The user is able to customize a functionality of one or more of the buttons. Touch screen 212 is used to implement virtual or soft buttons and one or more soft keyboards.

Touch-sensitive display 212 provides an input interface and an output interface between the device and a user. Display controller 256 receives and/or sends electrical signals from/to touch screen 212. Touch screen 212 displays visual output to the user. The visual output includes graphics, text, icons, video, and any combination thereof (collectively termed “graphics”). In some embodiments, some or all of the visual output correspond to user-interface objects.

Touch screen 212 has a touch-sensitive surface, sensor, or set of sensors that accepts input from the user based on haptic and/or tactile contact. Touch screen 212 and display controller 256 (along with any associated modules and/or sets of instructions in memory 202) detect contact (and any movement or breaking of the contact) on touch screen 212 and convert the detected contact into interaction with user-interface objects (e.g., one or more soft keys, icons, web pages, or images) that are displayed on touch screen 212. In an exemplary embodiment, a point of contact between touch screen 212 and the user corresponds to a finger of the user.

Touch screen 212 uses LCD (liquid crystal display) technology, LPD (light emitting polymer display) technology, or LED (light emitting diode) technology, although other display technologies may be used in other embodiments. Touch screen 212 and display controller 256 detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 212. In an exemplary embodiment, projected mutual capacitance sensing technology is used, such as that found in the iPhone® and iPod Touch® from Apple Inc. of Cupertino, Calif.

A touch-sensitive display in some embodiments of touch screen 212 is analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 212 displays visual output from device 200, whereas touch-sensitive touchpads do not provide visual output.

A touch-sensitive display in some embodiments of touch screen 212 is as described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 212 has, for example, a video resolution in excess of 100 dpi. In some embodiments, the touch screen has a video resolution of approximately 160 dpi. The user makes contact with touch screen 212 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 200 includes a touchpad (not shown) for activating or deactivating particular functions. In some embodiments, the touchpad is a touch-sensitive area of the device that, unlike the touch screen, does not display visual output. The touchpad is a touch-sensitive surface that is separate from touch screen 212 or an extension of the touch-sensitive surface formed by the touch screen.

Device 200 also includes power system 262 for powering the various components. Power system 262 includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 200 also includes one or more optical sensors 264. FIG. 2A shows an optical sensor coupled to optical sensor controller 258 in I/O subsystem 206. Optical sensor 264 includes charge-coupled device (CCD) or complementary metal-oxide semiconductor (CMOS) phototransistors. Optical sensor 264 receives light from the environment, projected through one or more lenses, and converts the light to data representing an image. In conjunction with imaging module 243 (also called a camera module), optical sensor 264 captures still images or video. In some embodiments, an optical sensor is located on the back of device 200, opposite touch screen display 212 on the front of the device so that the touch screen display is used as a viewfinder for still and/or video image acquisition. In some embodiments, an optical sensor is located on the front of the device so that the user's image is obtained for video conferencing while the user views the other video conference participants on the touch screen display. In some embodiments, the position of optical sensor 264 can be changed by the user (e.g., by rotating the lens and the sensor in the device housing) so that a single optical sensor 264 is used along with the touch screen display for both video conferencing and still and/or video image acquisition.

Device 200 optionally also includes one or more contact intensity sensors 265. FIG. 2A shows a contact intensity sensor coupled to intensity sensor controller 259 in I/O subsystem 206. Contact intensity sensor 265 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 265 receives contact intensity information (e.g., pressure information or a proxy for pressure information) from the environment. In some embodiments, at least one contact intensity sensor is collocated with, or proximate to, a touch-sensitive surface (e.g., touch-sensitive display system 212). In some embodiments, at least one contact intensity sensor is located on the back of device 200, opposite touch screen display 212, which is located on the front of device 200.

Device 200 also includes one or more proximity sensors 266. FIG. 2A shows proximity sensor 266 coupled to peripherals interface 218. Alternately, proximity sensor 266 is coupled to input controller 260 in I/O subsystem 206. Proximity sensor 266 is performed as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 212 when the multifunction device is placed near the user's ear (e.g., when the user is making a phone call).

Device 200 optionally also includes one or more tactile output generators 267. FIG. 2A shows a tactile output generator coupled to haptic feedback controller 261 in I/O subsystem 206. Tactile output generator 267 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 265 receives tactile feedback generation instructions from haptic feedback module 233 and generates tactile outputs on device 200 that are capable of being sensed by a user of device 200. In some embodiments, at least one tactile output generator is collocated with, or proximate to, a touch-sensitive surface (e.g., touch-sensitive display system 212) and, optionally, generates a tactile output by moving the touch-sensitive surface vertically (e.g., in/out of a surface of device 200) or laterally (e.g., back and forth in the same plane as a surface of device 200). In some embodiments, at least one tactile output generator sensor is located on the back of device 200, opposite touch screen display 212, which is located on the front of device 200.

Device 200 also includes one or more accelerometers 268. FIG. 2A shows accelerometer 268 coupled to peripherals interface 218. Alternately, accelerometer 268 is coupled to an input controller 260 in I/O subsystem 206. Accelerometer 268 performs, for example, as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 200 optionally includes, in addition to accelerometer(s) 268, a magnetometer (not shown) and a GPS (or GLONASS or other global navigation system) receiver (not shown) for obtaining information concerning the location and orientation (e.g., portrait or landscape) of device 200.

In some embodiments, the software components stored in memory 202 include operating system 226, communication module (or set of instructions) 228, contact/motion module (or set of instructions) 230, graphics module (or set of instructions) 232, text input module (or set of instructions) 234, Global Positioning System (GPS) module (or set of instructions) 235, Digital Assistant Client Module 229, and applications (or sets of instructions) 236. Further, memory 202 stores data and models, such as user data and models 231. Furthermore, in some embodiments, memory 202 (FIG. 2A) or 470 (FIG. 4) stores device/global internal state 257, as shown in FIGS. 2A and 4. Device/global internal state 257 includes one or more of: active application state, indicating which applications, if any, are currently active; display state, indicating what applications, views or other information occupy various regions of touch screen display 212; sensor state, including information obtained from the device's various sensors and input control devices 216; and location information concerning the device's location and/or attitude.

Operating system 226 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 228 facilitates communication with other devices over one or more external ports 224 and also includes various software components for handling data received by RF circuitry 208 and/or external port 224. External port 224 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 230 optionally detects contact with touch screen 212 (in conjunction with display controller 256) and other touch-sensitive devices (e.g., a touchpad or physical click wheel). Contact/motion module 230 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 230 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 230 and display controller 256 detect contact on a touchpad.

In some embodiments, contact/motion module 230 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 200). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 230 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 232 includes various known software components for rendering and displaying graphics on touch screen 212 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 232 stores data representing graphics to be used. Each graphic is, optionally, assigned a corresponding code. Graphics module 232 receives, from applications etc., one or more codes specifying graphics to be displayed along with, if necessary, coordinate data and other graphic property data, and then generates screen image data to output to display controller 256.

Haptic feedback module 233 includes various software components for generating instructions used by tactile output generator(s) 267 to produce tactile outputs at one or more locations on device 200 in response to user interactions with device 200.

Text input module 234, which is, in some examples, a component of graphics module 232, provides soft keyboards for entering text in various applications (e.g., contacts 237, email 240, IM 241, browser 247, and any other application that needs text input).

GPS module 235 determines the location of the device and provides this information for use in various applications (e.g., to telephone 238 for use in location-based dialing; to camera 243 as picture/video metadata; and to applications that provide location-based services such as weather widgets, local yellow page widgets, and map/navigation widgets).

Digital assistant client module 229 includes various client-side digital assistant instructions to provide the client-side functionalities of the digital assistant. For example, digital assistant client module 229 is capable of accepting voice input (e.g., speech input), text input, touch input, and/or gestural input through various user interfaces (e.g., microphone 213, accelerometer(s) 268, touch-sensitive display system 212, optical sensor(s) 229, other input control devices 216, etc.) of portable multifunction device 200. Digital assistant client module 229 is also capable of providing output in audio (e.g., speech output), visual, and/or tactile forms through various output interfaces (e.g., speaker 211, touch-sensitive display system 212, tactile output generator(s) 267, etc.) of portable multifunction device 200. For example, output is provided as voice, sound, alerts, text messages, menus, graphics, videos, animations, vibrations, and/or combinations of two or more of the above. During operation, digital assistant client module 229 communicates with DA server 106 using RF circuitry 208.

User data and models 231 include various data associated with the user (e.g., user-specific vocabulary data, user preference data, user-specified name pronunciations, data from the user's electronic address book, to-do lists, shopping lists, etc.) to provide the client-side functionalities of the digital assistant. Further, user data and models 231 include various models (e.g., speech recognition models, statistical language models, natural language processing models, ontology, task flow models, service models, etc.) for processing user input and determining user intent.

In some examples, digital assistant client module 229 utilizes the various sensors, subsystems, and peripheral devices of portable multifunction device 200 to gather additional information from the surrounding environment of the portable multifunction device 200 to establish a context associated with a user, the current user interaction, and/or the current user input. In some examples, digital assistant client module 229 provides the contextual information or a subset thereof with the user input to DA server 106 to help infer the user's intent. In some examples, the digital assistant also uses the contextual information to determine how to prepare and deliver outputs to the user. Contextual information is referred to as context data.

In some examples, the contextual information that accompanies the user input includes sensor information, e.g., lighting, ambient noise, ambient temperature, images or videos of the surrounding environment, etc. In some examples, the contextual information can also include the physical state of the device, e.g., device orientation, device location, device temperature, power level, speed, acceleration, motion patterns, cellular signals strength, etc. In some examples, information related to the software state of DA server 106, e.g., running processes, installed programs, past and present network activities, background services, error logs, resources usage, etc., and of portable multifunction device 200 is provided to DA server 106 as contextual information associated with a user input.

In some examples, the digital assistant client module 229 selectively provides information (e.g., user data 231) stored on the portable multifunction device 200 in response to requests from DA server 106. In some examples, digital assistant client module 229 also elicits additional input from the user via a natural language dialogue or other user interfaces upon request by DA server 106. Digital assistant client module 229 passes the additional input to DA server 106 to help DA server 106 in intent deduction and/or fulfillment of the user's intent expressed in the user request.

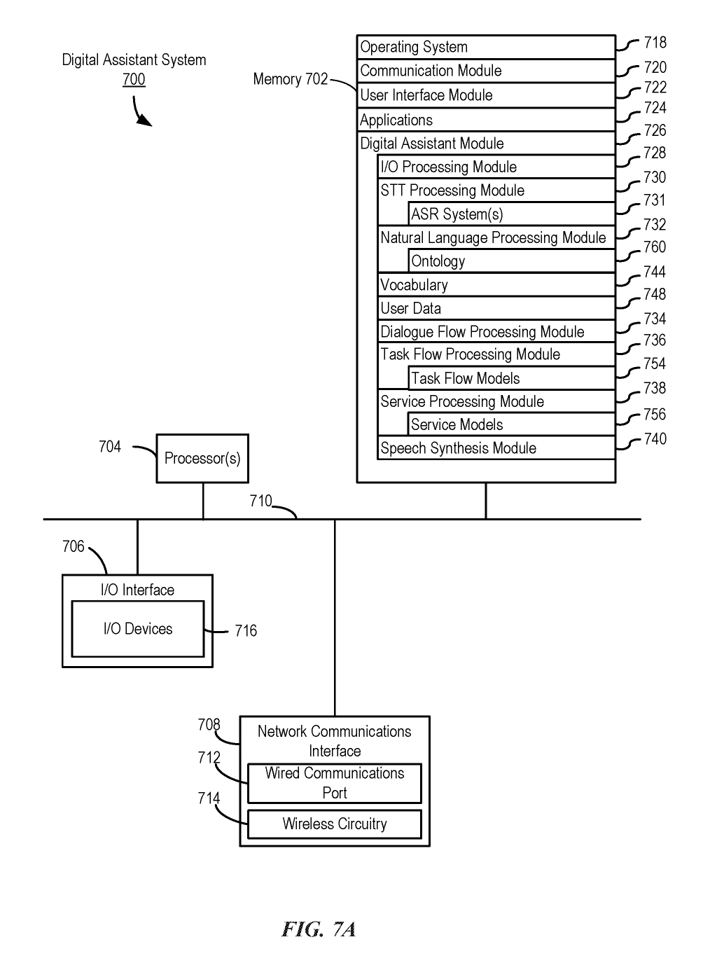

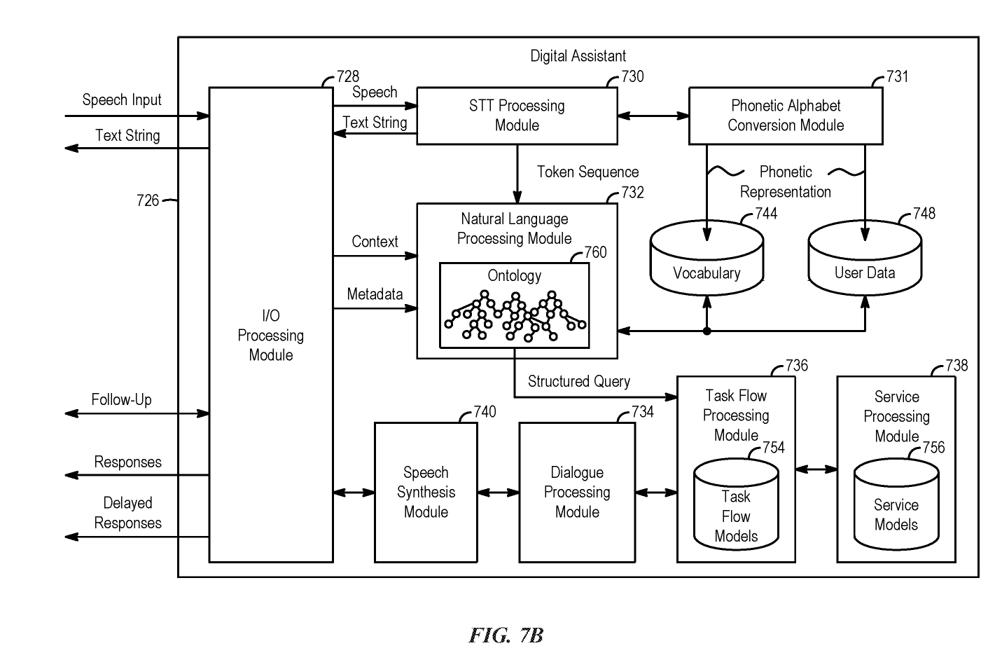

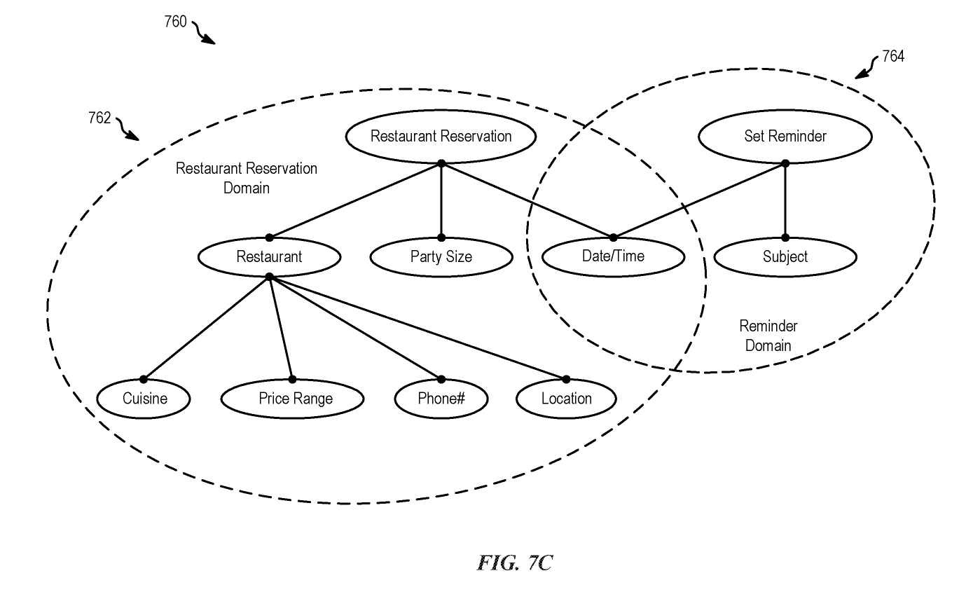

A more detailed description of a digital assistant is described below with reference to FIGS. 7A-C. It should be recognized that digital assistant client module 229 can include any number of the sub-modules of digital assistant module 726 described below.

Applications 236 include the following modules (or sets of instructions), or a subset or superset thereof:
Contacts module 237 (sometimes called an address book or contact list);
Telephone module 238;
Video conference module 239;
E-mail client module 240;
Instant messaging (IM) module 241;
Workout support module 242;
Camera module 243 for still and/or video images;
Image management module 244;
Video player module;
Music player module;
Browser module 247;
Calendar module 248;
Widget modules 249, which includes, in some examples, one or more of: weather widget 249-1, stocks widget 249-2, calculator widget 249-3, alarm clock widget 249-4, dictionary widget 249-5, and other widgets obtained by the user, as well as user-created widgets 249-6;
Widget creator module 250 for making user-created widgets 249-6;
Search module 251;
Video and music player module 252, which merges video player module and music player module;
Notes module 253;
Map module 254; and/or
Online video module 255.

Examples of other applications 236 that are stored in memory 202 include other word processing applications, other image editing applications, drawing applications, presentation applications, JAVA-enabled applications, encryption, digital rights management, voice recognition, and voice replication.

In conjunction with touch screen 212, display controller 256, contact/motion module 230, graphics module 232, and text input module 234, contacts module 237 are used to manage an address book or contact list (e.g., stored in application internal state 292 of contacts module 237 in memory 202 or memory 470), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 238, video conference module 239, e-mail 240, or IM 241; and so forth.

In conjunction with RF circuitry 208, audio circuitry 210, speaker 211, microphone 213, touch screen 212, display controller 256, contact/motion module 230, graphics module 232, and text input module 234, telephone module 238 are used to enter a sequence of characters corresponding to a telephone number, access one or more telephone numbers in contacts module 237, modify a telephone number that has been entered, dial a respective telephone number, conduct a conversation, and disconnect or hang up when the conversation is completed. As noted above, the wireless communication uses any of a plurality of communications standards, protocols, and technologies.

In conjunction with RF circuitry 208, audio circuitry 210, speaker 211, microphone 213, touch screen 212, display controller 256, optical sensor 264, optical sensor controller 258, contact/motion module 230, graphics module 232, text input module 234, contacts module 237, and telephone module 238, video conference module 239 includes executable instructions to initiate, conduct, and terminate a video conference between a user and one or more other participants in accordance with user instructions.

In conjunction with RF circuitry 208, touch screen 212, display controller 256, contact/motion module 230, graphics module 232, and text input module 234, e-mail client module 240 includes executable instructions to create, send, receive, and manage e-mail in response to user instructions. In conjunction with image management module 244, e-mail client module 240 makes it very easy to create and send e-mails with still or video images taken with camera module 243.

In conjunction with RF circuitry 208, touch screen 212, display controller 256, contact/motion module 230, graphics module 232, and text input module 234, the instant messaging module 241 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 208, touch screen 212, display controller 256, contact/motion module 230, graphics module 232, text input module 234, GPS module 235, map module 254, and music player module, workout support module 242 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 212, display controller 256, optical sensor(s) 264, optical sensor controller 258, contact/motion module 230, graphics module 232, and image management module 244, camera module 243 includes executable instructions to capture still images or video (including a video stream) and store them into memory 202, modify characteristics of a still image or video, or delete a still image or video from memory 202.

In conjunction with touch screen 212, display controller 256, contact/motion module 230, graphics module 232, text input module 234, and camera module 243, image management module 244 includes executable instructions to arrange, modify (e.g., edit), or otherwise manipulate, label, delete, present (e.g., in a digital slide show or album), and store still and/or video images.

In conjunction with RF circuitry 208, touch screen 212, display controller 256, contact/motion module 230, graphics module 232, and text input module 234, browser module 247 includes executable instructions to browse the Internet in accordance with user instructions, including searching, linking to, receiving, and displaying web pages or portions thereof, as well as attachments and other files linked to web pages.

In conjunction with RF circuitry 208, touch screen 212, display controller 256, contact/motion module 230, graphics module 232, text input module 234, e-mail client module 240, and browser module 247, calendar module 248 includes executable instructions to create, display, modify, and store calendars and data associated with calendars (e.g., calendar entries, to-do lists, etc.) in accordance with user instructions.

In conjunction with RF circuitry 208, touch screen 212, display controller 256, contact/motion module 230, graphics module 232, text input module 234, and browser module 247, widget modules 249 are mini-applications that can be downloaded and used by a user (e.g., weather widget 249-1, stocks widget 249-2, calculator widget 249-3, alarm clock widget 249-4, and dictionary widget 249-5) or created by the user (e.g., user-created widget 249-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 208, touch screen 212, display controller 256, contact/motion module 230, graphics module 232, text input module 234, and browser module 247, the widget creator module 250 are used by a user to create widgets (e.g., turning a user-specified portion of a web page into a widget).

In conjunction with touch screen 212, display controller 256, contact/motion module 230, graphics module 232, and text input module 234, search module 251 includes executable instructions to search for text, music, sound, image, video, and/or other files in memory 202 that match one or more search criteria (e.g., one or more user-specified search terms) in accordance with user instructions.

In conjunction with touch screen 212, display controller 256, contact/motion module 230, graphics module 232, audio circuitry 210, speaker 211, RF circuitry 208, and browser module 247, video and music player module 252 includes executable instructions that allow the user to download and play back recorded music and other sound files stored in one or more file formats, such as MP3 or AAC files, and executable instructions to display, present, or otherwise play back videos (e.g., on touch screen 212 or on an external, connected display via external port 224). In some embodiments, device 200 optionally includes the functionality of an MP3 player, such as an iPod (trademark of Apple Inc.).

In conjunction with touch screen 212, display controller 256, contact/motion module 230, graphics module 232, and text input module 234, notes module 253 includes executable instructions to create and manage notes, to-do lists, and the like in accordance with user instructions.

In conjunction with RF circuitry 208, touch screen 212, display controller 256, contact/motion module 230, graphics module 232, text input module 234, GPS module 235, and browser module 247, map module 254 are used to receive, display, modify, and store maps and data associated with maps (e.g., driving directions, data on stores and other points of interest at or near a particular location, and other location-based data) in accordance with user instructions.

In conjunction with touch screen 212, display controller 256, contact/motion module 230, graphics module 232, audio circuitry 210, speaker 211, RF circuitry 208, text input module 234, e-mail client module 240, and browser module 247, online video module 255 includes instructions that allow the user to access, browse, receive (e.g., by streaming and/or download), play back (e.g., on the touch screen or on an external, connected display via external port 224), send an e-mail with a link to a particular online video, and otherwise manage online videos in one or more file formats, such as H.264. In some embodiments, instant messaging module 241, rather than e-mail client module 240, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules can be combined or otherwise rearranged in various embodiments. For example, video player module can be combined with music player module into a single module (e.g., video and music player module 252, FIG. 2A). In some embodiments, memory 202 stores a subset of the modules and data structures identified above. Furthermore, memory 202 stores additional modules and data structures not described above.

In some embodiments, device 200 is a device where operation of a predefined set of functions on the device is performed exclusively through a touch screen and/or a touchpad. By using a touch screen and/or a touchpad as the primary input control device for operation of device 200, the number of physical input control devices (such as push buttons, dials, and the like) on device 200 is reduced.

The predefined set of functions that are performed exclusively through a touch screen and/or a touchpad optionally include navigation between user interfaces. In some embodiments, the touchpad, when touched by the user, navigates device 200 to a main, home, or root menu from any user interface that is displayed on device 200. In such embodiments, a “menu button” is implemented using a touchpad. In some other embodiments, the menu button is a physical push button or other physical input control device instead of a touchpad.

FIG. 2B is a block diagram illustrating exemplary components for event handling in accordance with some embodiments. In some embodiments, memory 202 (FIG. 2A) or 470 (FIG. 4) includes event sorter 270 (e.g., in operating system 226) and a respective application 236-1 (e.g., any of the aforementioned applications 237-251, 255, 480-490).

Event sorter 270 receives event information and determines the application 236-1 and application view 291 of application 236-1 to which to deliver the event information. Event sorter 270 includes event monitor 271 and event dispatcher module 274. In some embodiments, application 236-1 includes application internal state 292, which indicates the current application view(s) displayed on touch-sensitive display 212 when the application is active or executing. In some embodiments, device/global internal state 257 is used by event sorter 270 to determine which application(s) is (are) currently active, and application internal state 292 is used by event sorter 270 to determine application views 291 to which to deliver event information.

In some embodiments, application internal state 292 includes additional information, such as one or more of: resume information to be used when application 236-1 resumes execution, user interface state information that indicates information being displayed or that is ready for display by application 236-1, a state queue for enabling the user to go back to a prior state or view of application 236-1, and a redo/undo queue of previous actions taken by the user.

Event monitor 271 receives event information from peripherals interface 218. Event information includes information about a sub-event (e.g., a user touch on touch-sensitive display 212, as part of a multi-touch gesture). Peripherals interface 218 transmits information it receives from I/O subsystem 206 or a sensor, such as proximity sensor 266, accelerometer(s) 268, and/or microphone 213 (through audio circuitry 210). Information that peripherals interface 218 receives from I/O subsystem 206 includes information from touch-sensitive display 212 or a touch-sensitive surface.

In some embodiments, event monitor 271 sends requests to the peripherals interface 218 at predetermined intervals. In response, peripherals interface 218 transmits event information. In other embodiments, peripherals interface 218 transmits event information only when there is a significant event (e.g., receiving an input above a predetermined noise threshold and/or for more than a predetermined duration).

In some embodiments, event sorter 270 also includes a hit view determination module 272 and/or an active event recognizer determination module 273.

Hit view determination module 272 provides software procedures for determining where a sub-event has taken place within one or more views when touch-sensitive display 212 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected correspond to programmatic levels within a programmatic or view hierarchy of the application. For example, the lowest level view in which a touch is detected is called the hit view, and the set of events that are recognized as proper inputs is determined based, at least in part, on the hit view of the initial touch that begins a touch-based gesture.

Hit view determination module 272 receives information related to sub events of a touch-based gesture. When an application has multiple views organized in a hierarchy, hit view determination module 272 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 272, the hit view typically receives all sub-events related to the same touch or input source for which it was identified as the hit view.

Active event recognizer determination module 273 determines which view or views within a view hierarchy should receive a particular sequence of sub-events. In some embodiments, active event recognizer determination module 273 determines that only the hit view should receive a particular sequence of sub-events. In other embodiments, active event recognizer determination module 273 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 274 dispatches the event information to an event recognizer (e.g., event recognizer 280). In embodiments including active event recognizer determination module 273, event dispatcher module 274 delivers the event information to an event recognizer determined by active event recognizer determination module 273. In some embodiments, event dispatcher module 274 stores in an event queue the event information, which is retrieved by a respective event receiver 282.

In some embodiments, operating system 226 includes event sorter 270. Alternatively, application 236-1 includes event sorter 270. In yet other embodiments, event sorter 270 is a stand-alone module, or a part of another module stored in memory 202, such as contact/motion module 230.

In some embodiments, application 236-1 includes a plurality of event handlers 290 and one or more application views 291, each of which includes instructions for handling touch events that occur within a respective view of the application's user interface. Each application view 291 of the application 236-1 includes one or more event recognizers 280. Typically, a respective application view 291 includes a plurality of event recognizers 280. In other embodiments, one or more of event recognizers 280 are part of a separate module, such as a user interface kit (not shown) or a higher level object from which application 236-1 inherits methods and other properties. In some embodiments, a respective event handler 290 includes one or more of: data updater 276, object updater 277, GUI updater 278, and/or event data 279 received from event sorter 270. Event handler 290 utilizes or calls data updater 276, object updater 277, or GUI updater 278 to update the application internal state 292. Alternatively, one or more of the application views 291 include one or more respective event handlers 290. Also, in some embodiments, one or more of data updater 276, object updater 277, and GUI updater 278 are included in a respective application view 291.

A respective event recognizer 280 receives event information (e.g., event data 279) from event sorter 270 and identifies an event from the event information. Event recognizer 280 includes event receiver 282 and event comparator 284. In some embodiments, event recognizer 280 also includes at least a subset of: metadata 283, and event delivery instructions 288 (which include sub-event delivery instructions).

Event receiver 282 receives event information from event sorter 270. The event information includes information about a sub-event, for example, a touch or a touch movement. Depending on the sub-event, the event information also includes additional information, such as location of the sub-event. When the sub-event concerns motion of a touch, the event information also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 284 compares the event information to predefined event or sub-event definitions and, based on the comparison, determines an event or sub event, or determines or updates the state of an event or sub-event. In some embodiments, event comparator 284 includes event definitions 286. Event definitions 286 contain definitions of events (e.g., predefined sequences of sub-events), for example, event 1 (287-1), event 2 (287-2), and others. In some embodiments, sub-events in an event (287) include, for example, touch begin, touch end, touch movement, touch cancellation, and multiple touching. In one example, the definition for event 1 (287-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (287-2) is a dragging on a displayed object. The dragging, for example, comprises a touch (or contact) on the displayed object for a predetermined phase, a movement of the touch across touch-sensitive display 212, and liftoff of the touch (touch end). In some embodiments, the event also includes information for one or more associated event handlers 290.

In some embodiments, event definition 287 includes a definition of an event for a respective user-interface object. In some embodiments, event comparator 284 performs a hit test to determine which user-interface object is associated with a sub-event. For example, in an application view in which three user-interface objects are displayed on touch-sensitive display 212, when a touch is detected on touch-sensitive display 212, event comparator 284 performs a hit test to determine which of the three user-interface objects is associated with the touch (sub-event). If each displayed object is associated with a respective event handler 290, the event comparator uses the result of the hit test to determine which event handler 290 should be activated. For example, event comparator 284 selects an event handler associated with the sub-event and the object triggering the hit test.

In some embodiments, the definition for a respective event (287) also includes delayed actions that delay delivery of the event information until after it has been determined whether the sequence of sub-events does or does not correspond to the event recognizer's event type.

When a respective event recognizer 280 determines that the series of sub-events do not match any of the events in event definitions 286, the respective event recognizer 280 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 280 includes metadata 283 with configurable properties, flags, and/or lists that indicate how the event delivery system should perform sub-event delivery to actively involved event recognizers. In some embodiments, metadata 283 includes configurable properties, flags, and/or lists that indicate how event recognizers interact, or are enabled to interact, with one another. In some embodiments, metadata 283 includes configurable properties, flags, and/or lists that indicate whether sub-events are delivered to varying levels in the view or programmatic hierarchy.

In some embodiments, a respective event recognizer 280 activates event handler 290 associated with an event when one or more particular sub-events of an event are recognized. In some embodiments, a respective event recognizer 280 delivers event information associated with the event to event handler 290. Activating an event handler 290 is distinct from sending (and deferred sending) sub-events to a respective hit view. In some embodiments, event recognizer 280 throws a flag associated with the recognized event, and event handler 290 associated with the flag catches the flag and performs a predefined process.

In some embodiments, event delivery instructions 288 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 276 creates and updates data used in application 236-1. For example, data updater 276 updates the telephone number used in contacts module 237, or stores a video file used in video player module. In some embodiments, object updater 277 creates and updates objects used in application 236-1. For example, object updater 277 creates a new user-interface object or updates the position of a user-interface object. GUI updater 278 updates the GUI. For example, GUI updater 278 prepares display information and sends it to graphics module 232 for display on a touch-sensitive display.

In some embodiments, event handler(s) 290 includes or has access to data updater 276, object updater 277, and GUI updater 278. In some embodiments, data updater 276, object updater 277, and GUI updater 278 are included in a single module of a respective application 236-1 or application view 291. In other embodiments, they are included in two or more software modules.

It shall be understood that the foregoing discussion regarding event handling of user touches on touch-sensitive displays also applies to other forms of user inputs to operate multifunction devices 200 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 3 illustrates a portable multifunction device 200 having a touch screen 212 in accordance with some embodiments. The touch screen optionally displays one or more graphics within user interface (UI) 300. In this embodiment, as well as others described below, a user is enabled to select one or more of the graphics by making a gesture on the graphics, for example, with one or more fingers 302 (not drawn to scale in the figure) or one or more styluses 303 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 200. In some implementations or circumstances, inadvertent contact with a graphic does not select the graphic. For example, a swipe gesture that sweeps over an application icon optionally does not select the corresponding application when the gesture corresponding to selection is a tap.

Device 200 also includes one or more physical buttons, such as “home” or menu button 304. As described previously, menu button 304 is used to navigate to any application 236 in a set of applications that is executed on device 200. Alternatively, in some embodiments, the menu button is implemented as a soft key in a GUI displayed on touch screen 212.

In one embodiment, device 200 includes touch screen 212, menu button 304, push button 306 for powering the device on/off and locking the device, volume adjustment button(s) 308, subscriber identity module (SIM) card slot 310, headset jack 312, and docking/charging external port 224. Push button 306 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 200 also accepts verbal input for activation or deactivation of some functions through microphone 213. Device 200 also, optionally, includes one or more contact intensity sensors 265 for detecting intensity of contacts on touch screen 212 and/or one or more tactile output generators 267 for generating tactile outputs for a user of device 200.

FIG. 4 is a block diagram of an exemplary multifunction device with a display and a touch-sensitive surface in accordance with some embodiments. Device 400 need not be portable. In some embodiments, device 400 is a laptop computer, a desktop computer, a tablet computer, a multimedia player device, a navigation device, an educational device (such as a child's learning toy), a gaming system, or a control device (e.g., a home or industrial controller). Device 400 typically includes one or more processing units (CPUs) 410, one or more network or other communications interfaces 460, memory 470, and one or more communication buses 420 for interconnecting these components. Communication buses 420 optionally include circuitry (sometimes called a chipset) that interconnects and controls communications between system components. Device 400 includes input/output (I/O) interface 430 comprising display 440, which is typically a touch screen display. I/O interface 430 also optionally includes a keyboard and/or mouse (or other pointing device) 450 and touchpad 455, tactile output generator 457 for generating tactile outputs on device 400 (e.g., similar to tactile output generator(s) 267 described above with reference to FIG. 2A), sensors 459 (e.g., optical, acceleration, proximity, touch-sensitive, and/or contact intensity sensors similar to contact intensity sensor(s) 265 described above with reference to FIG. 2A). Memory 470 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 470 optionally includes one or more storage devices remotely located from CPU(s) 410. In some embodiments, memory 470 stores programs, modules, and data structures analogous to the programs, modules, and data structures stored in memory 202 of portable multifunction device 200 (FIG. 2A), or a subset thereof. Furthermore, memory 470 optionally stores additional programs, modules, and data structures not present in memory 202 of portable multifunction device 200. For example, memory 470 of device 400 optionally stores drawing module 480, presentation module 482, word processing module 484, website creation module 486, disk authoring module 488, and/or spreadsheet module 490, while memory 202 of portable multifunction device 200 (FIG. 2A) optionally does not store these modules.

Each of the above-identified elements in FIG. 4 is, in some examples, stored in one or more of the previously mentioned memory devices. Each of the above-identified modules corresponds to a set of instructions for performing a function described above. The above-identified modules or programs (e.g., sets of instructions) need not be implemented as separate software programs, procedures, or modules, and thus various subsets of these modules are combined or otherwise rearranged in various embodiments. In some embodiments, memory 470 stores a subset of the modules and data structures identified above. Furthermore, memory 470 stores additional modules and data structures not described above.

Attention is now directed towards embodiments of user interfaces that can be implemented on, for example, portable multifunction device 200.

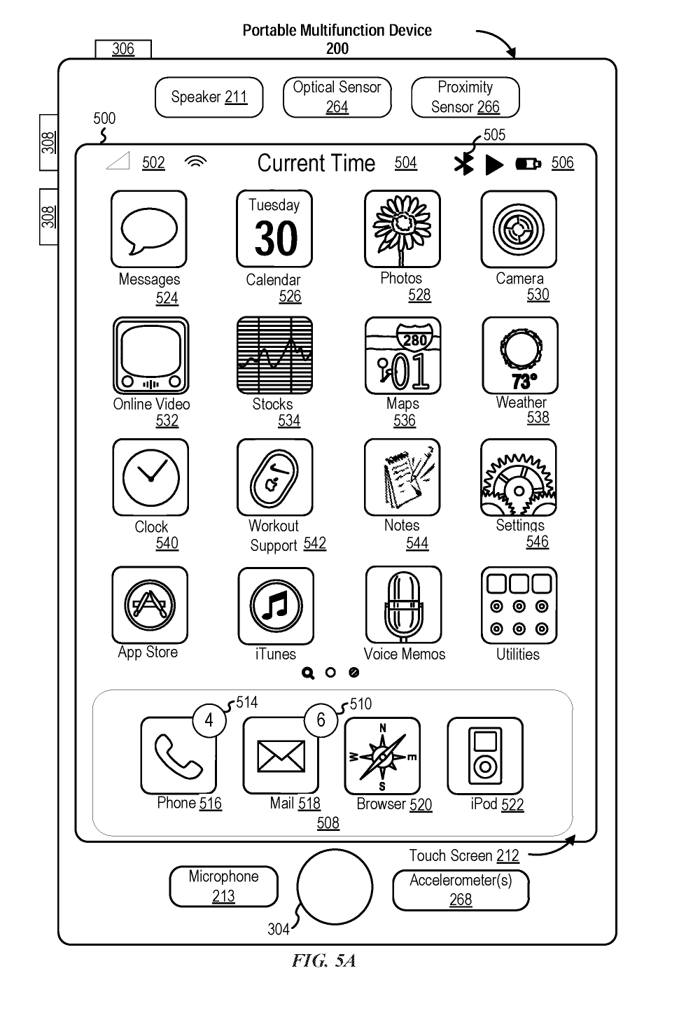

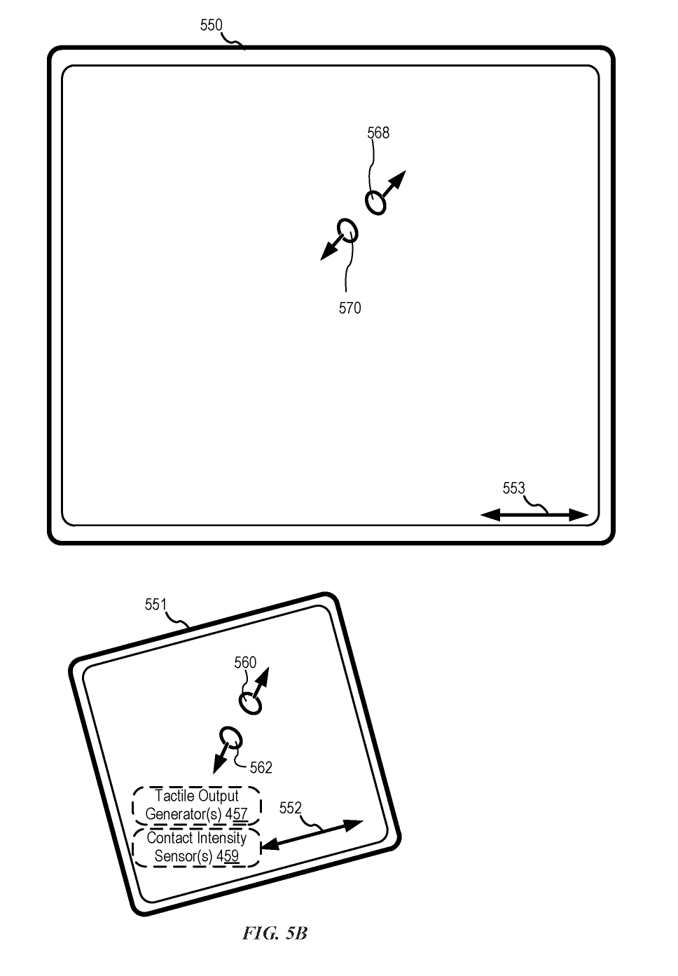

FIG. 5A illustrates an exemplary user interface for a menu of applications on portable multifunction device 200 in accordance with some embodiments. Similar user interfaces are implemented on device 400. In some embodiments, user interface 500 includes the following elements, or a subset or superset thereof:

Signal strength indicator(s) 502 for wireless communication(s), such as cellular and Wi-Fi signals;
Time 504;
Bluetooth indicator 505;
Battery status indicator 506;
Tray 508 with icons for frequently used applications, such as:
   Icon 516 for telephone module 238, labeled “Phone,” which optionally includes an indicator 514 of the number of missed calls or voicemail messages;
   Icon 518 for e-mail client module 240, labeled “Mail,” which optionally includes an indicator 510 of the number of unread e-mails;
   Icon 520 for browser module 247, labeled “Browser;” and
   Icon 522 for video and music player module 252, also referred to as iPod (trademark of Apple Inc.) module 252, labeled “iPod;” and
Icons for other applications, such as:
   Icon 524 for IM module 241, labeled “Messages;”
   Icon 526 for calendar module 248, labeled “Calendar;”
   Icon 528 for image management module 244, labeled “Photos;”
   Icon 530 for camera module 243, labeled “Camera;”
   Icon 532 for online video module 255, labeled “Online Video;”
   Icon 534 for stocks widget 249-2, labeled “Stocks;”
   Icon 536 for map module 254, labeled “Maps;”
   Icon 538 for weather widget 249-1, labeled “Weather;”
   Icon 540 for alarm clock widget 249-4, labeled “Clock;”
   Icon 542 for workout support module 242, labeled “Workout Support;”
   Icon 544 for notes module 253, labeled “Notes;” and
   Icon 546 for a settings application or module, labeled “Settings,” which provides access to settings for device 200 and its various applications 236.

It should be noted that the icon labels illustrated in FIG. 5A are merely exemplary. For example, icon 522 for video and music player module 252 is optionally labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 5B illustrates an exemplary user interface on a device (e.g., device 400, FIG. 4) with a touch-sensitive surface 551 (e.g., a tablet or touchpad 455, FIG. 4) that is separate from the display 550 (e.g., touch screen display 212). Device 400 also, optionally, includes one or more contact intensity sensors (e.g., one or more of sensors 457) for detecting intensity of contacts on touch-sensitive surface 551 and/or one or more tactile output generators 459 for generating tactile outputs for a user of device 400.

Although some of the examples which follow will be given with reference to inputs on touch screen display 212 (where the touch-sensitive surface and the display are combined), in some embodiments, the device detects inputs on a touch-sensitive surface that is separate from the display, as shown in FIG. 5B. In some embodiments, the touch-sensitive surface (e.g., 551 in FIG. 5B) has a primary axis (e.g., 552 in FIG. 5B) that corresponds to a primary axis (e.g., 553 in FIG. 5B) on the display (e.g., 550). In accordance with these embodiments, the device detects contacts (e.g., 560 and 562 in FIG. 5B) with the touch-sensitive surface 551 at locations that correspond to respective locations on the display (e.g., in FIG. 5B, 560 corresponds to 568 and 562 corresponds to 570). In this way, user inputs (e.g., contacts 560 and 562, and movements thereof) detected by the device on the touch-sensitive surface (e.g., 551 in FIG. 5B) are used by the device to manipulate the user interface on the display (e.g., 550 in FIG. 5B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

FIG. 6A illustrates exemplary personal electronic device 600. Device 600 includes body 602. In some embodiments, device 600 includes some or all of the features described with respect to devices 200 and 400 (e.g., FIGS. 2A-4B). In some embodiments, device 600 has touch-sensitive display screen 604, hereafter touch screen 604. Alternatively, or in addition to touch screen 604, device 600 has a display and a touch-sensitive surface. As with devices 200 and 400, in some embodiments, touch screen 604 (or the touch-sensitive surface) has one or more intensity sensors for detecting intensity of contacts (e.g., touches) being applied. The one or more intensity sensors of touch screen 604 (or the touch-sensitive surface) provide output data that represents the intensity of touches. The user interface of device 600 responds to touches based on their intensity, meaning that touches of different intensities can invoke different user interface operations on device 600.

Techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, and International Patent Application Serial No. PCT/US2013/069483, titled “Device, Method, and Graphical User Interface for Transitioning Between Touch Input to Display Output Relationships,” filed Nov. 11, 2013, each of which is hereby incorporated by reference in their entirety.

In some embodiments, device 600 has one or more input mechanisms 606 and 608. Input mechanisms 606 and 608, if included, are physical. Examples of physical input mechanisms include push buttons and rotatable mechanisms. In some embodiments, device 600 has one or more attachment mechanisms. Such attachment mechanisms, if included, can permit attachment of device 600 with, for example, hats, eyewear, earrings, necklaces, shirts, jackets, bracelets, watch straps, chains, trousers, belts, shoes, purses, backpacks, and so forth. These attachment mechanisms permit device 600 to be worn by a user.

FIG. 6B depicts exemplary personal electronic device 600. In some embodiments, device 600 includes some or all of the components described with respect to FIGS. 2A, 2B, and 4. Device 600 has bus 612 that operatively couples I/O section 614 with one or more computer processors 616 and memory 618. I/O section 614 is connected to display 604, which can have touch-sensitive component 622 and, optionally, touch-intensity sensitive component 624. In addition, I/O section 614 is connected with communication unit 630 for receiving application and operating system data, using Wi-Fi, Bluetooth, near field communication (NFC), cellular, and/or other wireless communication techniques. Device 600 includes input mechanisms 606 and/or 608. Input mechanism 606 is a rotatable input device or a depressible and rotatable input device, for example. Input mechanism 608 is a button, in some examples.

Input mechanism 608 is a microphone, in some examples. Personal electronic device 600 includes, for example, various sensors, such as GPS sensor 632, accelerometer 634, directional sensor 640 (e.g., compass), gyroscope 636, motion sensor 638, and/or a combination thereof, all of which are operatively connected to I/O section 614.

Memory 618 of personal electronic device 600 is a non-transitory computer-readable storage medium, for storing computer-executable instructions, which, when executed by one or more computer processors 616, for example, cause the computer processors to perform the techniques and processes described below. The computer-executable instructions, for example, are also stored and/or transported within any non-transitory computer-readable storage medium for use by or in connection with an instruction execution system, apparatus, or device, such as a computer-based system, processor-containing system, or other system that can fetch the instructions from the instruction execution system, apparatus, or device and execute the instructions. Personal electronic device 600 is not limited to the components and configuration of FIG. 6B, but can include other or additional components in multiple configurations.

As used here, the term “affordance” refers to a user-interactive graphical user interface object that is, for example, displayed on the display screen of devices 200, 400, and/or 600 (FIGS. 2, 4, and 6). For example, an image (e.g., icon), a button, and text (e.g., hyperlink) each constitutes an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 455 in FIG. 4 or touch-sensitive surface 551 in FIG. 5B) while the cursor is over a particular user interface element (e.g., a button, window, slider or other user interface element), the particular user interface element is adjusted in accordance with the detected input. In some implementations that include a touch screen display (e.g., touch-sensitive display system 212 in FIG. 2A or touch screen 212 in FIG. 5A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation) rather than being used to determine whether to perform a first operation or a second operation.

In some embodiments, a portion of a gesture is identified for purposes of determining a characteristic intensity. For example, a touch-sensitive surface receives a continuous swipe contact transitioning from a start location and reaching an end location, at which point the intensity of the contact increases. In this example, the characteristic intensity of the contact at the end location is based on only a portion of the continuous swipe contact, and not the entire swipe contact (e.g., only the portion of the swipe contact at the end location). In some embodiments, a smoothing algorithm is applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

### 3. Digital Assistant System

FIG. 7A illustrates a block diagram of digital assistant system 700 in accordance with various examples. In some examples, digital assistant system 700 is implemented on a standalone computer system. In some examples, digital assistant system 700 is distributed across multiple computers. In some examples, some of the modules and functions of the digital assistant are divided into a server portion and a client portion, where the client portion resides on one or more user devices (e.g., devices 104, 122, 200, 400, or 600) and communicates with the server portion (e.g., server system 108) through one or more networks, e.g., as shown in FIG. 1. In some examples, digital assistant system 700 is an implementation of server system 108 (and/or DA server 106) shown in FIG. 1. It should be noted that digital assistant system 700 is only one example of a digital assistant system, and that digital assistant system 700 can have more or fewer components than shown, can combine two or more components, or can have a different configuration or arrangement of the components. The various components shown in FIG. 7A are implemented in hardware, software instructions for execution by one or more processors, firmware, including one or more signal processing and/or application specific integrated circuits, or a combination thereof.

Digital assistant system 700 includes memory 702, one or more processors 704, input/output (I/O) interface 706, and network communications interface 708. These components can communicate with one another over one or more communication buses or signal lines 710.

In some examples, memory 702 includes a non-transitory computer-readable medium, such as high-speed random access memory and/or a non-volatile computer-readable storage medium (e.g., one or more magnetic disk storage devices, flash memory devices, or other non-volatile solid-state memory devices).

In some examples, I/O interface 706 couples input/output devices 716 of digital assistant system 700, such as displays, keyboards, touch screens, and microphones, to user interface module 722. I/O interface 706, in conjunction with user interface module 722, receives user inputs (e.g., voice input, keyboard inputs, touch inputs, etc.) and processes them accordingly. In some examples, e.g., when the digital assistant is implemented on a standalone user device, digital assistant system 700 includes any of the components and I/O communication interfaces described with respect to devices 200, 400, or 600 in FIGS. 2A, 4, 6A-B, respectively. In some examples, digital assistant system 700 represents the server portion of a digital assistant implementation, and can interact with the user through a client-side portion residing on a user device (e.g., devices 104, 200, 400, or 600).

In some examples, the network communications interface 708 includes wired communication port(s) 712 and/or wireless transmission and reception circuitry 714. The wired communication port(s) receives and send communication signals via one or more wired interfaces, e.g., Ethernet, Universal Serial Bus (USB), FIREWIRE, etc. The wireless circuitry 714 receives and sends RF signals and/or optical signals from/to communications networks and other communications devices. The wireless communications use any of a plurality of communications standards, protocols, and technologies, such as GSM, EDGE, CDMA, TDMA, Bluetooth, Wi-Fi, VoIP, Wi-MAX, or any other suitable communication protocol. Network communications interface 708 enables communication between digital assistant system 700 with networks, such as the Internet, an intranet, and/or a wireless network, such as a cellular telephone network, a wireless local area network (LAN), and/or a metropolitan area network (MAN), and other devices.

In some examples, memory 702, or the computer-readable storage media of memory 702, stores programs, modules, instructions, and data structures including all or a subset of: operating system 718, communications module 720, user interface module 722, one or more applications 724, and digital assistant module 726. In particular, memory 702, or the computer-readable storage media of memory 702, stores instructions for performing the processes described below. One or more processors 704 execute these programs, modules, and instructions, and reads/writes from/to the data structures.

Operating system 718 (e.g., Darwin, RTXC, LINUX, UNIX, iOS, OS X, WINDOWS, or an embedded operating system such as VxWorks) includes various software components and/or drivers for controlling and managing general system tasks (e.g., memory management, storage device control, power management, etc.) and facilitates communications between various hardware, firmware, and software components.

Communications module 720 facilitates communications between digital assistant system 700 with other devices over network communications interface 708. For example, communications module 720 communicates with RF circuitry 208 of electronic devices such as devices 200, 400, and 600 shown in FIG. 2A, 4, 6A-B, respectively. Communications module 720 also includes various components for handling data received by wireless circuitry 714 and/or wired communications port 712.

User interface module 722 receives commands and/or inputs from a user via I/O interface 706 (e.g., from a keyboard, touch screen, pointing device, controller, and/or microphone), and generate user interface objects on a display. User interface module 722 also prepares and delivers outputs (e.g., speech, sound, animation, text, icons, vibrations, haptic feedback, light, etc.) to the user via the I/O interface 706 (e.g., through displays, audio channels, speakers, touch-pads, etc.).

Applications 724 include programs and/or modules that are configured to be executed by one or more processors 704. For example, if the digital assistant system is implemented on a standalone user device, applications 724 include user applications, such as games, a calendar application, a navigation application, or an email application. If digital assistant system 700 is implemented on a server, applications 724 include resource management applications, diagnostic applications, or scheduling applications, for example.

Memory 702 also stores digital assistant module 726 (or the server portion of a digital assistant). In some examples, digital assistant module 726 includes the following sub-modules, or a subset or superset thereof: input/output processing module 728, speech-to-text (STT) processing module 730, natural language processing module 732, dialogue flow processing module 734, task flow processing module 736, service processing module 738, and speech synthesis module 740. Each of these modules has access to one or more of the following systems or data and models of the digital assistant module 726, or a subset or superset thereof: ontology 760, vocabulary index 744, user data 748, task flow models 754, service models 756, and ASR systems.

In some examples, using the processing modules, data, and models implemented in digital assistant module 726, the digital assistant can perform at least some of the following: converting speech input into text; identifying a user's intent expressed in a natural language input received from the user; actively eliciting and obtaining information needed to fully infer the user's intent (e.g., by disambiguating words, games, intentions, etc.); determining the task flow for fulfilling the inferred intent; and executing the task flow to fulfill the inferred intent.

In some examples, as shown in FIG. 7B, I/O processing module 728 interacts with the user through I/O devices 716 in FIG. 7A or with a user device (e.g., devices 104, 200, 400, or 600) through network communications interface 708 in FIG. 7A to obtain user input (e.g., a speech input) and to provide responses (e.g., as speech outputs) to the user input. I/O processing module 728 optionally obtains contextual information associated with the user input from the user device, along with or shortly after the receipt of the user input. The contextual information includes user-specific data, vocabulary, and/or preferences relevant to the user input. In some examples, the contextual information also includes software and hardware states of the user device at the time the user request is received, and/or information related to the surrounding environment of the user at the time that the user request was received. In some examples, I/O processing module 728 also sends follow-up questions to, and receive answers from, the user regarding the user request. When a user request is received by I/O processing module 728 and the user request includes speech input, I/O processing module 728 forwards the speech input to STT processing module 730 (or speech recognizer) for speech-to-text conversions.

STT processing module 730 includes one or more ASR systems. The one or more ASR systems can process the speech input that is received through I/O processing module 728 to produce a recognition result. Each ASR system includes a front-end speech pre-processor. The front-end speech pre-processor extracts representative features from the speech input. For example, the front-end speech pre-processor performs a Fourier transform on the speech input to extract spectral features that characterize the speech input as a sequence of representative multi-dimensional vectors. Further, each ASR system includes one or more speech recognition models (e.g., acoustic models and/or language models) and implements one or more speech recognition engines. Examples of speech recognition models include Hidden Markov Models, Gaussian-Mixture Models, Deep Neural Network Models, n-gram language models, and other statistical models. Examples of speech recognition engines include the dynamic time warping based engines and weighted finite-state transducers (WFST) based engines. The one or more speech recognition models and the one or more speech recognition engines are used to process the extracted representative features of the front-end speech pre-processor to produce intermediate recognitions results (e.g., phonemes, phonemic strings, and sub-words), and ultimately, text recognition results (e.g., words, word strings, or sequence of tokens). In some examples, the speech input is processed at least partially by a third-party service or on the user's device (e.g., device 104, 200, 400, or 600) to produce the recognition result. Once STT processing module 730 produces recognition results containing a text string (e.g., words, or sequence of words, or sequence of tokens), the recognition result is passed to natural language processing module 732 for intent deduction. In some examples, STT processing module 730 produces multiple candidate text representations of the speech input. Each candidate text representation is a sequence of words or tokens corresponding to the speech input. In some examples, each candidate text representation is associated with a speech recognition confidence score. Based on the speech recognition confidence scores, STT processing module 730 ranks the candidate text representations and provides the n-best (e.g., n highest ranked) candidate text representation(s) to natural language processing module 732 for intent deduction, where n is a predetermined integer greater than zero. For example, in one example, only the highest ranked (n=1) candidate text representation is passed to natural language processing module 732 for intent deduction. In another example, the five highest ranked (n=5) candidate text representations are passed to natural language processing module 732 for intent deduction.

More details on the speech-to-text processing are described in U.S. Utility application Ser. No. 13/236,942 for “Consolidating Speech Recognition Results,” filed on Sep. 20, 2011, the entire disclosure of which is incorporated herein by reference.

In some examples, STT processing module 730 includes and/or accesses a vocabulary of recognizable words via phonetic alphabet conversion module 731. Each vocabulary word is associated with one or more candidate pronunciations of the word represented in a speech recognition phonetic alphabet. In particular, the vocabulary of recognizable words includes a word that is associated with a plurality of candidate pronunciations. For example, the vocabulary includes the word “tomato” that is associated with the candidate pronunciations of / [symbol] / and / [symbol] /. Further, vocabulary words are associated with custom candidate pronunciations that are based on previous speech inputs from the user. Such custom candidate pronunciations are stored in STT processing module 730 and are associated with a particular user via the user's profile on the device. In some examples, the candidate pronunciations for words are determined based on the spelling of the word and one or more linguistic and/or phonetic rules. In some examples, the candidate pronunciations are manually generated, e.g., based on known canonical pronunciations.

In some examples, the candidate pronunciations are ranked based on the commonness of the candidate pronunciation. For example, the candidate pronunciation / [symbol] / is ranked higher than / [symbol] /, because the former is a more commonly used pronunciation (e.g., among all users, for users in a particular geographical region, or for any other appropriate subset of users). In some examples, candidate pronunciations are ranked based on whether the candidate pronunciation is a custom candidate pronunciation associated with the user. For example, custom candidate pronunciations are ranked higher than canonical candidate pronunciations. This can be useful for recognizing proper nouns having a unique pronunciation that deviates from canonical pronunciation. In some examples, candidate pronunciations are associated with one or more speech characteristics, such as geographic origin, nationality, or ethnicity. For example, the candidate pronunciation / [symbol] / is associated with the United States, whereas the candidate pronunciation / [symbol] / is associated with Great Britain. Further, the rank of the candidate pronunciation is based on one or more characteristics (e.g., geographic origin, nationality, ethnicity, etc.) of the user stored in the user's profile on the device. For example, it can be determined from the user's profile that the user is associated with the United States. Based on the user being associated with the United States, the candidate pronunciation / [symbol] / (associated with the United States) is ranked higher than the candidate pronunciation / [symbol] / (associated with Great Britain). In some examples, one of the ranked candidate pronunciations is selected as a predicted pronunciation (e.g., the most likely pronunciation).

When a speech input is received, STT processing module 730 is used to determine the phonemes corresponding to the speech input (e.g., using an acoustic model), and then attempt to determine words that match the phonemes (e.g., using a language model). For example, if STT processing module 730 first identifies the sequence of phonemes / [symbol] / corresponding to a portion of the speech input, it can then determine, based on vocabulary index 744, that this sequence corresponds to the word “tomato.”

In some examples, STT processing module 730 uses approximate matching techniques to determine words in an utterance. Thus, for example, the STT processing module 730 determines that the sequence of phonemes / [symbol] / corresponds to the word “tomato,” even if that particular sequence of phonemes is not one of the candidate sequence of phonemes for that word.

Natural language processing module 732 (“natural language processor”) of the digital assistant takes the n-best candidate text representation(s) (“word sequence(s)” or “token sequence(s)”) generated by STT processing module 730, and attempts to associate each of the candidate text representations with one or more “actionable intents” recognized by the digital assistant. An “actionable intent” (or “user intent”) represents a task that can be performed by the digital assistant, and can have an associated task flow implemented in task flow models 754. The associated task flow is a series of programmed actions and steps that the digital assistant takes in order to perform the task. The scope of a digital assistant's capabilities is dependent on the number and variety of task flows that have been implemented and stored in task flow models 754, or in other words, on the number and variety of “actionable intents” that the digital assistant recognizes. The effectiveness of the digital assistant, however, also dependents on the assistant's ability to infer the correct “actionable intent(s)” from the user request expressed in natural language.

In some examples, in addition to the sequence of words or tokens obtained from STT processing module 730, natural language processing module 732 also receives contextual information associated with the user request, e.g., from I/O processing module 728. The natural language processing module 732 optionally uses the contextual information to clarify, supplement, and/or further define the information contained in the candidate text representations received from STT processing module 730. The contextual information includes, for example, user preferences, hardware, and/or software states of the user device, sensor information collected before, during, or shortly after the user request, prior interactions (e.g., dialogue) between the digital assistant and the user, and the like. As described herein, contextual information is, in some examples, dynamic, and changes with time, location, content of the dialogue, and other factors.

In some examples, the natural language processing is based on, e.g., ontology 760. Ontology 760 is a hierarchical structure containing many nodes, each node representing either an “actionable intent” or a “property” relevant to one or more of the “actionable intents” or other “properties.” As noted above, an “actionable intent” represents a task that the digital assistant is capable of performing, i.e., it is “actionable” or can be acted on. A “property” represents a parameter associated with an actionable intent or a sub-aspect of another property. A linkage between an actionable intent node and a property node in ontology 760 defines how a parameter represented by the property node pertains to the task represented by the actionable intent node.

In some examples, ontology 760 is made up of actionable intent nodes and property nodes. Within ontology 760, each actionable intent node is linked to one or more property nodes either directly or through one or more intermediate property nodes. Similarly, each property node is linked to one or more actionable intent nodes either directly or through one or more intermediate property nodes. For example, as shown in FIG. 7C, ontology 760 includes a “restaurant reservation” node (i.e., an actionable intent node). Property nodes “restaurant,” “date/time” (for the reservation), and “party size” are each directly linked to the actionable intent node (i.e., the “restaurant reservation” node).

In addition, property nodes “cuisine,” “price range,” “phone number,” and “location” are sub-nodes of the property node “restaurant,” and are each linked to the “restaurant reservation” node (i.e., the actionable intent node) through the intermediate property node “restaurant.” For another example, as shown in FIG. 7C, ontology 760 also includes a “set reminder” node (i.e., another actionable intent node). Property nodes “date/time” (for setting the reminder) and “subject” (for the reminder) are each linked to the “set reminder” node. Since the property “date/time” is relevant to both the task of making a restaurant reservation and the task of setting a reminder, the property node “date/time” is linked to both the “restaurant reservation” node and the “set reminder” node in ontology 760.

An actionable intent node, along with its linked concept nodes, is described as a “domain.” In the present discussion, each domain is associated with a respective actionable intent, and refers to the group of nodes (and the relationships there between) associated with the particular actionable intent. For example, ontology 760 shown in FIG. 7C includes an example of restaurant reservation domain 762 and an example of reminder domain 764 within ontology 760. The restaurant reservation domain includes the actionable intent node “restaurant reservation,” property nodes “restaurant,” “date/time,” and “party size,” and sub-property nodes “cuisine,” “price range,” “phone number,” and “location.” Reminder domain 764 includes the actionable intent node “set reminder,” and property nodes “subject” and “date/time.” In some examples, ontology 760 is made up of many domains. Each domain shares one or more property nodes with one or more other domains. For example, the “date/time” property node is associated with many different domains (e.g., a scheduling domain, a travel reservation domain, a movie ticket domain, etc.), in addition to restaurant reservation domain 762 and reminder domain 764.

While FIG. 7C illustrates two example domains within ontology 760, other domains include, for example, “find a movie,” “initiate a phone call,” “find directions,” “schedule a meeting,” “send a message,” and “provide an answer to a question,” “read a list,” “providing navigation instructions,” “provide instructions for a task” and so on. A “send a message” domain is associated with a “send a message” actionable intent node, and further includes property nodes such as “recipient(s),” “message type,” and “message body.” The property node “recipient” is further defined, for example, by the sub-property nodes such as “recipient name” and “message address.”

In some examples, ontology 760 includes all the domains (and hence actionable intents) that the digital assistant is capable of understanding and acting upon. In some examples, ontology 760 is modified, such as by adding or removing entire domains or nodes, or by modifying relationships between the nodes within the ontology 760.

In some examples, nodes associated with multiple related actionable intents are clustered under a “super domain” in ontology 760. For example, a “travel” super-domain includes a cluster of property nodes and actionable intent nodes related to travel. The actionable intent nodes related to travel includes “airline reservation,” “hotel reservation,” “car rental,” “get directions,” “find points of interest,” and so on. The actionable intent nodes under the same super domain (e.g., the “travel” super domain) have many property nodes in common. For example, the actionable intent nodes for “airline reservation,” “hotel reservation,” “car rental,” “get directions,” and “find points of interest” share one or more of the property nodes “start location,” “destination,” “departure date/time,” “arrival date/time,” and “party size.”

In some examples, each node in ontology 760 is associated with a set of words and/or phrases that are relevant to the property or actionable intent represented by the node. The respective set of words and/or phrases associated with each node are the so-called “vocabulary” associated with the node. The respective set of words and/or phrases associated with each node are stored in vocabulary index 744 in association with the property or actionable intent represented by the node. For example, returning to FIG. 7B, the vocabulary associated with the node for the property of “restaurant” includes words such as “food,” “drinks,” “cuisine,” “hungry,” “eat,” “pizza,” “fast food,” “meal,” and so on. For another example, the vocabulary associated with the node for the actionable intent of “initiate a phone call” includes words and phrases such as “call,” “phone,” “dial,” “ring,” “call this number,” “make a call to,” and so on. The vocabulary index 744 optionally includes words and phrases in different languages.

Natural language processing module 732 receives the candidate text representations (e.g., text string(s) or token sequence(s)) from STT processing module 730, and for each candidate representation, determines what nodes are implicated by the words in the candidate text representation. In some examples, if a word or phrase in the candidate text representation is found to be associated with one or more nodes in ontology 760 (via vocabulary index 744), the word or phrase “triggers” or “activates” those nodes. Based on the quantity and/or relative importance of the activated nodes, natural language processing module 732 selects one of the actionable intents as the task that the user intended the digital assistant to perform. In some examples, the domain that has the most “triggered” nodes is selected. In some examples, the domain having the highest confidence value (e.g., based on the relative importance of its various triggered nodes) is selected. In some examples, the domain is selected based on a combination of the number and the importance of the triggered nodes. In some examples, additional factors are considered in selecting the node as well, such as whether the digital assistant has previously correctly interpreted a similar request from a user.

User data 748 includes user-specific information, such as user-specific vocabulary, user preferences, user address, user's default and secondary languages, user's contact list, and other short-term or long-term information for each user. In some examples, natural language processing module 732 uses the user-specific information to supplement the information contained in the user input to further define the user intent. For example, for a user request “invite my friends to my birthday party,” natural language processing module 732 is able to access user data 748 to determine who the “friends” are and when and where the “birthday party” would be held, rather than requiring the user to provide such information explicitly in his/her request.

It should be recognized that in some examples, natural language processing module 732 is implemented using one or more machine learning mechanisms (e.g., neural networks). In particular, the one or more machine learning mechanisms are configured to receive a candidate text representation and contextual information associated with the candidate text representation. Based on the candidate text representation and the associated contextual information, the one or more machine learning mechanism are configured to determine intent confidence scores over a set of candidate actionable intents. Natural language processing module 732 can select one or more candidate actionable intents from the set of candidate actionable intents based on the determined intent confidence scores. In some examples, an ontology (e.g., ontology 760) is also used to select the one or more candidate actionable intents from the set of candidate actionable intents.

Other details of searching an ontology based on a token string is described in U.S. Utility application Ser. No. 12/341,743 for “Method and Apparatus for Searching Using An Active Ontology,” filed Dec. 22, 2008, the entire disclosure of which is incorporated herein by reference.

In some examples, once natural language processing module 732 identifies an actionable intent (or domain) based on the user request, natural language processing module 732 generates a structured query to represent the identified actionable intent. In some examples, the structured query includes parameters for one or more nodes within the domain for the actionable intent, and at least some of the parameters are populated with the specific information and requirements specified in the user request. For example, the user says “Make me a dinner reservation at a sushi place at 7.” In this case, natural language processing module 732 is able to correctly identify the actionable intent to be “restaurant reservation” based on the user input. According to the ontology, a structured query for a “restaurant reservation” domain includes parameters such as {Cuisine}, {Time}, {Date}, {Party Size}, and the like. In some examples, based on the speech input and the text derived from the speech input using STT processing module 730, natural language processing module 732 generates a partial structured query for the restaurant reservation domain, where the partial structured query includes the parameters {Cuisine=“Sushi”} and {Time=“7 pm”}. However, in this example, the user's utterance contains insufficient information to complete the structured query associated with the domain. Therefore, other necessary parameters such as {Party Size} and {Date} is not specified in the structured query based on the information currently available. In some examples, natural language processing module 732 populates some parameters of the structured query with received contextual information. For example, in some examples, if the user requested a sushi restaurant “near me,” natural language processing module 732 populates a {location} parameter in the structured query with GPS coordinates from the user device.

In some examples, natural language processing module 732 identifies multiple candidate actionable intents for each candidate text representation received from STT processing module 730. Further, in some examples, a respective structured query (partial or complete) is generated for each identified candidate actionable intent. Natural language processing module 732 determines an intent confidence score for each candidate actionable intent and ranks the candidate actionable intents based on the intent confidence scores. In some examples, natural language processing module 732 passes the generated structured query (or queries), including any completed parameters, to task flow processing module 736 (“task flow processor”). In some examples, the structured query (or queries) for the m-best (e.g., m highest ranked) candidate actionable intents are provided to task flow processing module 736, where m is a predetermined integer greater than zero. In some examples, the structured query (or queries) for the m-best candidate actionable intents are provided to task flow processing module 736 with the corresponding candidate text representation(s).

Other details of inferring a user intent based on multiple candidate actionable intents determined from multiple candidate text representations of a speech input are described in U.S. Utility application Ser. No. 14/298,725 for “System and Method for Inferring User Intent From Speech Inputs,” filed Jun. 6, 2014, the entire disclosure of which is incorporated herein by reference.

Task flow processing module 736 is configured to receive the structured query (or queries) from natural language processing module 732, complete the structured query, if necessary, and perform the actions required to “complete” the user's ultimate request. In some examples, the various procedures necessary to complete these tasks are provided in task flow models 754. In some examples, task flow models 754 include procedures for obtaining additional information from the user and task flows for performing actions associated with the actionable intent.

As described above, in order to complete a structured query, task flow processing module 736 needs to initiate additional dialogue with the user in order to obtain additional information, and/or disambiguate potentially ambiguous utterances. When such interactions are necessary, task flow processing module 736 invokes dialogue flow processing module 734 to engage in a dialogue with the user. In some examples, dialogue flow processing module 734 determines how (and/or when) to ask the user for the additional information and receives and processes the user responses. The questions are provided to and answers are received from the users through I/O processing module 728. In some examples, dialogue flow processing module 734 presents dialogue output to the user via audio and/or visual output, and receives input from the user via spoken or physical (e.g., clicking) responses. Continuing with the example above, when task flow processing module 736 invokes dialogue flow processing module 734 to determine the “party size” and “date” information for the structured query associated with the domain “restaurant reservation,” dialogue flow processing module 734 generates questions such as “For how many people?” and “On which day?” to pass to the user. Once answers are received from the user, dialogue flow processing module 734 then populates the structured query with the missing information, or pass the information to task flow processing module 736 to complete the missing information from the structured query.

Once task flow processing module 736 has completed the structured query for an actionable intent, task flow processing module 736 proceeds to perform the ultimate task associated with the actionable intent. Accordingly, task flow processing module 736 executes the steps and instructions in the task flow model according to the specific parameters contained in the structured query. For example, the task flow model for the actionable intent of “restaurant reservation” includes steps and instructions for contacting a restaurant and actually requesting a reservation for a particular party size at a particular time. For example, using a structured query such as: {restaurant reservation, restaurant=ABC Café, date=3/12/2012, time=7 pm, party size=5}, task flow processing module 736 performs the steps of: (1) logging onto a server of the ABC Café or a restaurant reservation system such as OPENTABLE®, (2) entering the date, time, and party size information in a form on the website, (3) submitting the form, and (4) making a calendar entry for the reservation in the user's calendar.

In some examples, task flow processing module 736 employs the assistance of service processing module 738 (“service processing module”) to complete a task requested in the user input or to provide an informational answer requested in the user input. For example, service processing module 738 acts on behalf of task flow processing module 736 to make a phone call, set a calendar entry, invoke a map search, invoke or interact with other user applications installed on the user device, and invoke or interact with third-party services (e.g., a restaurant reservation portal, a social networking website, a banking portal, etc.). In some examples, the protocols and application programming interfaces (API) required by each service are specified by a respective service model among service models 756. Service processing module 738 accesses the appropriate service model for a service and generate requests for the service in accordance with the protocols and APIs required by the service according to the service model.

For example, if a restaurant has enabled an online reservation service, the restaurant submits a service model specifying the necessary parameters for making a reservation and the APIs for communicating the values of the necessary parameter to the online reservation service. When requested by task flow processing module 736, service processing module 738 establishes a network connection with the online reservation service using the web address stored in the service model, and send the necessary parameters of the reservation (e.g., time, date, party size) to the online reservation interface in a format according to the API of the online reservation service.

In some examples, natural language processing module 732, dialogue flow processing module 734, and task flow processing module 736 are used collectively and iteratively to infer and define the user's intent, obtain information to further clarify and refine the user intent, and finally generate a response (i.e., an output to the user, or the completion of a task) to fulfill the user's intent. The generated response is a dialogue response to the speech input that at least partially fulfills the user's intent. Further, in some examples, the generated response is output as a speech output. In these examples, the generated response is sent to speech synthesis module 740 (e.g., speech synthesizer) where it can be processed to synthesize the dialogue response in speech form. In yet other examples, the generated response is data content relevant to satisfying a user request in the speech input.

In examples where task flow processing module 736 receives multiple structured queries from natural language processing module 732, task flow processing module 736 initially processes the first structured query of the received structured queries to attempt to complete the first structured query and/or execute one or more tasks or actions represented by the first structured query. In some examples, the first structured query corresponds to the highest ranked actionable intent. In other examples, the first structured query is selected from the received structured queries based on a combination of the corresponding speech recognition confidence scores and the corresponding intent confidence scores. In some examples, if task flow processing module 736 encounters an error during processing of the first structured query (e.g., due to an inability to determine a necessary parameter), the task flow processing module 736 can proceed to select and process a second structured query of the received structured queries that corresponds to a lower ranked actionable intent. The second structured query is selected, for example, based on the speech recognition confidence score of the corresponding candidate text representation, the intent confidence score of the corresponding candidate actionable intent, a missing necessary parameter in the first structured query, or any combination thereof.

Speech synthesis module 740 is configured to synthesize speech outputs for presentation to the user. Speech synthesis module 740 synthesizes speech outputs based on text provided by the digital assistant. For example, the generated dialogue response is in the form of a text string. Speech synthesis module 740 converts the text string to an audible speech output. Speech synthesis module 740 uses any appropriate speech synthesis technique in order to generate speech outputs from text, including, but not limited, to concatenative synthesis, unit selection synthesis, diphone synthesis, domain-specific synthesis, formant synthesis, articulatory synthesis, hidden Markov model (HMM) based synthesis, and sinewave synthesis. In some examples, speech synthesis module 740 is configured to synthesize individual words based on phonemic strings corresponding to the words. For example, a phonemic string is associated with a word in the generated dialogue response. The phonemic string is stored in metadata associated with the word. Speech synthesis model 740 is configured to directly process the phonemic string in the metadata to synthesize the word in speech form.

In some examples, instead of (or in addition to) using speech synthesis module 740, speech synthesis is performed on a remote device (e.g., the server system 108), and the synthesized speech is sent to the user device for output to the user. For example, this can occur in some implementations where outputs for a digital assistant are generated at a server system. And because server systems generally have more processing power or resources than a user device, it is possible to obtain higher quality speech outputs than would be practical with client-side synthesis.

Additional details on digital assistants can be found in the U.S. Utility application Ser. No. 12/987,982, entitled “Intelligent Automated Assistant,” filed Jan. 10, 2011, and U.S. Utility application Ser. No. 13/251,088, entitled “Generating and Processing Task Items That Represent Tasks to Perform,” filed Sep. 30, 2011, the entire disclosures of which are incorporated herein by reference.

### 4. Exemplary Architecture and Functionality of an Intelligent Automated Assistant

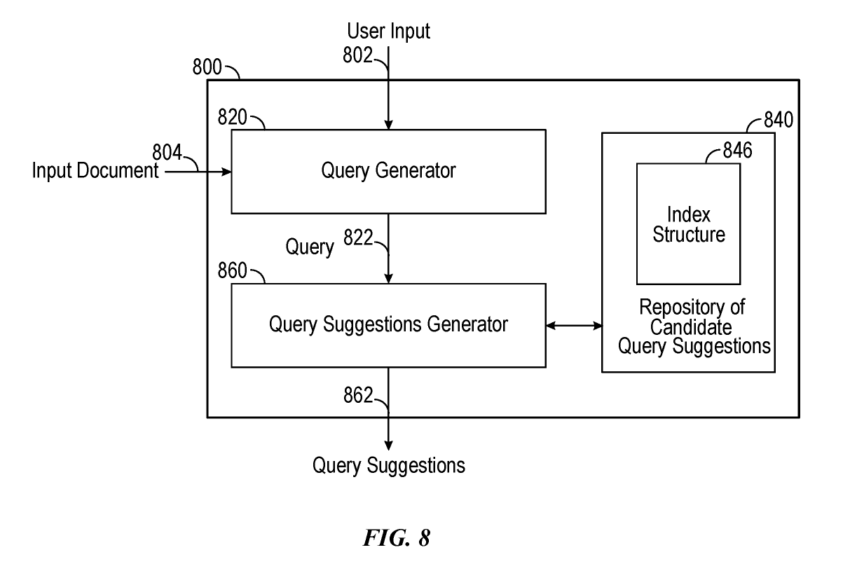

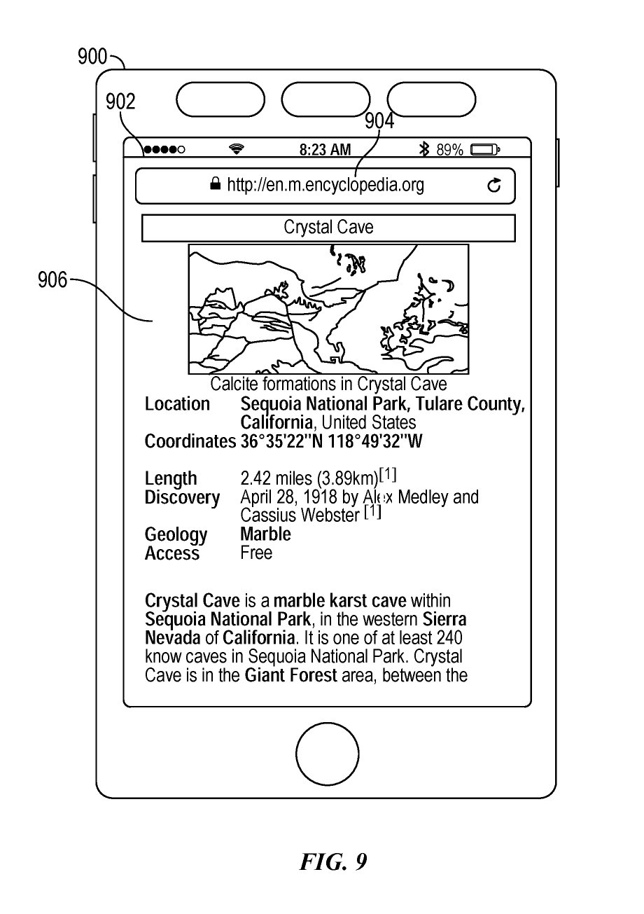

FIG. 8 illustrates a block diagram of an intelligent automated assistant 800 for providing query suggestions, according to various examples. In some examples, intelligent automated assistant 800 (e.g., digital assistant system 700) is implemented by a user device according to various examples. In some examples, the user device, a server (e.g., server 108), or a combination thereof, can implement intelligent automated assistant 800. The user device can be implemented using, for example, device 104, 200, 400, 900, 1000, or 1300 as illustrated in FIGS. 1, 2A-2B, 4, 9, 10A-10C, and 13A-13B. In some examples, intelligent automated assistant 800 can be implemented using digital assistant module 726 of digital assistant system 700. Intelligent automated assistant 800 includes one or more modules, models, applications, vocabularies, and user data similar to those of digital assistant module 726. For example, intelligent automated assistant 800 includes the following sub-modules, or a subset or superset thereof: an input/output processing module, an STT process module, a natural language processing module, a task flow processing module, and a speech synthesis module. These modules can also be implemented similar to that of the corresponding modules as illustrated in FIG. 7B, and therefore are not shown and not repeatedly described. FIG. 9 illustrates a user interface 902 displaying a document on a user device 900, according to various examples.

With reference to FIGS. 8 and 9, intelligent automated assistant 800 can display, on user interface 902, a document to the user. For example, as shown in FIG. 9, intelligent automated assistant 800 provides user interface 902, which can include a user input area 904 and a display area 906. User input area 904 and display area 906 can be a portion of, for example, an application such as a web browser. User input area 904 can enable intelligent automated assistant 800 to receive a user input. For example, the user may type a URL of a website within user input area 904. In response to receiving the user input, intelligent automated assistant 800 can provide information in display area 906. For example, intelligent automated assistant 800 can display a document (e.g., an article regarding crystal cave) in display area 906. In some embodiments, the displayed document can be used by intelligent automated assistant 800 as an input document 804 to generate query suggestions, as described in more detail below.

In some embodiments, prior to initiating a query, intelligent automated assistant 800 can include a language detector (not shown) for detecting one or more languages associated with input document 804 using various techniques. For example, the language detector of intelligent automated assistant 800 can detect languages based on n-gram models, mutual information based distance measure, or the like. In some examples, the language detector of intelligent automated assistant 800 can rank the detected languages. For example, the language detector of intelligent automated assistant 800 may detect that input document 804 may likely include English text and/or German text. Based on certainty scores of the detected languages, the language detector can rank the detected languages likely included in input document 804. For instance, the language detector can indicate that input document 804 has 95% of probability of containing English text and 7% of probability of containing German text.

In some examples, intelligent automated assistant 800 can further include a repository identifier (not shown) for identifying, based on the ranking of the detected languages, a repository of candidate query suggestions (e.g., repository 840 and associated index structure 846) from a plurality of repositories of candidate query suggestions. The plurality of repositories can correspond to plurality of languages. For example, a system language of the electronic device on which intelligent automated assistant 800 operates may be configured as English. The detected language of input document 804 could be determined as likely German. In some examples, there can be a plurality of repositories and/or associated index structures supporting different languages (e.g., English, German, Japanese, Chinese, etc.). If the repository identifier determines that repository 840 (and associated index structure 846) supports German as an input document language, and English as an output language associated with query suggestions 862, the repository identifier can identify repository 840 (and associated index structure 846) for performing the subsequence processes of generating query suggestions 862.

As another example, a system language of the electronic device on which intelligent automated assistant 800 operates may be configured as German. The detected language of input document 804 could be determined as likely English. If the repository identifier determines that repository 840 (and associated index structure 846) does not support English as an input document language, and/or does not support English as an output language associated with query suggestions 862, the repository identifier may not identify repository 840 (and associated index structure 846) for performing the subsequence processes of generating query suggestions 862. It may identify another repository (and associated index structure) or may not proceed to the subsequent processes of generating query suggestions 862.

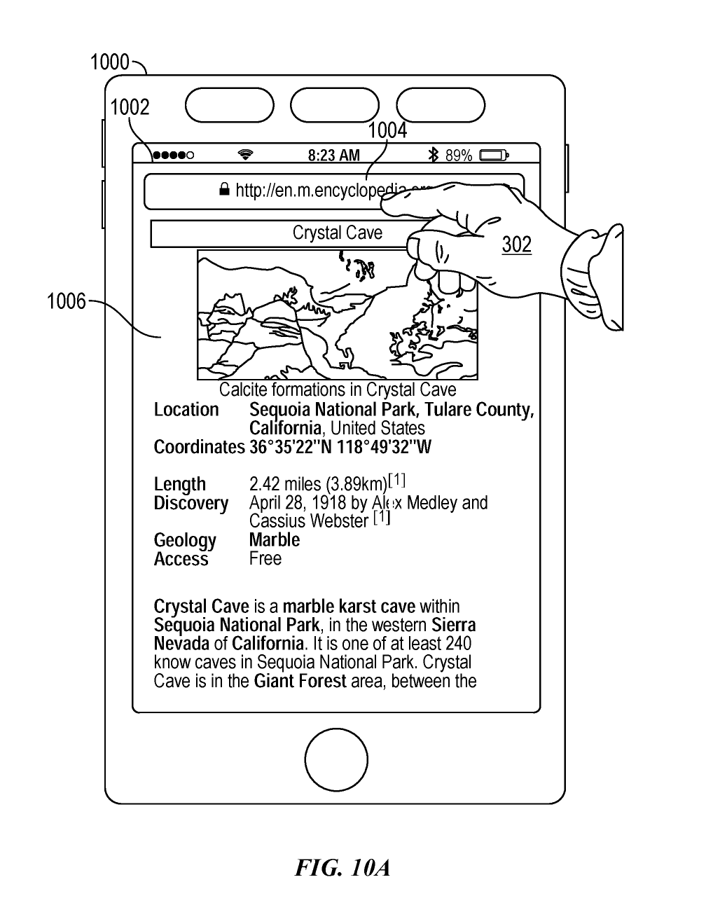

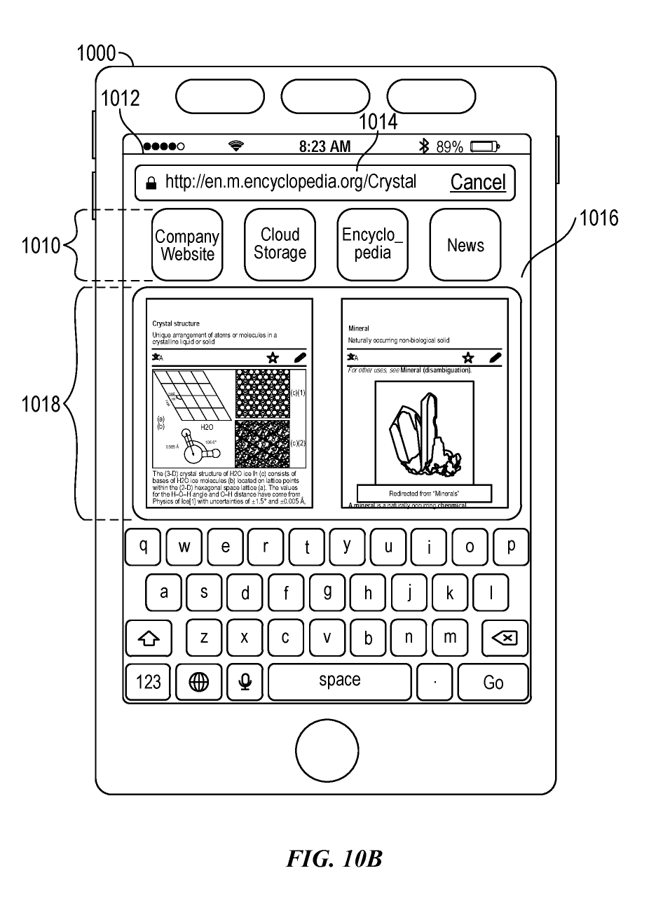

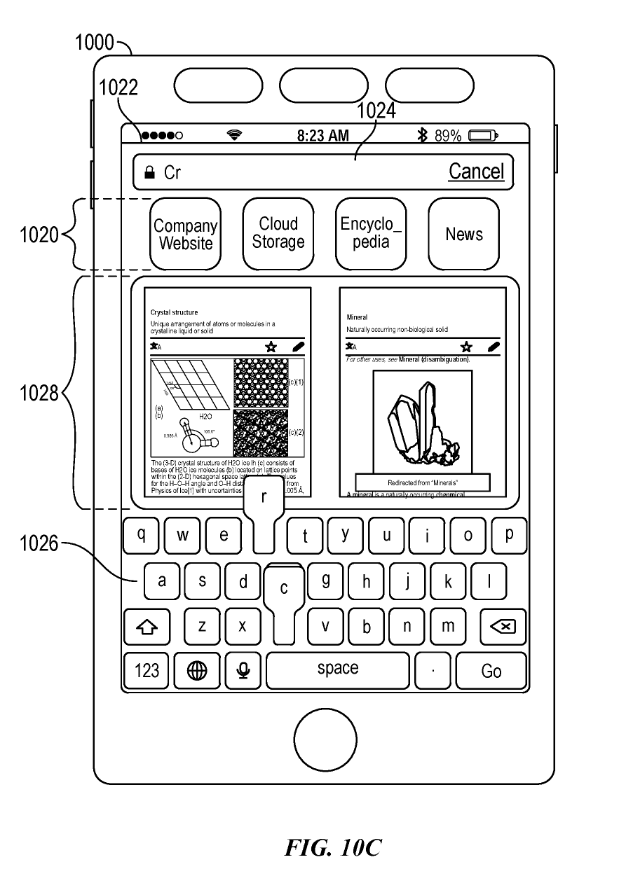

FIG. 10A illustrates a user interface 1002 of a user device 1000 receiving a user input initiating a search, according to various examples. Similar to user interface 902, user interface 1002 can also include a user input area 1004 and a display area 1006. With reference to FIGS. 8 and 10A, in some embodiments, intelligent automated assistant 800 can receive a user input while displaying a document. For example, while reading an article displayed in display area 1006, a user may decide to read more related articles. The user can thus initiate a search for related articles. In some examples, the user can initiate a search for a document stored internally (e.g., documents stored in user device 1000) or externally on a user device (e.g., documents provided by websites or remote storage devices). In some examples, the user can initiate the search by a hand gesture such as touching or taping within user input area 1004 by using one or more fingers 302. In some examples, a user can provide a voice input to initiate the search (e.g., “find me more like this”).

With reference to FIG. 8, in response to receiving a user input 802 initiating a search, intelligent automated assistant 800 can initiate a query 822 based on an input document 804. In some embodiments, input document 804 can be a document that is being displayed to the user (e.g., the crystal cave article displayed in display area 1006 as illustrated in FIG. 10A) or a document the user was reading or listening. Input document 804 can be, for example, a text document, a webpage, a message (e.g., a voice message, a text message), an email, a hyperlink to a document, or the like. In some examples, query 822 can access a repository of candidate query suggestions 840. Candidate query suggestions can represent documents that are topically-similar or related to one or more topics presented in input document 804. For example, the topic of input document 804 may be “crystal cave.” Candidate query suggestions may represent documents having topics such as “crystal structure,” “underground crystals,” “minerals,” or the like.

Based on query 822, intelligent automated assistant 800 can receive one or more query suggestions 862 from a repository of query suggestions 840, and provide one or more query suggestions 862 to the user. For example, intelligent automated assistant 800 can compose, derive, or infer query suggestions 862 based on query 822 and provide query suggestions to the user. FIG. 10B illustrates a user interface 1012 displaying a plurality of document suggestions 1018, according to various examples. Document suggestions 1018 represent suggested documents that the user is likely interested in. Document suggestions 1018 can be one type of query suggestions stored in repository 840. In some embodiments, intelligent automated assistant 800 can determine document suggestions 1018 based on a plurality of candidate query suggestions, and provided document suggestions 1018 to the user on user interface 1012. With reference to FIGS. 8 and 10B, in some examples, intelligent automated assistant 800 can display document suggestions 1018 within a display area 1016. For example, document suggestions 1018 can include a hyperlink and a thumbnail image of a document that is likely topically-similar or related to that of input document 804. Continuing the above example, and as shown in FIG. 10B, document suggestions 1018 may include thumbnail images of documents related to crystal structure and mineral, which are likely similar or related to topics presented in the crystal cave article the user was reading (e.g., the article shown in FIG. 10A). In some examples, display area 1016 can include one or more affordances 1010 (e.g., hyperlinks to websites, applications, etc.) to provide the user with additional functionality.

FIG. 10C illustrates a user interface 1022 for receiving another user input initiating a search, according to various examples. As illustrated in FIG. 10C, in some embodiments, a user can provide an input by typing or dictating one or more characters using keyboard 1026 and/or an audio input device (e.g., a microphone). In some examples, while intelligent automated assistant 800 is receiving user inputs, it can initiate a query, receive query suggestions, and display the query suggestions to the user. For example, as shown in FIG. 10C, as the user is typing or dictating one or more characters (e.g., “Cr” as in the word “Crystal”) in user input area 1024, intelligent automated assistant 800 can initiate a query, receive query suggestions, and display query suggestions (e.g., query suggestions 1028) to the user. In some examples, intelligent automated assistant 800 can initiate a query and receive query suggestions before the user completes providing the input (e.g., before the user types the complete word “crystal”).

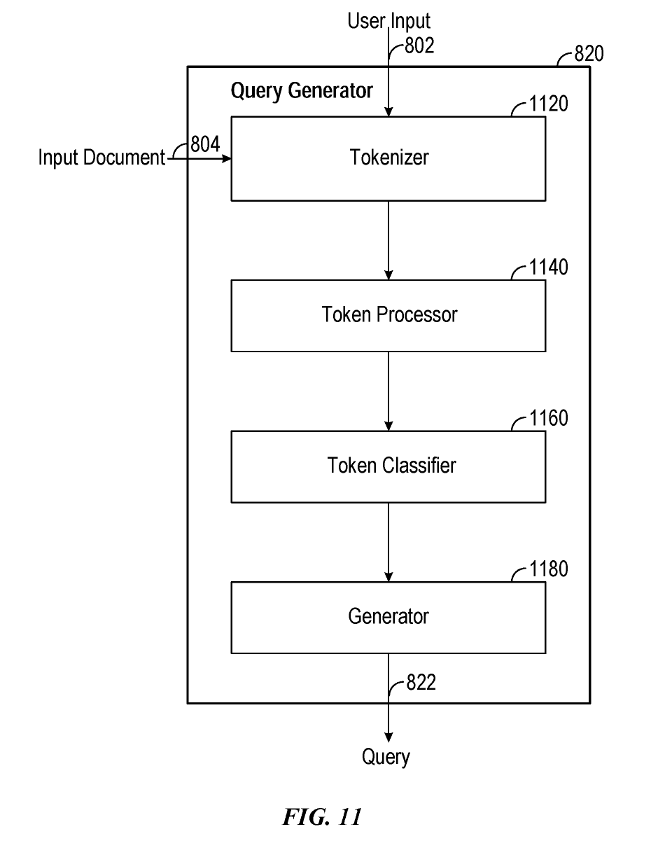

With reference to FIG. 8, in some embodiments, intelligent automated assistant 800 can include a query generator 820, a repository of candidate query suggestions 840, and a query suggestion generator 860. The repository of candidate query suggestions 840 can include an index structure 846. FIG. 11 illustrates a block diagram of a query generator 820, according to various examples. In some embodiments, query generator 820 can receive a user input 802 for initiating a search and an input document 804, and generate a query for accessing a repository of candidate query suggestions related to one or more topics present in input document 804. As described above, user input 802 can be, for example, a touch on a user input area or a voice input. Input document 804 can be, for example, a document that is being displayed to the user or the user was reading/listening.

As illustrated in FIG. 11, in some embodiments, query generator 820 can include a tokenizer 1120, a token processor 1140, a token classifier 1160, and a generator 1180. In some examples, tokenizer 1120 receives input document 804 (e.g., an article that is being displayed to the user) and generates one or more tokens representing input document 804. For example, input document 804 can include one or more characters such as letters, words, whitespaces, punctuation marks, symbols, etc. To generate tokens, tokenizer 1120 can, for example, separate the words by whitespaces, remove punctuation marks, and convert the characters in the separated words to lowercase characters. A token can thus include a sequence of lowercase characters (e.g., lowercase words) without punctuation marks. In some examples, tokens are thus simplified representations of input document 804.

With reference to FIG. 11, tokenizer 1120 can provide the tokens representing input document 804 to a token processor 1140. In some examples, token processor 1140 can further process the tokens to simplify the representations of input document 804. For example, token processor 1140 can remove tokens representing structured content in input document 804 from the tokens provided by tokenizer 1120. Structured content in input document 804 may include, for example, boilerplate text such as comments, navigational elements, tables, references, or the like. Structured content are likely not the focus of input document 804 and are thus likely not essential for generating a query. Token processor 1140 can remove structured content using, for example, a webpage reader (e.g., Safari® reader), rule-based removing techniques, visual page segmentation techniques, deep learning data-driven networks (e.g., neural network) based techniques, or the like.

With reference to FIG. 11, after removing tokens representing structured content in input document 804, token processor 1140 can provide the remaining tokens to token classifier 1160. Token classifier 1160 can classify the remaining tokens into one or more groups of terms or sequences of terms. For example, token classifier 1160 can classify remaining tokens into primary terms, auxiliary terms, and/or terms that are not to-be-included in the query. Similarly, token classifier 1160 can classify tokens into sequences of primary terms, sequences of auxiliary terms, and/or sequences of terms that are not to-be-included in the query. A primary term or sequence is a term or sequence that can be used for both selection and ranking in subsequent processing of search results. A primary term or sequence may be a term or sequence that represents the topic or focus of an associated document (e.g., input document 804). For example, input document 804 may be a document regarding why U.S. should ban nuclear power. Thus, one or more tokens generated based on input document 804 may include terms or a sequence of terms such as “nuclear,” “catastrophe,” “solar,” “alternatives,” “gigawatt,” and” or “Fukushima.” Token classifier 1160 can classify these terms or sequences as primary terms or sequences.

In some embodiments, an auxiliary term or sequence of terms is a term or sequence that can be used only for ranking. An auxiliary term or sequence may be a term or sequence related to the topic or focus of an associated document (e.g., input document 804), but may be less relevant than a primary term or sequence. Continuing the above example in which input document 804 is a document regarding banning nuclear power, one or more tokens generated based on input document 804 may include a term such as “reaction.” Token classifier 1160 can classify this term as an auxiliary term. In some examples, token classifier 1160 can classify terms or sequences into primary terms/sequences and auxiliary terms/sequences based on a document frequency (DF), a collection term frequency (CTF), or a relation of the DF and CTF, as described in more detail below.

With reference to FIG. 11, in some examples, primary terms/sequences and auxiliary terms/sequences can be terms/sequences that are used for generating a query. Among the remaining tokens provided by token processor 1140, there may be some terms or sequences of terms that are not to be included in the query. Terms or sequences that are not to-be-included in the query can include irrelevant terms or sequences. Continuing the above example in which input document 804 regarding banning the nuclear power, a term such as “fashion” may be an irrelevant term.

In some embodiments, token classifier 1160 can classify the remaining tokens based on at least one of a document frequency (DF), a collection term frequency (CTF), or a relation of the DF and CTF. In some examples, DF represents the number of documents, in a collection of documents (e.g., a training corpus), that include a particular term or a sequence of terms (e.g., a phrase). And CTF represents the number of times a particular term or a sequence of terms is present in a single document or a collection of documents. A DF and a CTF can be obtained using a collection of documents such as a training corpus. The training corpus can include, for example, a collection of topically-diverse documents (e.g., a large quantity of online articles representing various topics). In some examples, token classifier 1160 can determine the DF, the CTF, and/or a ratio of DF and CTF associated with a term or a sequence of terms (e.g., “nuclear reactor”) included in input document 804. Token classifier 1160 can further determine whether the DF, the CTF, or the ratio of DF and CTF associated with a term or a sequence of terms included in input document 804 satisfies one or more corresponding threshold conditions. Based on such determination, token classifier 1160 can classify the tokens into primary terms, auxiliary terms, and/or terms not to-be-included in the query. For example, token classifier 1160 may determine that the DF of a particular term or a sequence of terms is more than 2% of the collection of documents (e.g., the term is a frequently occurring term in a training corpus), or that the DF and CTF of a term or a sequence of terms is less than a corresponding threshold (e.g., the term is a rarely occurring term with DF<3 or CTF<5). In some examples, token classifier 1160 may thus classify these frequently occurring terms and rarely occurring terms as terms not to-be-included in the query, and classify other terms (e.g., terms have DF, CTF, or a ratio of DF and CTF within a range, indicating they are not either frequently occurring terms or rarely occurring terms) as either primary terms or auxiliary terms. In some examples, the ratio of DF and CTF can be a normalized ratio, which can be a good heuristic indication of finding primary terms and auxiliary terms (e.g., terms that are more relevant or representative of input document 804). In some embodiments, the terms in the remaining tokens (e.g., primary terms, auxiliary terms, terms not-to-be included in the query) may or may not be included in an index structure, as described in more detail below. In some examples, the determination of whether a term is to be included in an index structure can be based on the DF, CTF, and/or a relation of the DF and CTF.

Under certain circumstances, one or more particular terms or sequences in input document 804 may be under-represented or over-represented in the training corpus (e.g., in the collection of documents). For example, a training corpus may include non-English language documents, or may include documents that are not topically diverse. In some embodiments, token classifier 1160 can classify the remaining tokens associated with input document 804 based on a predetermined list of terms or sequences. For example, the predetermined list of terms or sequences can be customized to account for under- or over-representation of terms or sequences. In some examples, the predetermined list of terms or sequences can also be generated based on statistics associated with indexes of non-English language documents.

With reference to FIG. 11, based on the classification of remaining tokens associated with input document 804, generator 1180 can generate a query 822. For example, generator 1180 can include one or more tokens classified into primary terms/sequences and/or auxiliary terms/sequences, but not include tokens classified into not to-be-included in a query. As described above, primary terms/sequences and auxiliary terms/sequences are at least likely to be relevant to the topic of input document 804 and therefore are useful for generating query suggestions. In some embodiments, generator 1180 can determine whether the number of terms or sequences to-be-included in query 822 satisfies a threshold condition. For example, if generator 1180 determines that there is not enough primary terms/sequences and/or auxiliary terms/sequences, it may not generate a query.

As described above, a plurality of terms can form sequences of terms (e.g., phrases); and token classifier 1160 can classify tokens into sequences of primary terms, sequences of auxiliary terms, and sequences of terms not to-be-included in the query. A sequence of terms may have different statistical properties (e.g., DF, CTF) than the individual terms that form the sequence. For example, the phrase “the who” may represent the name of an English rock band and may have vastly different document statistical properties than those of the two individual terms “the” and “who.” Accordingly, in some examples, generator 1180 can generate a query including a sequence of terms as if it is a single term (e.g., include the phrase “the who,” rather than two individual words “the” and “who”). In some embodiments, including sequences of terms in a query can improve the accuracy of generating query suggestions.

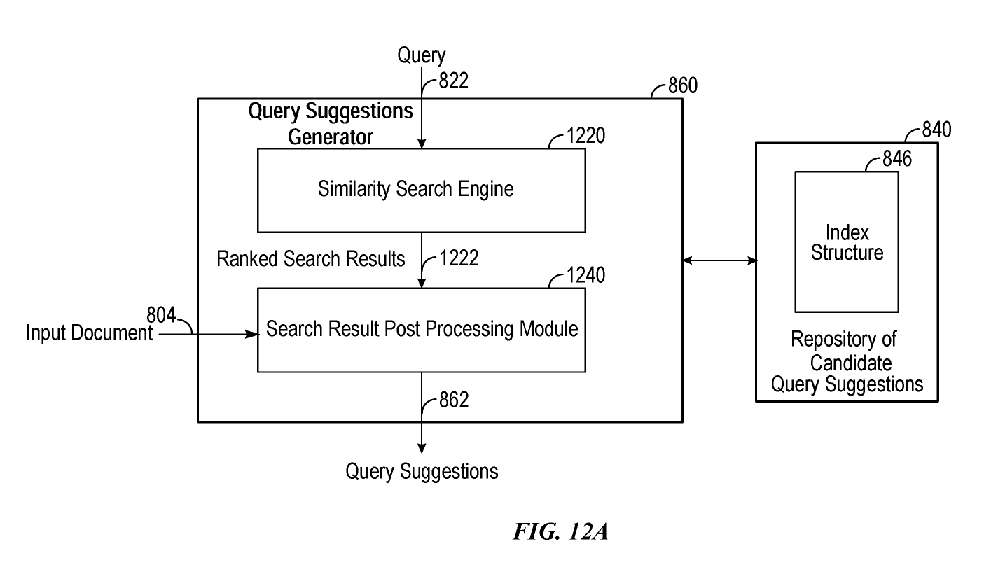

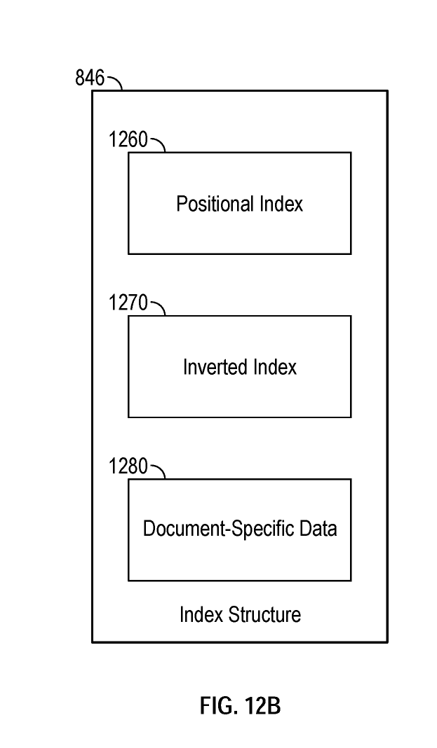

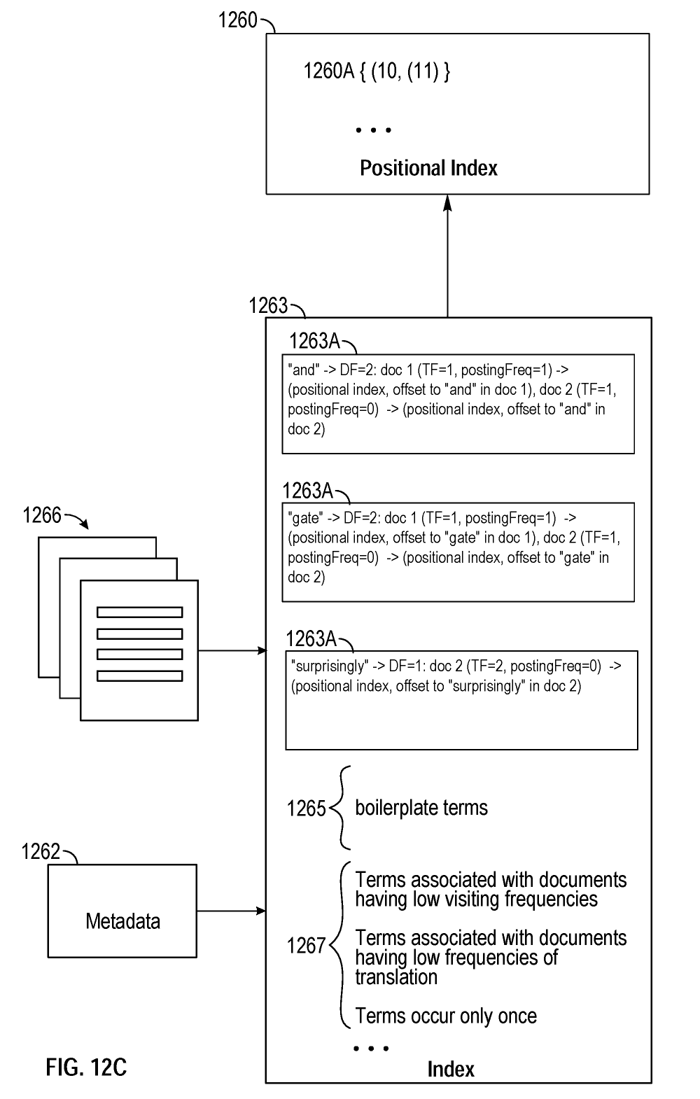

FIG. 12A illustrates a block diagram of a query suggestion generator 860, according to various examples. As described above, query suggestion generator 860 can receive query 822 and access a repository of candidate query suggestions 840. Candidate query suggestions are related to one or more topics present in input document 804. In some embodiments, query suggestion generator 860 can include a similarity search engine 1220 and a search result post processing module 1240.

As shown in FIG. 12A, similarity search engine 1220 can obtain an index structure 846 and perform a similarity search based on query 822 (e.g., the query provided by query generator 820) and index structure 846. FIG. 12B illustrates index structure 846, according to various examples. In some embodiments, index structure 846 can include a positional index 1260. A positional index includes positions of one or more terms associated with a collection of documents. FIG. 12C illustrates positional index 1260 associated with a text corpus 1266, according to various examples. Text corpus 1266 can be a training corpus (e.g., a collection of documents such as topically-diverse online articles). In some examples, positional index 1260 can be a positional index of selected terms associated with text corpus 1266. For example, positional index 1260 can include positions of selected terms associated with a collection of topically-diverse online articles (e.g., Wikipedia® articles). Positional index 1260 can thus represent positions of various terms representing topics of a collection of documents.

As shown in FIGS. 12B and 12C, in some examples, to generate positional index 1260, positions can be generated for a first group of terms associated with text corpus 1266 and then positions of a second group of terms, which is a subset of the first group terms, can be removed. The first group of terms can include one or more terms and one or more sequences of terms (e.g., phrases). For example, the first group of terms can include substantially all terms/sequences of terms associated with text corpus 1266, a majority of terms/sequences, or substantially all document-topic related terms/sequences. As described above, text corpus 1266, in some examples, represents a collection of topically-diverse documents (e.g., Wikipedia® articles). In some example, the first group of terms can also include topically-related terms (e.g., the term “crystal” in an article “Crystal Structures”) and terms representing structured content. Structure content can include boilerplate text such as comments, navigational elements (e.g., text links, breadcrumbs, navigation bar, sitemap, dropdown menus, flyout menus, anchors, etc.), tables, references, lists, indexes, disambiguation pages (e.g., pages enabling a user to find an article on different topics that could be referenced by the same search term), invisible/hidden texts (e.g., texts that are only visible when editing the source for a webpage), or the like. Structured content are likely not the topic or focus of the document and are thus likely not essential or less relevant for generating query suggestions. Thus, terms associated with structure content may not be represented in positional index 1260. In some examples, positional index 1260 can be referenced from an index 1263. Index 1263 can include information associated with terms that are not part of one or more sequences (e.g., non-phrase terms). For example, index 1263 can include information such as which documents include the terms and the frequencies. In some examples, positional index 1260 may only include information associated with terms that are part of one or more sequences (e.g., terms that are part of a phrase).

With reference to FIG. 12C, in some examples, positional index 1260 can include a per-document data structure that can be referenced from index 1263. Index 1263 can store a sorted list of terms (e.g., in their alphanumerical order). In some examples, for each term in index 1263, index 1263 stores a count (e.g., the document frequency DF of the term), a list of documents that contain the term, a number that corresponds to the number of occurrences of the term after the positions of the second group of terms are removed, and a number that corresponds to the number of occurrences of the term before the positions of the second group of terms are removed. As described below, the second group of terms is not essential or relevant for generating query suggestions and thus the positions of the terms in the second group can be removed from, or not included in, positional index 1260.

FIG. 12C illustrates an example of index 1263 and positional index 1260. For instance, a first document in text corpus 1266 may include a sequence of terms “AND gate” (e.g., a type of electrical circuit) at position 10. The sequence of terms “AND gate” is a meaningful bigram phrase that should be included in positional index 1260. A second document in text corpus 1266 may include sequences of terms “gate surprisingly and” at position 20 and further instances of the term “and” at positions 30, 35, 48, and 57. This sequence of terms may contain bigram phrases such as “gate surprisingly” and “surprisingly and,” none of which is a meaningful bigram phrase that should be included in positional index 1260. Index 1263 can thus include items 1263A-C. Item 1263A may indicate “and”->DF=2: doc 1 (TF=1, postingFreq=1)->(positional index, offset to “and” in doc 1), doc 2 (TF=1, postingFreq=0)->(positional index, offset to “and” in doc 2)}; item 1263B may indicate {“gate”->DF=2: doc 1 (TF=1, postingFreq=1)->(positional index, offset to “gate” doc 1), doc 2 (TF=1, postingFreq=0)->(positional index, offset to “gate” in doc 2)}; and item 1263C may indicate {“surprisingly” DF=1: doc 2 (TF=2, postingFreq=0)->(positional index for “surprisingly” in doc 2)}. For each term (e.g., the terms “and,” “gate,” or “surprisingly”), the corresponding items 1263A-C indicates the document frequency (e.g., DF), the document(s) that include the term (e.g., doc 1, doc 2), a term frequency used for ranking (e.g., TF), a number of terms to read for a particular term/document pairing (e.g., “postingFreq”), and a position offset to the term (e.g., offset to the term “and” in doc 1). In some examples, a term frequency used for ranking (e.g., TF) and a number of terms to read for a particular term/document pairing (e.g., “postingFreq”) may or may not be the same. Conventionally, these two numbers are not differentiated (e.g., in the stock version of Apache Lucene) and may be the same. However, this may increase the size of a positional index by including positions of undesired terms. For example, as described below, based on index 1263, the positions associated with phrases “gate surprisingly” and “surprisingly and” are not included in positional index 1260. Thus, differentiating a term frequency used for ranking (e.g., TF) and a number of terms to read for a particular term/document pairing (e.g., “postingFreq”) can reduce the size of positional index 1260 and thus improve the search efficiency.

In index 1263, the position offset to the term and the number of terms to read for a particular term/document pairing can be used for generating the positions of the terms in positional index 1260. Continuing with the above example, as illustrated in FIG. 12C, item 1260A in positional index 1260 can be generated based on index 1263 and can include, for example, {(10), (11)}. The first number “(10)” in item 1260A can represent the position of the term “and” in document 1, and the second number “(11)” in item 1260B can represent the position of the term “gate” in document 1. Thus, the positions of the phrase “AND gate” are included in positional index 1260. As described above, sequences of terms that are not meaningful (e.g., phrases “gate surprisingly” and “surprisingly and” should not have corresponding positions in positional index 1260. Thus, positional index 1260 does not include an item such as {(10), (22), (30), 35}, (48), (57), (11), (20), (21))}, which correspond to positions of the term “and” in documents 1 and 2, the positions of the term “gate” in documents 1 and 2, and positions of “surprisingly” in document 2. As described above, phrases that are not meaningful, boilerplate terms, and other terms/phrases may be removed from, or not included in, positional index 1260 to reduce the size of the positional index 1260. A smaller size of positional index can improve search efficiency and speed.

As described above, an index 1263 can initially include a position for each term of the first group of terms corresponding to a collection of documents (e.g., a collection of topically-diverse documents). As illustrated in FIG. 12C, the first group of terms may include the terms “and” and “gate,” which may be terms relate to the topic of a document regarding an electrical circuit.

As described above, the first group of terms can include boilerplate terms (e.g., the words “the,” “a,” “to”). A boilerplate term may not be relevant to the topic of a document, but may relate to structured content such as comments, navigational elements, tables, references, or the like. Correspondingly, for a boilerplate term, an item 1265 may be generated. Item 1265 may include, for instance, the boilerplate term, it associated document frequency; offset, etc. In some embodiments, the first group of terms may include one or more other terms associated with text corpus 1266. For example, the first group of terms may include terms having low visiting frequencies, terms associated with documents having low frequencies of translation, terms occur only once, or the like. Correspondingly, one or more items 1267 can be generated for these terms. Items 1267 may indicate the document frequencies, the number of times the terms are present, and their respective positions. The boilerplate terms and other terms may be part of a second group of terms, which do not indicate topics of documents in text corpus 1266. The second group of terms is not essential or relevant for generating query suggestions, and thus the positions of the second group of terms may be removed from, or not included in, positional index 1260, as described in more detail below.

In some examples, each term of the first group of terms can be associated with metadata 1262. Metadata 1262 can indicate the classification of each term. For example, the metadata associated with a term of the first group of terms may indicate that the term is a primary term, an auxiliary term, or a term not to-be-included in positional index 1260. In some examples, stop words can be terms not to-be-included in positional index 1260. A stop word can be a term that may represent or indicate the topic of a document when it is included in a sequence of terms (e.g., the word “great” in the phrase “great depression;” the word “and” in the phrase “and gate”), but is otherwise less relevant or useful for generating query suggestions. In some embodiments, a stop word can be included in positional index 1260 if it is part of a sequence of terms (e.g., a phrase).

In some examples, a sequence of terms of the first group of terms can be annotated or associated with metadata 1262. For example, the metadata associated with a sequence of terms (e.g., a phrase) can be encoded using a space-and-time efficient data structure such as a Bloom filter. Due to the large number of possible sequences of terms, using a space-and-time efficient data structure can reduce the disk space or memory requirement of index structure 846, and can facilitate a similarity search in an efficient manner. For example, when a Bloom filter is used to facilitate a search of a sequence of terms (e.g., terms in two adjacent tokens) in index structure 846, it does not provide false negatives (although false positives are still possible), thereby improving the querying speed. Annotating or associating metadata to a sequence of terms is described in more detail below.

In some examples, as described, the first group of terms can include a second group of terms. The second group of terms can be a subset of the first group of terms. The second group of terms can include terms and/or sequences of terms that are not to-be-included in the positional index 1260. For example, the second group of terms can include terms/sequences of structured content, terms/sequences irrelevant to topics of documents, stop words, terms/sequences associated with documents having low visiting frequencies, terms/sequences associated with documents having low frequencies of translation, terms/sequences occur only once, or the like. In some examples, to generate positional index 1260, positions of a second group of terms can be removed from the positions of the first group of terms. With reference to FIG. 12C, as an example, items 1265 may include positions associated with a boilerplate term or sequence (e.g., a term or sequence associated with lists, tables, indexes, disambiguation pages, etc.) and thus can be removed from, or not included in, positional index 1260. As another example, positions associated with terms/sequences in a page that is less than a page-length threshold (e.g., a very short page) can be removed from, or not included in, positional index 1260. As another example, item 1267 may include positions of terms associated with documents having a number of visits less than a visit-frequency threshold (e.g., rarely visited documents), and thus may be removed from, or not included in, positional index 1260. As another example, item 1267 may include positions of terms/sequences associated with documents having frequency of translations less than a translation-frequency threshold (e.g., a document may not have been translated in more than 7 languages), and thus may be removed from, or not included in, positional index 1260. As another example, item 1267 may include positions of terms/sequences that are present only once in the corresponding documents (e.g., rare terms), and thus may be removed from, or not included in, positional index 1260.

In some embodiments, positions associated with terms/sequences in the second group of terms can be removed based on document frequencies (DF) of the terms/sequences. For example, if a term/sequence has a DF less than a DF threshold (e.g., 3), the corresponding position can be removed from, or not included in, positional index 1260. A term/sequence has a small DF may indicate that the term/sequence is present in a relative small number of documents and is thus likely not representative or relevant to the topic of the corresponding document.

In some embodiments, positions associated with terms/sequences in the second group of terms can be removed based on the character length of the terms/sequences. For example, if a term/sequence has a character length that is greater than a first character-length threshold (e.g., a very long term/sequence) or has a character length that is less than a second character-length threshold (e.g., a very short term/sequence), the corresponding position can be removed from, or not included in, positional index 1260. In some examples, a very long or a very short term/sequence is likely not to be representative or relevant to the topic of the corresponding document.

In some embodiments, positions associated with terms/sequences in the second group of terms can be removed based on relevant criteria such as scores derived from, for example, page-view statistics associated with the documents included in text corpus 1266. For example, a score may be assigned to each document in text corpus 1266 based on the number of searches or clicks of the particular document within a duration of time. A higher score may indicate that the document has been searched or included in a search result more frequently than a document having a lower score. Thus, the score of a document may indicate the popularity of a document. In some examples, positions associated with terms/sequences in a less popular document (e.g., a document having a score that is less than a document-score threshold) can be removed from, or not included in, positional index 1260. In some examples, less popular documents may not be included in, or may be ignored from, text corpus 1266 in the first place. Additionally, a popularity score can also be used for post-processing the query suggestions, as discussed in more detail below.

In some examples, the number of second group of terms can be a substantial portion of the number of the first group of terms. For example, the second group of terms may include about 80% of the terms in the first group of terms. As a result, removing the positions of the second group of terms from the positions of the first group of terms may significantly reduce the file size of index structure 846. In some embodiments, the size of the index structure 846 can be reduced to, for example, a size that can be readily stored in a mobile device (e.g., a smartphone), such as devices 104, 200, 400, 600, 900, 1000, and 1300. As a result, based on a locally-stored index structure, a mobile device can perform a similarity search of index structure 846 with or without a network connection. This can improve and enhance the speed of providing query suggestions to the user (e.g., providing the query suggestions in a matter of milliseconds from the user initiating the search for topically-similar documents).

With reference back to FIG. 12B, in some embodiments, index structure 846 can include an inverted index 1270. Inverted index 1270 can be a data structure storing a mapping of one or more terms/sequences to one or more documents. In some examples, inverted index 1270 can be generated based on documents of a text corpus (e.g., text corpus 1266 in FIG. 12C). In some embodiments, generating inverted index 1270 can include annotating each term with a tag suffix, similar to a part-of-speech (POS) tagging. For example, a term used in surnames, locations, country names, or the like, can be annotated as a “name” term. A tag suffix for “name” terms can be denoted as “N.” For instance, in inverted index 120, the term “jobs” in the context of “Steve Jobs” can be annotated as “jobsN.” As another example, a term that includes a stop word can be annotated using an “S” suffix. For instance, the term “great” in the sequence of “great depression” is a stop word, and thus can be annotated as “greatS.”

In some embodiments, to generate inverted index 1270, primary terms can be annotated as “topic” terms with a “T’ suffix. For example, the term “ios” can be annotated as “iosT.” As described above, a primary term is a term that can be used for both selection and ranking in the subsequent processing of search results. A primary term may be a term that represents the topic or focus of an associated document. Thus, in some examples, if a similarity search result indicate that one or more terms in a query correspond to one or more primary terms in index structure 846, the documents associated with the one or more primary terms can be the basis of selecting the candidate query suggestions, as described in more detail below. In some embodiments, in addition to annotating a primary term with a suffix, the primary term can also be annotated with extra information such as a reference to the corresponding document.

In some embodiments, to generate inverted index 1270, synonyms can be annotated or encoded with a synonym reference or suffix. For example, the term “aluminum” and “aluminium” can be synonyms and they can be annotated as “aluminumYaluminium,” which indicates that if a query includes the term “aluminum,” the synonym “aluminium” is also to be searched during a similarity search of index structure 846. In some examples, for synonym terms, inverted index 1270 may store the frequency and position information only once. In the above example, inverted index 1270 may only store document and position information for any occurrence of either aluminum or aluminium (or “alu”) in one common item and omit the information for all other synonyms in inverted index 1270. For example, inverted index 1270 may store items indicating {“aluYaluminium”:={no further information}; {“aluminium”:=DF=123: doc 4 (TF=2, postingFreq=1)->(positional index for “alu”, “aluminium” or “aluminum” in doc 4)}; and {“aluminumYaluminium”:={no further information}}.

In some examples, synonym terms can include a reference term and one or more alternative terms. In the above example, the term “aluminum” can be a reference term and the term “aluminium” can be an alternative term. In some examples, alternative terms can be annotated with a suffix “Y,” while reference terms may not have any suffix. Thus, in inverted index 1270, alternative terms may not be associated with any position information, and can instead refer to the corresponding reference terms. For example, inverted index 1270 can include items indicating {“aluY”:={no further information}}; {“aluminiumY”:={no further information}}; {“aluminum”:=DF=123: doc 4 (TF=2, postingFreq=1)->(positional index for “alu”, “aluminium” or “aluminum” in doc 4)}. By only including position information for a reference term, the file size of index structure 846 can be further reduced.

In some embodiments, to generate inverted index 1270, each unique sequence of terms (e.g., a phrase) associated with a text corpus (e.g., text corpus 1266 in illustrated in FIG. 12C) can be annotated. As described above, a text corpus can include one or more sequences of terms. In some examples, unique sequences of terms in the text corpus can be annotated to improve search performance (e.g., increasing the speed of performing a similarity search of the index structure 846). For example, a sequence of terms “and gate” may represent a type of circuit element and may be a unique sequence of terms. This sequence of terms can thus be annotated such that the similarity search would be performed with respect to the sequence “and gate,” rather than two separate terms “and” and “gate.” In some embodiments, annotation of a sequence of terms can be performed in a space-and-time efficient data structure, such as a Bloom filter.

With reference to FIGS. 12B and 12C, in some embodiments, to annotate each unique sequence of terms (e.g., a sequence stored in a Bloom filter), positional index 1260 can be cross referenced. For example, it can be determined whether a unique sequence of terms in inverted index 1270 corresponds to a sequence of terms associated with positional index 1260. As described above, positional index 1260 may include positions of only the selected terms (e.g., by removing positions of the second group of terms), which can include terms that are likely to be relevant to or representative of the topic of the documents in text corpus 1266. Thus, the determination of whether a sequence of terms corresponds to a sequence of terms associated with positional index 1260 can indicate whether the particular sequence of terms is likely to be relevant to or representative of the topic of the documents in text corpus 1266. In some examples, if the particular sequence of terms does not correspond to any sequence of terms associated with positional index 1260, the particular sequence may unlikely be relevant to or representative of the topic of any document of text corpus 1266, and thus may not be annotated.

With reference to FIG. 12B, in some embodiments, in accordance with a determination that a sequence of terms in inverted index 1270 corresponds to a sequence of terms associated with positional index 1260, annotating the sequence of terms in inverted index 1270 can include determining metadata associated with the sequence of terms in inverted index 1270. In some examples, determining metadata associated with the sequence of terms in inverted index 1270 can include determining whether the sequence of terms is a primary sequence. Similarly to a primary term, a primary sequence is a sequence of terms that can be used for both selection and ranking in the subsequent processing of search results. A primary sequence may be a sequence that represents the topic or focus of an associated document in text corpus 1266. In some examples, in accordance with a determination that the sequence of terms in inverted index 1270 is not a primary sequence, the particular sequence is determined to be an auxiliary sequence. An auxiliary sequence may not be annotated (e.g., encoded using a Bloom filter).

In some examples, metadata (e.g., metadata 1262 as shown in FIG. 12C) can store indications of whether a sequence is a primary sequence or an auxiliary sequence. As described above, metadata can be encoded and stored using a Bloom filter. A typical Bloom filter may only store information regarding whether a term or sequence (e.g., represented by a set of numbers derived from the term or sequence using one or more hash functions) “may or may not be present” or “is definitely not present.” Thus, a typical Bloom filter may not provide a data structure for readily storing metadata along with the corresponding term or sequence. In some examples, instead of directly converting a term or a sequence of terms (e.g., a bigram phrase) to a numeric representation using hash functions, the hash functions can be modified with a seed value, which corresponds to a particular metadata type. Based on the modified hash functions, a modified Bloom filter can have a data structure for storing metadata-term or metadata-sequence combinations. For example, recognizing that the sequence “Donald Trump” may be a primary sequence, a name, and a topic by itself, a modified Bloom filter can store, for a sequence “Donald Trump,” three elements such as {(“Donald Trump”, primary); (“Donald Trump”, name); (“Donald Trump”, topic)}. And recognizing the sequence “John Doe” is merely an auxiliary sequence and a name, but probably not a topic by itself, a modified Bloom filter can store, for a sequence of “John Doe,” two elements such as {(“John Doe”, auxiliary); (“John Doe”, name)}.

In some embodiments, determining metadata associated with the sequence of terms in inverted index 1270 can further include determining whether the particular sequence of terms is a name sequence (e.g., a phrase “Donald Trump”). In some examples, in accordance with a determination that the particular sequence of terms is a name sequence, the sequence is annotated accordingly (e.g., encoded using a Bloom filter).

In some embodiments, determining metadata associated with the sequence of terms in inverted index 1270 can include determining whether the particular sequence of terms is a topic sequence (e.g., a phrase “nuclear debate” may be a topic sequence indicating the topic of an article regarding whether U.S. should abandon nuclear power). In some examples, in accordance with a determination that the sequence of terms in inverted index 1270 is a topic sequence, the sequence is annotated accordingly (e.g., encoded using a Bloom filter).

In some embodiments, determining metadata associated with the sequence of terms in inverted index 1270 include determining whether the sequence of terms is stored as a single term. For example, a tokenizer may tokenize text “T-Mobile” to obtain a sequence of terms “t” and “mobile.” This sequence of terms may be stored as a single term “t mobile.” In some examples, in accordance with a determination that the sequence of terms in inverted index 1270 is stored as a single term, the sequence is annotated accordingly (e.g., encoded using a Bloom filter). In some examples, inverted index 1270 may include a term “t mobile” or optionally synonym “tmobileYt mobile” or vice versa, similar to those described above.

In some embodiments, to annotate each unique sequence of terms in inverted index 1270, the metadata associated with the sequence of terms can be encoded. As described above, the metadata associated with a sequence of terms (e.g., a phrase) in inverted index 1270 can be encoded using a space-and-time efficient data structure such as a Bloom filter. A Bloom filter can reduce the disk space requirement of annotating sequences of terms, and therefore reduces the disk space requirement for inverting index 1270. Moreover, a Bloom filter can facilitate the search of a sequence of terms (e.g., represented in the form of a hashed value) in substantially constant time with a predetermined upper limit of a false positive rate (e.g., 0.1%). In some examples, when a Bloom filter is used to determine whether a sequence of terms (e.g., terms in two adjacent tokens) in a query is included in index structure 846, it does not provide false negatives (although false positives are still possible), thereby improves the querying speed.

With reference back to FIG. 12B, in some embodiments, index structure 846 can include document-specific data 1280. Document-specific data 1280 can include, for example, title of the document. Document-specific data 1280 enables displaying information associated with the query suggestions (e.g., displaying titles of the suggested articles) to the user. In some embodiments, as illustrated in FIG. 12B, positional index 1260, inverted index 1270, and document-specific data 1280 can form a customized Lucene index. A Lucene index can represent documents having various different formats, such as pdf documents, HTML documents, Microsoft Word® documents, or any other documents containing text. With reference to FIGS. 8, 11, and 12A-C, in some examples, Apache® Lucene can be, but is not required to be, used as a component for similarity search engine 1220, tokenizer 1120, as well as the framework to store and retrieve information from index 1263, positional index 1260, repository of candidate query suggestions 840, and metadata 1262.

As described above, index structure 846 can be generated based on a text corpus (e.g., a training corpus), which can be a collection of documents. With reference back to FIG. 8, in some examples, index structure 846 can be generated by intelligent automated assistant 800 implemented by components depicted in FIGS. 1-4, 6A-B, and 7A-C (e.g., devices 104, 200, and 600). In some examples, index structure 846 can be generated before intelligent automated assistant 800 receives a user input initiating a search (e.g., a search for topically similar document). As such, index structure 846 can be provided or accessible to query suggestion generator 860 for generating query suggestions based on the user input 802 initiating a search (e.g., a touch in an user input area) and input document 804 (e.g., an article the user is reading/listening). In some examples, intelligent automated assistant 800 can generate index structure 846 after receiving a user input initiating a search. Index structure 846 can then be provided or accessible to query suggestion generator 860. In some examples, index structure 846 can be dynamically updated with additional or newly available documents in a text corpus (e.g., text corpus 1266 as illustrated in FIG. 12C).

With reference to FIGS. 8 and 12A, as described, query suggestion generator 860 can include a similarity search engine 1220 and a search result post processing module 1240. In some embodiments, similarity search engine 1220 can perform a similarity search based on query 822 and index structure 846. A similarity search can compare the similarities between one or more terms and/or sequences of terms in query 822 and the terms and/or sequences of terms in index structure 846. As described, the one or more terms and/or sequences of terms in query 822 are generated based on input document 804 (e.g., an article the user is reading/listening), and index structure 846 is generated based on a text corpus (e.g., a training corpus including a collection of topically-diverse documents). As a result, a similarity search can facilitate the determination of query suggestions (e.g., documents that are topically similar or related to input document 804). In some examples, post processing of the similarity search result can be performed to determine the query suggestions, as described in more detail below.

With reference to FIG. 12A, in some examples, to perform a similarity search, similarity search engine 1220 can search index structure 846 based on query 822, which may include one or more primary terms/sequences and auxiliary terms/sequence. For example, to obtain the search results, similarity search engine 1220 can perform a cosine similarity search using primary terms/sequences, followed by an optional refining cosine similarity search using both primary and auxiliary terms/sequences. It is appreciated that similarity search engine 1220 can perform the similarity search based on any other search techniques or algorithms.

In some examples, similarity search engine 1220 can further rank the search results based on the one or more primary terms/sequences of terms and/or one or more auxiliary terms/sequences of terms included in query 822. As described above, a primary term or primary sequence can be a term or sequence that represents the topic or focus of an associated document (e.g., input document 804). An auxiliary term or auxiliary sequence can be a term or sequence related to the topic or focus of the associated document (e.g., input document 804), but may be less relevant than a primary term or sequence. Therefore, in some examples, primary terms/sequences can be used for both ranking and selection, while auxiliary terms/sequences can be used only for ranking. For example, similarity search engine 1220 can determine a score for each document associated with the search results based on the primary terms/sequences and/or the auxiliary terms/sequences included in query 822. Similarity search engine 1220 can then rank the search results based on the score, and generated a group of ranked search results 1222 (e.g., top-20 search results). In some examples, the score can represent the degree of similarity between the terms/sequences included in query 822 and the term/sequences included in documents represented by the search results. It is appreciated that similarity search engine 1220 can rank the search results based on any other ranking or sorting techniques or algorithms.

With reference to FIG. 12A, in some embodiments, search result post processing module 1240 can determine one or more query suggestions 862 based on the similarity search results. As described, similarity search engine 1220 can generate a group of ranked search results 1222, which may represent, for example, 20 documents. In some embodiments, further refining or narrowing of the search results may be desired such that the user is provided with a few (e.g., 2-3) query suggestions (e.g., suggested articles). Providing the user with a few query suggestions improves user interaction interface, and can be more efficient. For example, the user would not be required to manually view or scroll to view a large number (e.g., 20) query suggestions, and would only need to select between 2-3 query suggestions that are most likely be interested to the user. Thus, in some embodiments, post-processing of ranked search results 1222 to refine or narrow the search results to a few query suggestions can be performed.

With reference to FIG. 12A, to determine one or more query suggestions 862, search result post processing module 1240 can obtain a group of ranked search results 1222 (e.g., the top 20 search results). The group of ranked search results 1222 can represent the candidate query suggestions. In some examples, search result post processing module 1240 can perform post-processing of the group of ranked search results 1222 based on various techniques. As an example, search result post processing module 1240 can determine whether one or more matching primary terms or sequences are interdependent, and in accordance with a determination that one or more matching primary terms or sequences are interdependent, reduce the number of matches associated with search results. In the group of ranked search results 1222, a matching primary term or sequence can be a primary term or sequence that is included in query 822 and is also a term or sequence represented in index structure 846. As an example of interdependence, search result post processing module 1240 can determine whether a matching primary term is also part of a matching sequence (e.g., the term “crystal” is also in the phrase “crystal cave”). If so, search result post processing module 1240 can reduce the number of matches associated with the search results. This is because the term “crystal” and the phrase “crystal cave” are interdependent, and should not be counted twice.

As another example of post processing of the ranked search results 1222, search result post processing module 1240 can determine whether all matching primary terms represent names. For example, a similarity search may be performed with respect to primary terms or primary sequences of terms such as “European road signs.” The group of ranked search results 1222 may indicate that all matching primary terms associated with index structure 846 represent European country names such as “Germany,” “Spain,” “France,” etc. With reference to FIGS. 12A and 12B, in some examples, in accordance with a determination that all matching primary terms represent names, search result post processing module 1240 can determine the number of correlations between the matching primary terms and document-specific data 1280 (e.g., the title of the documents) of index structure 846 as shown in FIG. 12B. For example, search result post processing module 1240 determines how many of the matching primary terms correspond to terms included in the title of the documents represented by index structure 846. If a matching primary term corresponds to a term included in the title of a document represented by index structure 846, it is likely that the matching primary term represents or reflects the topic of that document. As a result, the particular search result may be retained.

In some examples, search result post processing module 1240 can further determine whether the number of correlations satisfies a correlation-threshold. In accordance with a determination that the number of corrections does not satisfy a correlation-threshold, search result post processing module 1240 can remove one or more ranked search results associated with the matching primary terms. For example, search result post processing module 1240 determines that the number of correlations between the matching primary terms and the titles of the documents represented by index structure 846 is only 1, indicating that the majority of the matching primary terms are likely not representative or reflecting the topics of the corresponding documents represented by index structure 846. As such, search result post processing module 1240 can remove the ranked search results associated with the matching primary terms.

As another example of post processing of the ranked search results 1222, search result post processing module 1240 can determine whether one or more terms associated with a document title (e.g., indicated by document-specific data 1280 as shown in FIG. 12B) match with the tokens included in query 822. In some examples, the group of ranked search results 1222 can include terms corresponding to a title of a document in a text corpus represented by index structure 846. The terms included in a document title likely represent or reflect the topic of the document. For example, a document of a text corpus represented by index structure 846 may have a title including the terms or a sequence of terms “Melania Trump,” indicating that this document has a topic regarding the first lady. In some examples, search result post processing module 1240 can determine whether both of these terms or the sequence of the terms “Melania Trump” match with one or more tokens included in query 822. In accordance with a determination that at least one of the one or more terms of a document title does not match the tokens included in query 822, search result post processing module 1240 can remove one or more ranked search results associated with the document title. For example, if search result post processing module 1240 determines that one or both terms “Melania Trump” does not match with tokens in query 822, it determines that the corresponding ranked search result is unlikely to have similar topic as input document 804 (e.g., the article the user was reading), and can thus remove the corresponding ranked search result.

Matching the terms in the title of a document to the tokens in query 822 can reduce the likelihood of providing false positive query suggestions. For example, a document with a title “GeForce® 650 GPU” may have a topic on a particular graphic processing unit (GPU) manufactured by the company Nvidia®. The document may thus include the terms “nvidia” and “graphics card.” A ranked search result may indicate that the matching primary terms include “nvidia” and “graphics card,” indicating that these terms are included in query 822. However, in some examples, the user is likely interested in reading a document about the company Nvidia®, and is less likely to be interested in the specific product of that company. Therefore, providing a query suggestion for the document titled “GeForce® 650 GPU” may not be desired. By matching the terms in the title of the document (i.e., GeForce® 650 GPU) to the tokens in query 822 (e.g., “nvidia,” “graphic card”), search result post processing module 1240 can determine that the terms in the title are not included in query 822, and thus remove the ranked search result associated with the document title “GeForce® 650 GPU.” In some examples, a single document may have multiple candidate titles (e.g., stored in document-specific data 1280). Search result post processing module 1240 can compare terms in each of the multiple candidate titles to the tokens in query 822, and determine a best matching title.

As another example of post processing of the ranked search results 1222, search result post processing module 1240 can re-rank the search results associated with documents having identical matching terms. For example, the group of ranked search results 1222 may indicate that two documents in a text corpus represented by index structure 846 have the same or substantially the same matching terms or sequences corresponding to those included in query 822. The same matching terms or sequence may include a subset of the terms such as primary terms or sequences. Accordingly, search result post processing module 1240 can re-rank the group of ranked search results 1222 with respect to the two documents. For example, search result post processing module 1240 can assign a higher rank to the search result corresponding to the document having one or more matching terms in the document title, or to the search result corresponding to the document that represent a more generic description of the topic.

As described above, popularity scores (e.g., derived from page-view statistics of text corpus 1266 shown in FIG. 12C) can be used for post-processing of the query suggestions. Popularity scores can indicate how popular a particular document is (e.g., how frequently the document is visited or viewed). In some examples, the same or different popularity scores can be used to re-rank ranked search results 1222. For example, for an input document 804 having a topic regarding a discovery of a new dinosaur, the group of ranked search results 1222 may include terms ranked in the order of “Ankylosaurus,” “Tyrannosaurus,” and “Dinosaur.” Based on the popularity scores, search result post processing module 1240 can re-rank these terms.

In particular, as described above, repository of candidate query suggestions 840 can include query suggestions representing topically-diverse documents. In some examples, these documents can be ranked or ordered based on their popularity scores. Popularity scores may be distributed accordingly to, for example, a power-law distribution and thus only a few query suggestions (e.g., topics) may have relatively high popularity scores (e.g., very popular) and the majority of other query suggestions may have low popularity scores (e.g., less popular). In some examples, the documents can be ranked or ordered such that those documents with high popularity scores can be associated with low document ID numbers (e.g., doc ID 0, 1, etc.), indicating they are ordered in the beginning of the ranked documents. And documents with less popular scores can be associated with high document ID numbers (e.g., doc ID 10000, 10001, etc. for a text corpus of about 20000 documents). In some examples where the popularity scores have a power-law distribution, the difference in popularity can be greater between documents with low document ID numbers (e.g., between doc IDs 10 and 15) than between documents with relatively high document ID numbers (e.g., between doc IDs 10000 and 10015)).

With reference to FIG. 12A, in some examples, search result post processing module 1240 can perform post processing of ranked search results 1222 based on the documents ranked based on their associated popularity scores. For example, search result post processing module 1240 can obtain top-k (e.g., top 3) search results from ranked search results 1222. Each of the top-k ranked search results may be associated with a similarity score indicating the degree of similarity between the particular search result and the topic of input document 804. Each of the top-k ranked search results may also have a corresponding document ID number indicating the relative popularity of the corresponding document represented in repository 840. For instance, the top-3 ranked search results for an input document 804 regarding a recently discovered dinosaur fossil may include “Ankylosaurus” (similarity score: 23.45, docID 14041), “Tyrannosaurus” (similarity score: 18.45, docID: 27455), and “Dinosaur” (similarity score: 12, docID: 5645).

In some examples, based on the similarity scores of the top-k search results, a relative document score for each search result can be determined. The relative document score can be a ratio of the absolute similarity score of each search result to the highest absolute similarity score in the top-k search results. Continuing the above example, the top-3 search results in ranked search results 1222 can have the following associated information: {result rank 1: “Ankylosaurus” (relative document score: 23.45/23.45=1, docID 14041, document_rank=2)}; {result rank 2: “Tyrannosaurus”, relative document score: 18.45/23.45=0.787, docID: 27455, document_rank=3)}; and {result rank 3: “Dinosaur”, relative document score: 12/23.45=0.512, docID: 5645, document_rank=1)}. In the above information of search results, the doc ID denotes a document ID number of the rth search result, and document_rank denotes the ranking of search results based on the document ID. For example, the search result having the lowest docID (e.g., 5645) is assigned a document_rank of 1, the search result having docID of 14041 is assigned a document_rank of 2, and the search result having docID of 27455 is assigned a document_rank of 3. As described, in some examples, the document ID reflects the popularity of the corresponding document, and thus the top-k search results can be re-ranked according to the document IDs. In some examples, re-ranking of the top-k search results may account for further factor using a blended score, as described below.

In some examples, for each search result in the top-k search results, a blended score can be determined based on the relative document score and relative popularity score of the particular search result. For example, a blended score can be determined based on the following formula (1).

blended_score(r)=alpha*relative_document_score(r)+(1−alpha)*relative_popularity_score(docID(r)) (1)

In formula (1), relative_popularity_score(docID(r)) can be determined based on formula (2) below.

relative_popularity_score(d)=(1−(docID(r)/(NUM_DOC+1)))/log_2(1+document_rank(d)) (2)

In the above formulas, log_2 denotes a logarithm of base 2; docID(r) denotes a document ID number of the rth search result; NUM_DOC denotes the total number of documents represented by repository 840, and document_rank(d) denotes the rank of a particular document ID relative to the others. The docID(r) can have a range from, for example, 0 to the total number of documents represented by repository of candidate query suggestions 840. The document_rank(d) can have a range from 0 to k, where k denotes the total number of top-k search results. In the above formulas, alpha denotes a blending parameter, which can be an empirical factor that may have a range from 0 to 1. If alpha equals 1, only relative document score is considered, and the order of the search results in ranked search results 1222 is preserved (e.g., not re-ranked). If alpha equals 0, only relative popularity score is considered, and the search results in ranked search results 1222 is re-ranked solely based on their popularities (e.g., using the document ranks). For instance, as described above, the ranked search results 1222 may be in the order of “Ankylosaurus,” “Tyrannosaurus,” and “Dinosaur.” If alpha equals 1, this order is not changed. If alpha equals 0, this order may be changed to, for example, “Dinosaur,” “Tyrannosaurus,” and “Ankylosaurus.” The blend parameter alpha can be a numerical value between 0 and 1. For example, alpha may equal 0.5. Accordingly, for a total number of documents of about 30000 represented by repository 840, the blended scores for “Ankylosaurus,” “Tyrannosaurus,” and “Dinosaur” can be determined using the above formulas to be 0.668, 0.415, and 0.662, respectively. Accordingly, the order of the ranked search results 1222 may be re-ranked to be in the order of “Ankylosaurus,” “Dinosaur,” and “Tyrannosaurus” (e.g., the descending order of the blended score).

In some examples, certain graphical user interfaces (GUIs) of a device (e.g., a smart watch) may only allow limited number of query suggestions. Thus, re-ranking of the search results can further enhance or maximize the likelihood that query suggestions most interested to the user or relevant are provided to the user. This in turn improves the user-interface interaction efficiency.

As another example of post processing of the ranked search results 1222, search result post processing module 1240 can determine whether a ranking score of a document satisfies a document-score threshold. As described above, to provide ranked search results 1222, similarity search engine 1220 can determine a score for each document associated with the similarity search results, and subsequently rank the documents based on their respectively scores. In some examples, search result post processing module 1240 can compare the score of each document in the group of ranked search results 1222 to a document-score threshold. If the score of a particular document is less than the document-score threshold, search result post processing module 1240 can remove the ranked search result associated with the particular document.

With reference to FIG. 12A, as another example of post processing of the ranked search results 1222, search result post processing module 1240 can determine an alternative document title based on query 822. In some examples, two or more different terms or sequences of terms can refer to the same entity or concepts. For example, “Sir Topham Hatt” and “The Fat Controller” may refer to the same entity or person. Thus, based on the terms or sequences included in input document 804, which are the basis for generating query 822, search result post processing module 1240 can select one or more search results from the group of ranked search results 1222, and remove others. For example, input document 804 may include the terms or a sequence of terms “The Fat Controller.” Accordingly, with respect to the group of ranked search results 1222, search result post processing module 1240 can select, or assign a higher rank to, a search result associated with the document with a title “The Fat Controller,” rather than a search result associated with the document with a title “Sir Topham Hatt.” In some examples, search result post processing module 1240 can make the selection based on terms and/or sequences stored in index 1263 (e.g., shown in FIG. 12C) and optionally tokens that are not stored in index 1263 (e.g., “sir” may be a token obtained by tokenizer 1120, but may not be stored in index 1263).

With reference to FIGS. 8 and 12A, as another example of post processing of the ranked search results 1222, search result post processing module 1240 can re-rank the ranked search results 1222 based on the user input (e.g., user input 802). Using the above example of “Sir Topham Hatt,” user input 802 may include the text “Sir Top.” Thus, search result post processing module 1240 may rank the search result containing the sequence of terms “Sir Topham Hatt” higher than other search results, despite that other re-ranking factors (e.g., popularity scores) may indicate that a search result containing the sequence “The Fat Controller” should be ranked higher. In some examples, user input 802 can also be used as a filter for removing any search results that are not likely completions of user input 802.

With reference to FIGS. 8 and 12A, based on the post processing results, query suggestion generator 860 can receive, from repository of candidate query suggestions 840, one or more query suggestions 862. As illustrated in FIG. 12A, in some embodiments, candidate query suggestions can be generated based on the group of ranked search results 1222. As described, candidate query suggestions can include a document, a link to a document, a thumbnail image representing the link to a document, or any representation of a document. In some embodiments, candidate query suggestions can be generated based on the group of ranked search results 122 and index structure 846 (e.g., using the matching terms and index structure 846 to obtain a corresponding document). In some embodiments, search result post processing module 1240 can receive query suggestions 862 based on the post processed search results (e.g., refined or narrowed search results based on the group of ranked search results 1222). For example, a few (e.g., 2-3) candidate query suggestions can be selected from repository of candidate query suggestions 840 and provided as query suggestions 862. As described, query suggestions 862 can represent topically similar documents that the user is likely interested in. In some embodiments, candidate query suggestions can be generated based on the post processed search results (e.g., refined or narrowed search results based on the group of ranked search results 1222). Accordingly, these candidate query suggestions can be provided as query suggestions 862.

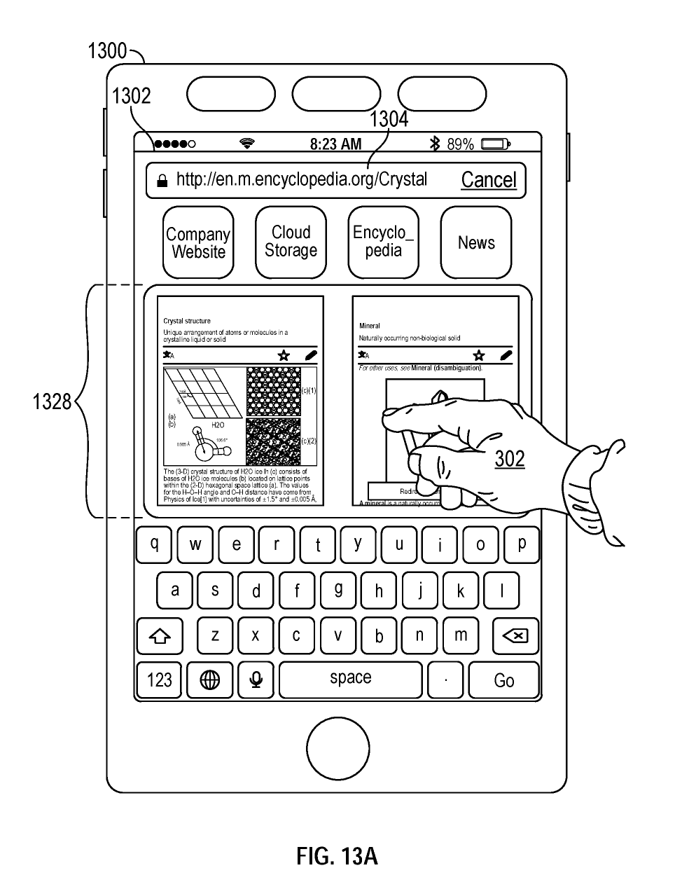

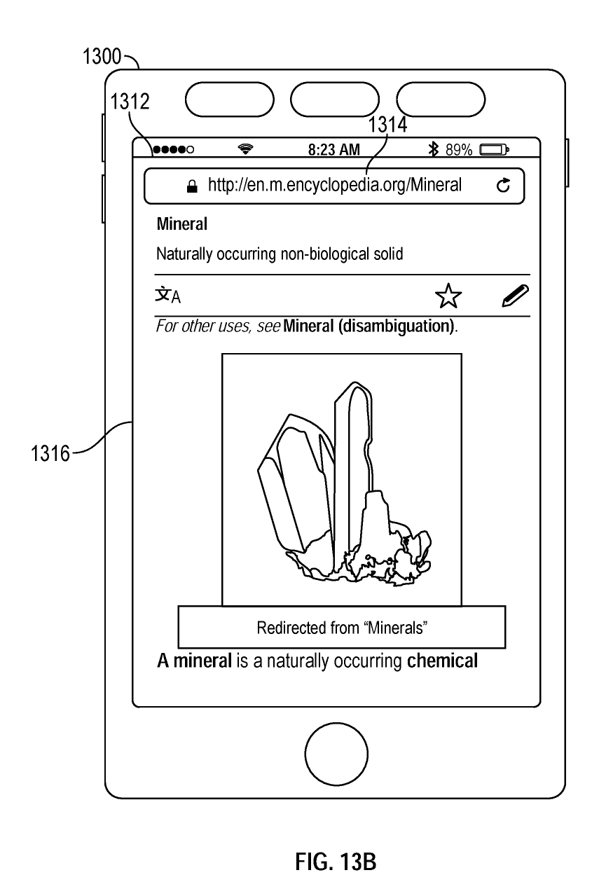

With references to FIGS. 8 and 13A, in some embodiments, intelligent automated assistant 800 can provide one or more query suggestions 862 to the user. As illustrated in FIG. 13A, in some examples, intelligent automated assistant 800 can display query suggestions 1328 on user interface 1302. In some examples, query suggestions 1328 are displayed at a display area that is different from the display area (e.g., display area 1304) for receiving the input document (e.g., input document 804). In some examples, query suggestions 1328 can include thumbnails or preview images of the linked documents.

FIG. 13A further illustrates a user interface 1302 for receiving a user selection of a query suggestion, according to various examples. FIG. 13B illustrates a user interface 1312 for providing a document to the user in accordance with the user selection of a query suggestion, according to various examples. As shown in FIGS. 13A and 13B, for example, intelligent automated assistant 800 can provide a user interface 1302 for receiving a selection of one query suggestion among a plurality of query suggestions 1328 from the user. The user can select one of query suggestions 1328 by using, for example, one or more fingers 302. In response to receiving the user selection, intelligent automated assistant 800 can provide a user interface 1312 for providing information corresponding to the selected query suggestion to the user (e.g., displaying a document 1316 to the user according to the selected query suggestion).

### 5. Process for Providing Query Suggestions Based on Intelligent and Efficient Searching

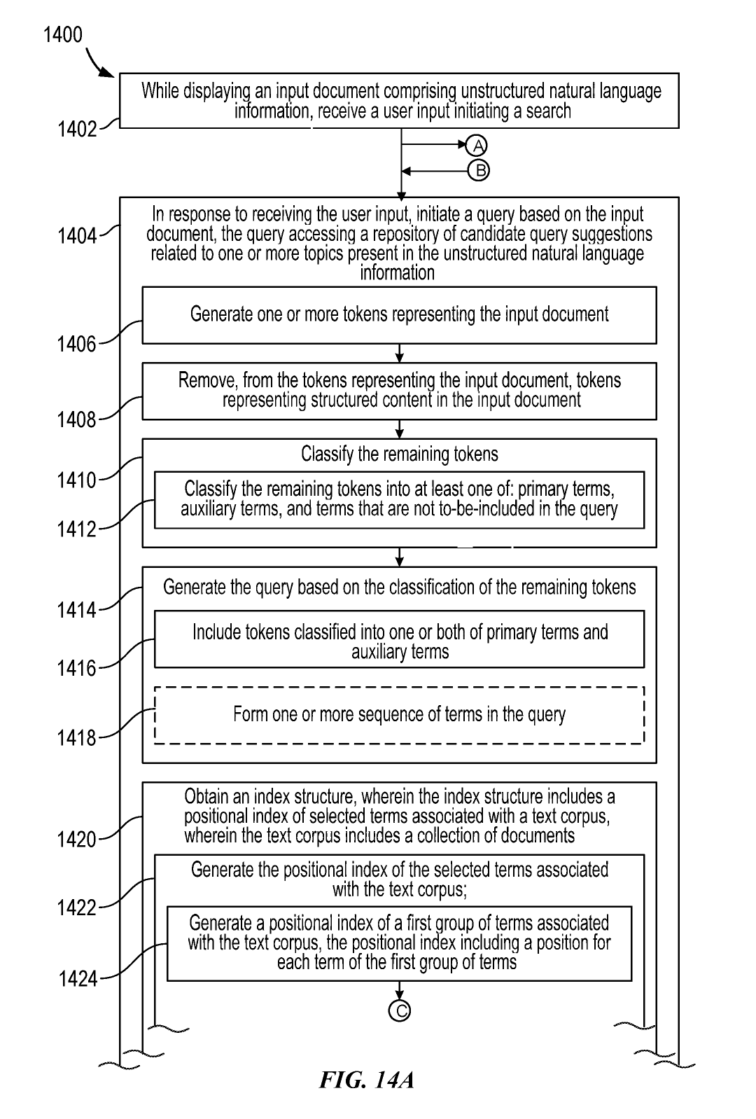

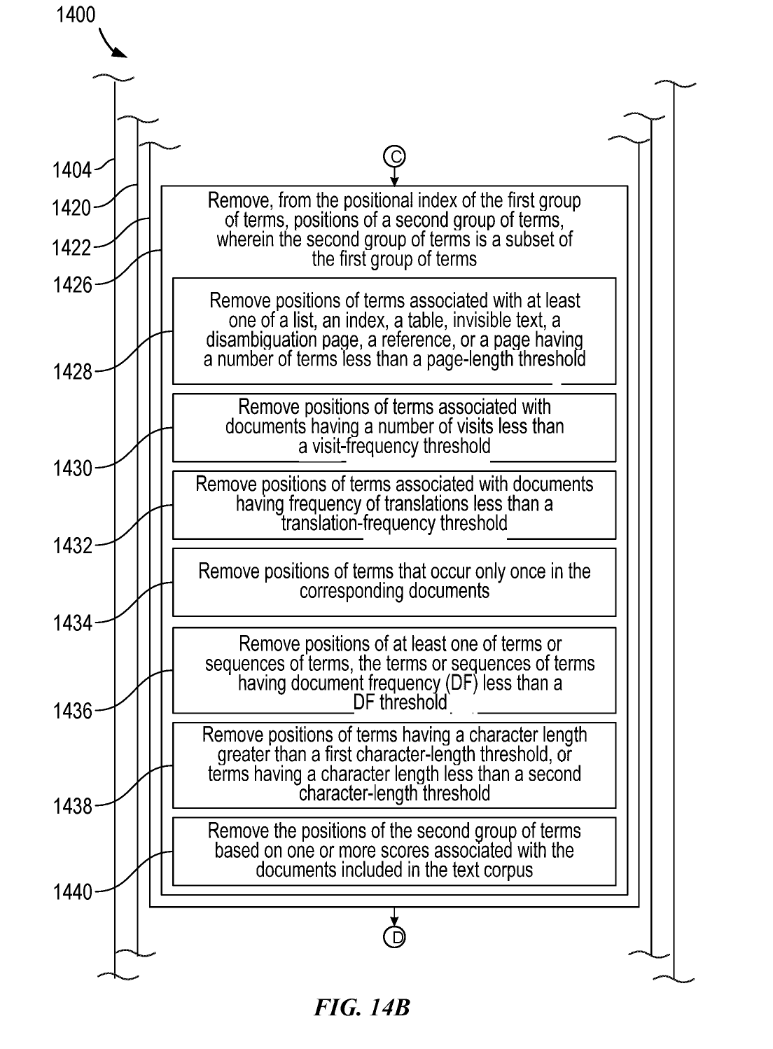

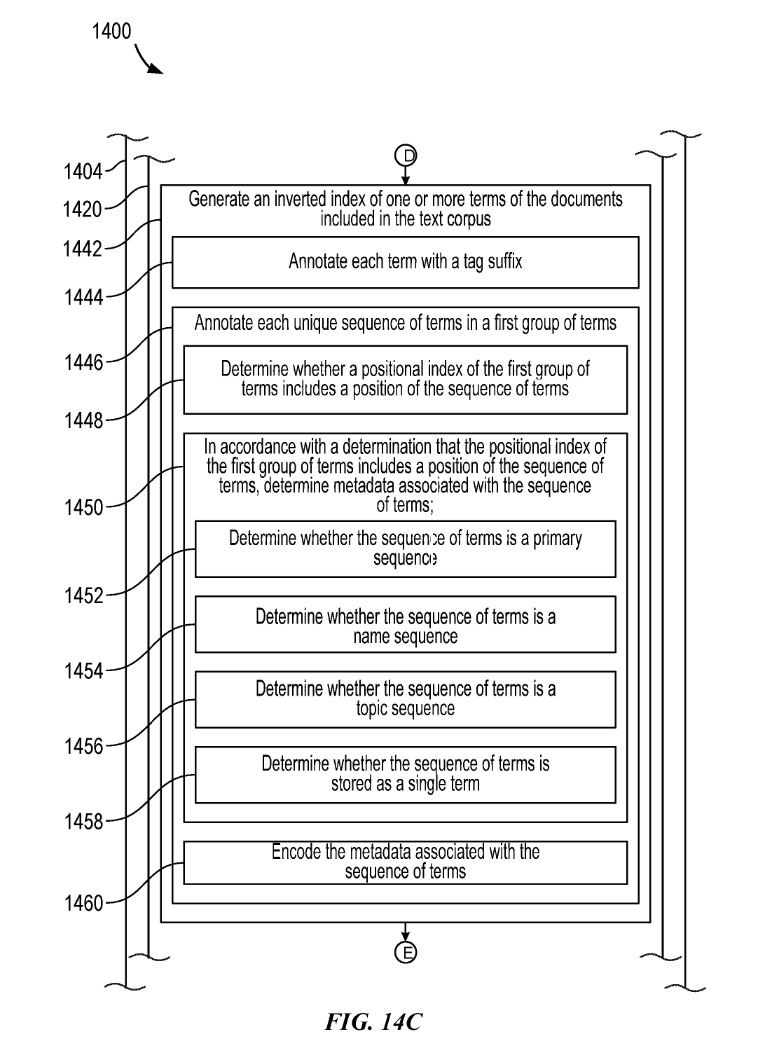

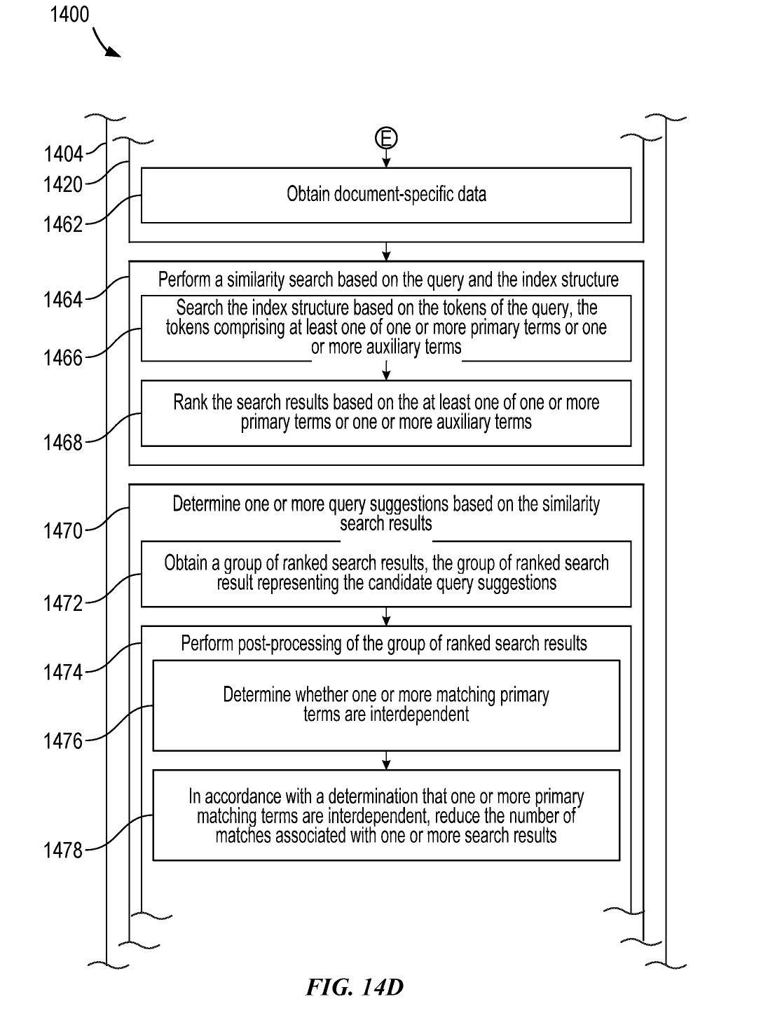

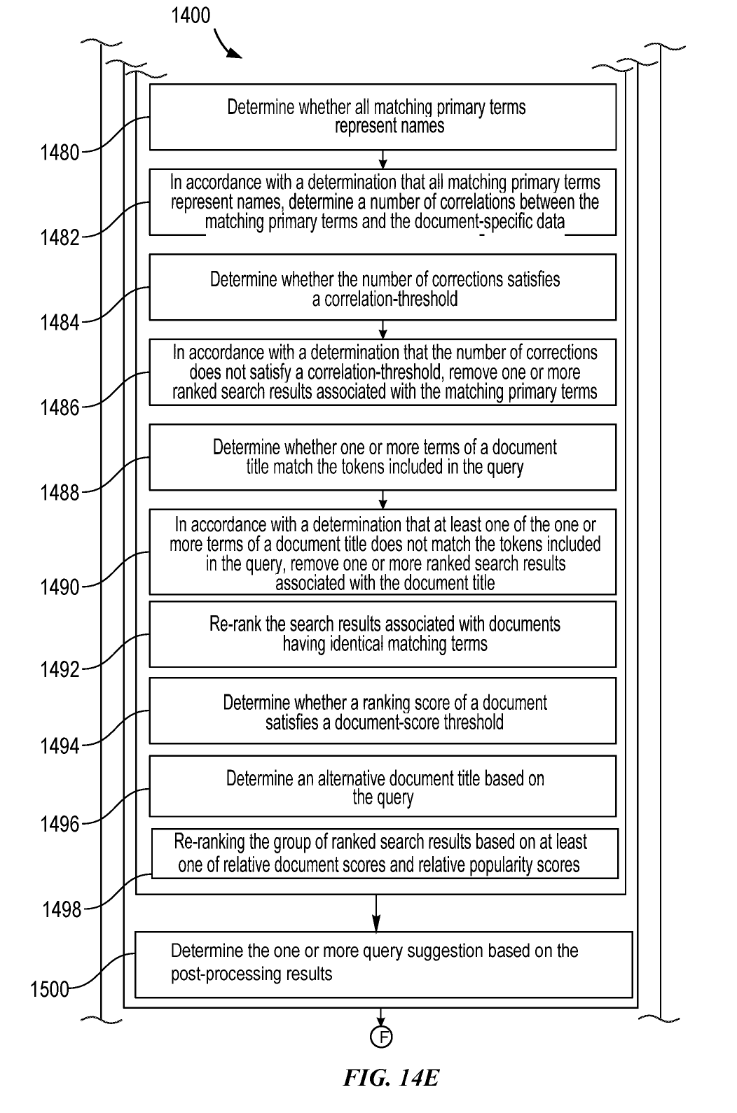

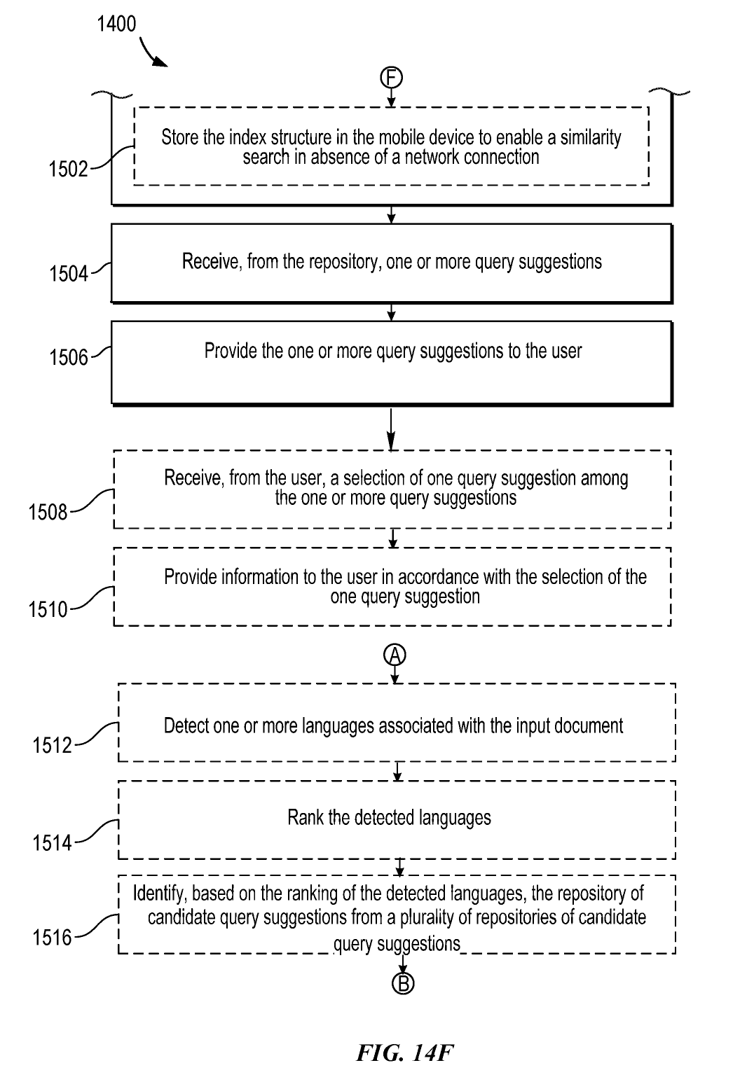

FIG. 14A-14F illustrates process 1400 for operating a digital assistant for providing query suggestions, according to various examples. Process 1400 is performed, for example, using one or more electronic devices implementing a digital assistant. In some examples, process 1400 is performed using a client-server system (e.g., system 100), and the blocks of process 1400 are divided up in any manner between the server (e.g., DA server 106) and a client device. In other examples, the blocks of process 1400 are divided up between the server and multiple client devices (e.g., a mobile phone and a smart watch). Thus, while portions of process 1400 are described herein as being performed by particular devices of a client-server system, it will be appreciated that process 1400 is not so limited. In other examples, process 1400 is performed using only a client device (e.g., user device 104, 200, 400, 600, 900, 1000, or 1300) or only multiple client devices. In process 1400, some blocks are, optionally, combined, the order of some blocks is, optionally, changed, and some blocks are, optionally, omitted. In some examples, additional steps may be performed in combination with the process 1400.

With reference to FIG. 14A, at block 1402, while displaying an input document comprising unstructured natural language information, a user input initiating a search is received. The input document may be a document that the user is reading or listening. In some examples, the input document includes a text document, a webpage, a message, an email, or a hyperlink to a document. In some examples, the user input initiates a search for a document that is topically similar to the input document.

At block 1404, in response to receiving the user input, a query is initiated based on the input document. The query accesses a repository of candidate query suggestions related to one or more topics present in the unstructured natural language information. At block 1406, to initiate a query, one or more tokens representing the input document are generated. At block 1408, tokens representing structured content in the input document are removed from the tokens representing the input document. Structured content in the input document may include, for example, boilerplate text such as comments, navigational elements, tables, references, or the like. Structured content are likely not the focus of the input document and are thus likely not essential for generating the query. At block 1410, the remaining tokens are classified. At block 1412, the remaining tokens are classified into one or more primary terms, one or more auxiliary terms, and terms that not to-be-included in the query. In some examples, it is further determined whether one or more terms of the remaining tokens are to be included in an index structure. And the determination can be based on at least one of a document frequency (DF), a collection term frequency (CTF), or a relation of the DF and CTF. In some examples, classifying the remaining tokens is based on a predetermined list of terms (e.g., a user customized list of terms).

At block 1414, the query is generated based on the classification of the remaining tokens. At block 1416, to generate the query, tokens classified into one or both of primary terms and auxiliary terms are included in the query. At block 1418, one or more sequences of terms are formed in the query.

At block 1420, to access a repository of query suggestions related to one or more topics present in the unstructured natural language information, an index structure is obtained. The index structure includes a positional index of selected terms associated with a text corpus. The text corpus includes a collection of documents. At block 1422, to obtain the index structure, the positional index of the selected terms associated with the text corpus is generated.

At block 1424, to generate the positional index, positions of a first group of terms associated with the text corpus are generated. The positions include a position for each term of the first group of terms. In some examples, each term of the first group of terms is associated with metadata indicating the classification of the term (e.g., primary, auxiliary, not to-be-included). In some examples, the first group of terms includes one or more sequences of terms. The one or more sequences of terms are associated with metadata encoded using a space-and-time efficient data structure such as a Bloom filter. With reference to FIG. 14B, at block 1426, positions of a second group of terms are removed from the positions of the first group of terms. The second group of terms is a subset of the first group of terms. In some examples, the number of the second group of terms is a substantial portion of the number of first group of terms.

At block 1428, to remove positions of the second group of terms, it is removed the positions of terms associated with structured content such as at least one of a list, an index, a table, invisible text, a disambiguation page, a reference, or a page having a number of terms less than a page-length threshold. At block 1430, to remove positions of the second group of terms, it is removed the positions of terms associated with documents having a number of visits less than a visit-frequency threshold (e.g., rarely or infrequently visited documents).

At block 1432, to remove positions of the second group of terms, it is removed the positions of terms associated with documents having frequency of translations less than a translation-frequency threshold (e.g., documents that do not have enough translations). At block 1434, to remove positions of the second group of terms, it is removed the positions of terms that are present only once in the corresponding documents (e.g., rare terms).

At block 1436, to remove positions of the second group of terms, it is removed the positions of at least one of terms or sequences of terms, the terms or sequences of terms having document frequency (DF) less than a DF threshold (e.g., terms are present in a very small number of documents and are thus likely not representative or relevant to the topic of the corresponding document).

At block 1438, to remove positions of the second group of terms, it is removed the positions of terms having a character length greater than a first character-length threshold, or terms having a character length less than a second character-length threshold (e.g., very long terms or very short terms).

At block 1440, removing the positions of the second group of terms is based on one or more scores associated with the documents included in the text corpus.

With reference to FIG. 14C, at block 1442, to obtain an index structure, an inverted index of one or more terms of the documents included in the text corpus is generated. At block 1444, to generate the inverted index, each term is annotated with a tag suffix (e.g., a suffix of “N” for name terms, a suffix “S” for stop words).

At block 1446, to generate the inverted index, each unique sequence of terms associated with the text corpus is annotated. Annotating the sequence of terms can be performed using a space-and-time efficient data structure such as a Bloom filter.

At block 1448, to annotate each unique sequence of terms, it is determined, for each unique sequence of terms, whether the sequence of terms corresponds to a sequence of terms associated with the positional index of the selected terms. At block 1450, in accordance with a determination that the sequence of terms corresponds to a sequence of terms associated with the positional index of the selected terms, metadata associated with the sequence of terms is determined.

At block 1452, to determine the metadata, it is determined whether the sequence of terms is a primary sequence. At block 1454, to determine the metadata, it is determined whether the sequence of terms is a name sequence. At block 1456, to determine the metadata, it is determined whether the sequence of terms is a topic sequence. At block 1458, to determine the metadata, it is determined whether the sequence of terms is stored as a single term.

At block 1460, the metadata associated with the sequence of terms are encoded. For example, the metadata are encoded using a space-and-time efficient data structure such as a Bloom filter.

With reference to FIG. 14D, at block 1462, to obtain the index structure, document-specific data (e.g., the title of the document) is obtained.

At block 1464, after obtaining an index structure, a similarity search can be performed based on the query and the index structure. At block 1466, to perform a similarity search, the index structure is searched based on the tokens of the query. The tokens include at least one of one or more primary terms or one or more auxiliary terms.

At block 1468, the search results are ranked based on the at least one of one or more primary terms or one or more auxiliary terms. At block 1470, after the similarity search is performed, one or more query suggestions are determined based on the similarity search results.

At block 1472, to determine one or more query suggestions, a group of ranked search results is obtained. The group of ranked search result represents the candidate query suggestions (e.g., top 20 search results). At block 1474, post-processing of the group of ranked search results is performed.

At block 1476, to perform post-processing of the group of ranked search results, it is determined whether one or more matching primary terms are interdependent. For example, it is determined whether a term is also included in a sequence of terms. At block 1478, in accordance with a determination that one or more matching primary terms are interdependent, the number of matches associated with one or more search results is reduced.

With reference to FIG. 14E, at block 1480, to perform post-processing of the group of ranked search results, it is determined whether all matching primary terms represent names (e.g., European country names). At block 1482, in accordance with a determination that all matching primary terms represent names, it is determined a number of correlations between the matching primary terms and the document-specific data (e.g., the title of the document). At block 1484, it is determined whether the number of correlations satisfies a correlation-threshold. At block 1486, in accordance with a determination that the number of corrections does not satisfy a correlation-threshold (indicating that the majority of the matching primary terms are likely not representative or reflecting the topics of the corresponding documents represented by the index structure), one or more ranked search results associated with the matching primary terms are removed.

At block 1488, to perform post-processing of the group of ranked search results, it is determined whether one or more terms of a document title match with the tokens included in the query. The title is likely a representation of the topic of the corresponding documents. At block 1490, in accordance with a determination that at least one of the one or more terms of a document title does not match the tokens included in the query, one or more ranked search results associated with the document title are removed. For example, if the terms included in the title are not included in the query, it is likely that the document is not what the user is interested in. Thus, the corresponding search result is removed.

At block 1492, to perform post-processing of the group of ranked search results, the search results associated with documents having identical matching terms are re-ranked. For example, a higher rank is assigned to the search result corresponding to the document having one or more matching terms in the document title, or to the search result corresponding to the document that represent a more generic description of the topic.

At block 1494, to perform post-processing of the group of ranked search results, it is determined whether a ranking score of a document satisfies a document-score threshold. If the score of a particular document is less than the document-score threshold, the ranked search result associated with the particular document is removed.

At block 1496, to perform post-processing of the group of ranked search results, it is determined an alternative document title based on the query. For example, the input document includes the terms “The Fat Controller.” According to the terms used in the input document, which are the basis for generating the query, a search result associated with the document with a title “The Fat Controller” is selected or assigned a higher rank, rather than a search result associated with the document with a title “Sir Topham Hatt.”

At block 1498, to perform post-processing of the group of ranked search results, the group of ranked search results is re-ranked based on relative document scores and relative popularity scores. As described above, a blended score can be determined based on a relative document score and a relative popularity score associated with a particular document. The blended score can be used to re-rank the ranked search results.

At block 1500, the one or more query suggestions are determined based on the post-processing results.

With reference to FIG. 14F, at block 1502, the index structure is stored in the mobile device to enable a similarity search in absence of a network connection. The index structure thus facilitates the searching and providing query suggestions to the user in a fast and efficient manner.

At block 1504, one or more query suggestions are received from the repository of candidate query suggestions. At block 1506, the one or more query suggestions are provided to the user. At block 1508, a selection of one query suggestion among the one or more query suggestions is received from the user. At block 1510, information is provided to the user in accordance with the selection of the one query suggestion.

With reference to FIGS. 14A and 14F, at block 1512, in some examples, prior to initiate a query, one or more languages associated with the input document are detected. At block 1514, the detected languages are ranked. At block 1516, based on the ranking of the detected languages, a repository of candidate query suggestions (and associated index structure) is identified from a plurality of repositories of candidate query suggestions. The plurality of repositories corresponds to plurality of languages.

The operations described above with reference to FIG. 14 are optionally implemented by components depicted in FIGS. 1-4, 6A-B, and 7A-C. For example, the operations of process 1400 may be implemented by devices 104, 200, and 600; and digital assistant 700. It would be clear to a person having ordinary skill in the art how other processes are implemented based on the components depicted in FIGS. 1-4, 6A-B, and 7A-C.

In accordance with some implementations, a computer-readable storage medium (e.g., a non-transitory computer readable storage medium) is provided, the computer-readable storage medium storing one or more programs for execution by one or more processors of an electronic device, the one or more programs including instructions for performing any of the methods or processes described herein.

In accordance with some implementations, an electronic device (e.g., a portable electronic device) is provided that comprises means for performing any of the methods or processes described herein.

In accordance with some implementations, an electronic device (e.g., a portable electronic device) is provided that comprises a processing unit configured to perform any of the methods or processes described herein.

In accordance with some implementations, an electronic device (e.g., a portable electronic device) is provided that comprises one or more processors and memory storing one or more programs for execution by the one or more processors, the one or more programs including instructions for performing any of the methods or processes described herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources (e.g., the input document such as an article the user is reading) to improve the delivery to users of invitational content or any other content that may be of interest to them (e.g., providing query suggestions). The present disclosure contemplates that in some instances, this gathered data may include personal information data that uniquely identifies or can be used to contact or locate a specific person. Such personal information data can include demographic data, location-based data, telephone numbers, email addresses, home addresses, or any other identifying information.

The present disclosure recognizes that the use of such personal information data, in the present technology, can be used to the benefit of users. For example, the personal information data can be used to deliver targeted content that is of greater interest to the user. Accordingly, use of such personal information data enables calculated control of the delivered content. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services. In another example, users can select not to provide location information for targeted content delivery services. In yet another example, users can select to not provide precise location information, but permit the transfer of location zone information.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publically available information.

What is claimed is:

1. An electronic device comprising:
one or more processors;
memory; and
one or more programs stored in memory, the one or more programs including instructions for:
while displaying an input document comprising unstructured natural language information, receiving a user input initiating a search;
in response to receiving the user input, initiating a query based on the input document, the query accessing a repository of candidate query suggestions related to one or more topics present in the unstructured natural language information;
receiving, from the repository, one or more query suggestions; and
providing the one or more query suggestions to the user.

2. The electronic device of claim 1, wherein initiating the query based on the input document comprises:
generating one or more tokens representing the input document;
removing, from the tokens representing the input document, tokens representing structured content in the input document;
classifying the remaining tokens; and
generating the query based on the classification of the remaining tokens.

3. The electronic device of claim 2, wherein classifying the remaining tokens comprises classifying the remaining tokens into at least one of:
one or more primary terms;
one or more auxiliary terms; and
one or more terms that are not to-be-included in the query.

4. The electronic device of claim 2, further comprising determining whether one or more terms of the remaining tokens are to be included in an index structure, wherein the determination is based on at least one of a document frequency (DF), a collection term frequency (CTF), or a relation of the DF and CTF.

5. The electronic device of claim 1, wherein accessing a repository of query suggestions related to one or more topics present in the unstructured natural language information comprises:
obtaining an index structure, wherein the index structure includes a positional index of selected terms associated with a text corpus, wherein the text corpus includes a collection of documents;
performing a similarity search based on the query and the index structure; and
determining one or more query suggestions based on the similarity search results.

6. The electronic device of claim 5, further comprising storing the index structure in the mobile device to enable a similarity search in absence of a network connection.

7. The electronic device of claim 5, wherein obtaining the index structure comprises:
generating the positional index of the selected terms associated with the text corpus;
generating an inverted index of one or more terms of the documents included in the text corpus; and
obtaining document-specific data.

8. The electronic device of claim 7, wherein generating the positional index of the selected terms associated with the text corpus comprises:
generating positions of a first group of terms associated with the text corpus, the positions including a position for each term of the first group of terms; and
removing, from the positions of the first group of terms, positions of a second group of terms, wherein the second group of terms is a subset of the first group of terms.

9. The electronic device of claim 8, wherein the number of the second group of terms is a substantial portion of the number of first group of terms.

10. The electronic device of claim 8, wherein removing the positions of the second group of terms comprises one or more of:
removing positions of terms associated with at least one of a list, an index, a table, invisible text, a disambiguation page, a reference, or a page having a number of terms less than a page-length threshold;
removing positions of terms associated with documents having a number of visits less than a visit-frequency threshold;
removing positions of terms associated with documents having frequency of translations less than a translation-frequency threshold; and
removing positions of terms that are present only once in the corresponding documents.

11. The electronic device of claim 8, wherein removing the positions of the second group of terms comprises one or more of:
removing positions of at least one of terms or sequences of terms, the terms or sequences of terms having document frequency (DF) less than a DF threshold;
removing positions of terms having a character length greater than a first character-length threshold, or terms having a character length less than a second character-length threshold; and
removing the positions of the second group of terms based on one or more scores associated with the documents included in the text corpus.

12. The electronic device of claim 7, wherein generating the inverted index of one or more terms of documents included in the text corpus comprises annotating each term with a tag suffix.

13. The electronic device of claim 7, wherein generating the inverted index of one or more terms of documents included in the text corpus comprises annotating each unique sequence of terms associated with the text corpus.

14. The electronic device of claim 13, wherein annotating each unique sequence of terms comprises, for each unique sequence of terms:
determining whether the sequence of terms corresponds to a sequence of terms associated with the positional index of the selected terms;
in accordance with a determination that the sequence of terms corresponds to a sequence of terms associated with the positional index of the selected terms, determining metadata associated with the sequence of terms; and
encoding the metadata associated with the sequence of terms.

15. The electronic device of claim 14, wherein determining metadata associated with the sequence of terms comprises determining whether the sequence of terms is a primary sequence.

16. The electronic device of claim 14, wherein determining metadata associated with the sequence of terms comprises one or more of:
determining whether the sequence of terms is a name sequence;
determining whether the sequence of terms is a topic sequence; and
determining whether the sequence of terms is stored as a single term.

17. The electronic device of claim 5, wherein performing the similarity search based on the query and the index structure comprises:
searching the index structure based on the tokens of the query, the tokens comprising at least one of one or more primary terms or one or more auxiliary terms; and
ranking the search results based on the at least one of one or more primary terms or one or more auxiliary terms.

18. The electronic device of claim 5, wherein determining one or more query suggestions based on the similarity search results comprises:
obtaining a group of ranked search results, the group of ranked search result representing the candidate query suggestions;
performing post-processing of the group of ranked search results; and
determining the one or more query suggestion based on the post-processing results.

19. The electronic device of claim 18, wherein performing the post-processing of the group of ranked search results comprises:
determining whether one or more matching primary terms are interdependent; and
in accordance with a determination that one or more matching primary terms are interdependent, reducing the number of matches associated with one or more search results.

20. The electronic device of claim 18, wherein performing the post-processing of the group of ranked search results comprises:
determining whether all matching primary terms represent names;
in accordance with a determination that all matching primary terms represent names, determining a number of correlations between the matching primary terms and the document-specific data;
determining whether the number of correlations satisfies a correlation-threshold; and
in accordance with a determination that the number of corrections does not satisfy a correlation-threshold, removing one or more ranked search results associated with the matching primary terms.

21. The electronic device of claim 18, wherein performing the post-processing of the group of ranked search results comprises:
determining whether one or more terms of a document title match with the tokens included in the query; and
in accordance with a determination that at least one of the one or more terms of a document title does not match the tokens included in the query, removing one or more ranked search results associated with the document title.

22. The electronic device of claim 18, wherein performing the post-processing of the group of ranked search results comprises one or more of:
re-ranking the search results associated with documents having identical matching terms;
determining whether a ranking score of a document satisfies a document-score threshold;
determining an alternative document title based on the query; and
re-ranking the group of ranked search results based on at least one of relative document scores and relative popularity scores.

23. The electronic device of claim 1, wherein providing one or more query suggestions to the user comprises:
providing the plurality of query suggestions to the user at a display area different from the display area for receiving the input document.

24. The electronic device of claim 1, further comprising:
receiving, from the user, a selection of one query suggestion among the one or more query suggestions; and
providing information to the user in accordance with the selection of the one query suggestion.

25. The electronic device of claim 1, further comprising, prior to initiating a query based on the input document:
detecting one or more languages associated with the input document;
ranking the detected languages; and
identifying, based on the ranking of the detected languages, the repository of candidate query suggestions from a plurality of repositories of candidate query suggestions, the plurality of repositories corresponding to plurality of languages.

26. A non-transitory computer-readable storage medium storing one or more programs, the one or more programs comprising instructions, which when executed by one or more processors of an electronic device, cause the electronic device to:
while displaying input document comprising unstructured natural language information, receive a user input initiating a search;
in response to receiving the user input, initiate a query based on the input document, the query accessing a repository of candidate query suggestions related to one or more topics present in the unstructured natural language information;
receive, from the repository, one or more query suggestions; and
provide the one or more query suggestions to the user.

27. A method for providing a plurality of query suggestions, comprising:
at a mobile device with one or more processors and memory;
while displaying input document comprising unstructured natural language information, receiving a user input initiating a search;
in response to receiving the user input, initiating a query based on the input document, the query accessing a repository of candidate query suggestions related to one or more topics present in the unstructured natural language information;
receiving, from the repository, one or more query suggestions; and
providing the one or more query suggestions to the user.
